(19) United States
(12) Patent Application Publication
(10) Pub. No.: US 2026/0084058 A1
(43) Pub. Date: Mar. 26, 2026

(54) GAME PROGRAM, GAME SYSTEM, INFORMATION PROCESSING DEVICE, SERVER, GAME METHOD, AND GENERATION METHOD

(71) Applicant: The Pokémon Company, Tokyo (JP)

(72) Inventors: Takato UTSUNOMIYA, Tokyo (JP); Kaname KOSUGI, Tokyo (JP); Marie SHUTO, Tokyo (JP); Yuki TERADA, Tokyo (JP); Yoshinari YONEHARA, Tokyo (JP); Yu SATO, Tokyo (JP); Misaki KAMIMURA, Tokyo (JP); Yutaka HOSHI, Tokyo (JP); Koya NAKAHATA, Tokyo (JP); Keisuke MIYAGAWA, Tokyo (JP); Takumi TSUKADA, Tokyo (JP)

(73) Assignee: The Pokémon Company, Tokyo (JP)

(21) Appl. No.: 19/407,085

(22) Filed: Dec. 3, 2025

Related U.S. Application Data
(63) Continuation of application No. PCT/JP2024/020129, filed on Jun. 1, 2024.

(30) Foreign Application Priority Data
Jun. 3, 2023 (JP) 2023-092008

(51) Int. Cl. A63F 13/58; A63F 13/537

(52) U.S. Cl. CPC A63F 13/58; A63F 13/537

(57) ABSTRACT

A game system that can improve enjoyability of a sleep game that uses sleep information of a user includes processor configured to execute a parameter control step of increasing a first parameter by adding to the first parameter a sum value obtained by adding one or more predetermined values during an activity period except for a period during which the user is sleeping; a parameter storage step of storing the first parameter at a timing at which the user has started sleeping as a sleep start time parameter at a time of the start of the sleep; a sleep parameter calculation step of calculating a sleep parameter based on sleep information of the user; and an event determination step of determining a game event to be caused on the basis of a second parameter obtained by multiplying the sleep parameter with the sleep start time parameter.

### CROSS-REFERENCE TO RELATED APPLICATIONS

This application is a Continuation of PCT International Application No. PCT/JP2024/020129, filed on Jun. 1, 2024, which claims priority to Japanese Patent Application No. 2023-092008, filed on Jun. 3, 2023. The above applications are hereby expressly incorporated by reference, in their entirety, into the present application.

### TECHNICAL FIELD

The present disclosure relates to a game program, a game system, an information processing device, a server, a game method, and a generation method. More particularly, the present disclosure relates to a game program, a game system, an information processing device, a server, a game method, and a generation method that execute game processing using a user's sleep information.

### BACKGROUND

There is known a game system that executes a game that uses sleep information related to user's sleep, and that includes a sleep information acquisition unit that acquires the user's sleep information, a sleep information change unit that generates, as for at least part of the sleep information, changed sleep information obtained by changing the sleep information based on sleep information having different contents from that of the sleep information, and a game control unit that, in a case where the changed sleep information has not been generated by the sleep information change unit, determines a first effect of the game based on the sleep information, and, in a case where the changed sleep information has been generated by the sleep information change unit, determines a second effect different from the first effect based on the changed sleep information (see, for example, PTL 1). The game system described in PTL 1 can appropriately acquire sleep information, and advance the game that uses the sleep information even when a situation that the user's sleep information cannot be appropriately measured occurs.

### CITATION LIST

### Patent Literature

[PTL 1] Japanese Patent Application Laid-open No. 2022-161264

### SUMMARY

### Technical Problems

According to a sleep game such as the game system described in PTL 1, while it is important for a user to take an appropriate sleep, it is not possible to completely eliminate a game operation in a time zone during which the user is awake. The applicant has obtained the finding during the development of a sleep game that enhancing game playability in the time zone during which the user is awake may not necessarily result in enhancing improvement of appeal and enjoyability of the sleep game.

Accordingly, an object of the present disclosure is to provide a game program, a game system, an information processing device, a server, a game method, and a generation method that can improve enjoyability of a sleep game that uses user's sleep information.

### Solutions to Problems

In an embodiment, the present disclosure provides a game program that causes a computer that includes a processor and a memory and manages execution of a game that uses sleep information related to a user' sleep to execute: a parameter control step of increasing a first parameter by adding to the first parameter a sum value obtained by adding one or more predetermined values during an activity period except for a period during which the user is sleeping; a parameter storage step of storing the first parameter at a timing at which the user has started sleeping as a sleep start time parameter at a time of the start of the sleep; a sleep parameter calculation step of calculating a sleep parameter based on sleep information of the user; and an event determination step of determining a game event to be caused on the basis of a second parameter obtained by multiplying the sleep parameter with the sleep start time parameter.

### Advantageous Effects

A game program, a game system, an information processing device, a server, a game method, and a generation method according to the present disclosure can provide a game program, a game system, an information processing device, a server, a game method, and a generation method that can improve enjoyability of a sleep game that uses the user's sleep information.

### BRIEF DESCRIPTION OF DRAWINGS

FIG. 1 is a schematic view of a game system according to one or more aspects of the disclosed subject matter.

FIG. 2A, FIG. 2B, FIG. 2C, and FIG. 2D illustrate a flow of the game system according to one or more aspects of the disclosed subject matter.

FIG. 3 is a block diagram of a functional configuration of the game system according to one or more aspects of the disclosed subject matter.

FIG. 4 is a data configuration diagram of each storage unit included in a storing unit according to one or more aspects of the disclosed subject matter.

FIG. 5 is a flowchart of processing in the game system according to one or more aspects of the disclosed subject matter.

FIG. 6A, FIG. 6B, and FIG. 6C illustrate display contents in the game system according to one or more aspects of the disclosed subject matter.

FIG. 7A, FIG. 7B, and FIG. 7C illustrate display contents in the game system according to one or more aspects of the disclosed subject matter.

FIG. 8 is a flowchart of processing in the game system according to one or more aspects of the disclosed subject matter.

FIG. 9A, FIG. 9B, and FIG. 9C illustrate display contents in the game system according to one or more aspects of the disclosed subject matter.

FIG. 10A and FIG. 10B illustrate display contents in the game system according to one or more aspects of the disclosed subject matter.

FIG. 11A and FIG. 11B illustrate display contents in the game system according to one or more aspects of the disclosed subject matter.

FIG. 12A, FIG. 12B, and FIG. 12C illustrate display contents in the game system according to one or more aspects of the disclosed subject matter.

FIG. 13 is a flowchart of processing in the game system according to one or more aspects of the disclosed subject matter.

FIG. 14A, FIG. 14B, and FIG. 14C illustrates display contents in the game system according to one or more aspects of the disclosed subject matter.

FIG. 15A and FIG. 15B illustrate display contents in the game system according to one or more aspects of the disclosed subject matter.

FIG. 16A, FIG. 16B, and FIG. 16C illustrate display contents in the game system according to one or more aspects of the disclosed subject matter.

FIG. 17 is a flowchart of processing in the game system according to one or more aspects of the disclosed subject matter.

FIG. 18 is a flowchart of processing in the game system according to one or more aspects of the disclosed subject matter.

FIG. 19 is a flowchart of processing in the game system according to one or more aspects of the disclosed subject matter.

FIG. 20A, FIG. 20B, and FIG. 20C illustrate display contents in the game system according to one or more aspects of the disclosed subject matter.

FIG. 21 is a view of display contents in the game system according to one or more aspects of the disclosed subject matter.

FIG. 22 is a flowchart of processing in the game system according to one or more aspects of the disclosed subject matter.

FIG. 23 is a flowchart of processing in the game system according to one or more aspects of the disclosed subject matter.

### DETAILED DESCRIPTION

### Embodiment

### <Overview of Game System 1>

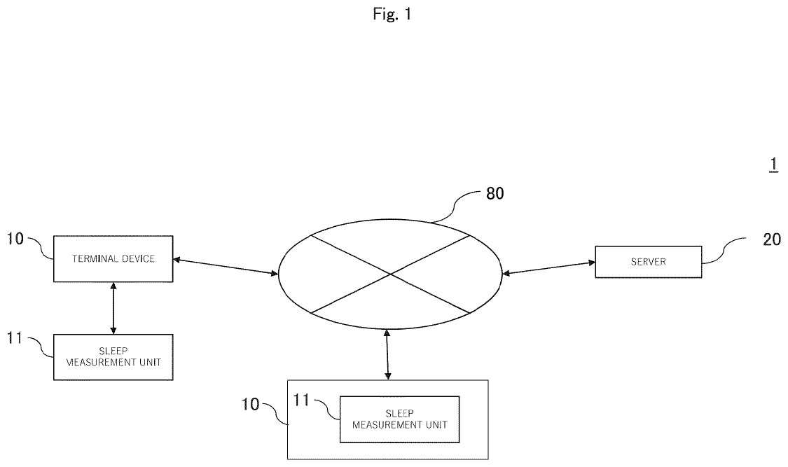

FIG. 1 illustrates an overview of a game system according to a present embodiment. More specifically, FIG. 1 illustrates an overview of a configuration of a game system 1 according to the present embodiment.

The game system 1 according to the present embodiment executes a game using sleep information related to a user's sleep. As illustrated in FIG. 1, the game system 1 includes a terminal device 10 of the user, a sleep measurement unit 11 that measures a user's sleep state, and a server 20 that executes game processing. The terminal device 10 and the server 20 are connected through a communication network 80 bidirectionally communicably. Furthermore, in the game system 1, the server 20 accepts the sleep information of the user, and advances the game. Note that the game system 1 may be also a server client type game system. Furthermore, the sleep measurement unit 11 may be an independent device that is separate from the terminal device 10, or may be built in the terminal device 10.

Note that, although FIG. 1 illustrates the example where the two terminal devices 10 are connected to the server 20 through the communication network 80, the one terminal device 10 and/or a plurality of the terminal devices 10 used respectively by different users may be connected to the server 20 via the communication network 80. To simplify the following description, an example where the one terminal device 10 is connected to the server 20 through the communication network 80 will be described.

First, the game system 1 advances the game based on a first parameter that increases on the basis of whether or not a user's operation is performed in a time zone during which the user is awake and active, a sleep parameter that is determined on the basis of the sleep information related to a user's sleep, and a second parameter that is obtained by multiplying the first parameter with the sleep parameter. The game system 1 determines a game event to be caused on the basis of the second parameter, and generates game event information of the game event to be caused. Note that the time zone during which the user is awake and active may be referred to as an “activity period” below. The activity period may be a time zone that differs per user and may be a time zone except for a time at which the user is sleeping.

Here, the game system 1 has a function that can encourage the user to take an appropriate sleep without overly increasing game playability of the game system 1 during the user's activity period. For example, the game system 1 advances game processing in response to a predetermined operation every time a predetermined operation is accepted from the user during the user's activity period, and increases the first parameter by adding a predetermined value to the first parameter. Alternatively, if the game system 1 does not accept the predetermined operation from the user during the user's activity period, the game system 1 increases the first parameter by adding to the first parameter a value that is determined on the basis of a duration of the activity period (in this regard, the value may be a different value such as a small value different from the predetermined value in a case where the game system 1 accepts the predetermined operation from the user during the activity period.) (The user can increase the first parameter on a step by step basis by performing the predetermined operation, and can secure the minimum first parameters required to advance the game without performing the operation.). Furthermore, the game system 1 calculates the second parameter by multiplying the sleep parameter determined on the basis of the user's sleep time with the first parameter at a time of start of a user's sleep. The game system 1 executes determination of a game event and generation of game event information based on this second parameter. The game system 1 causes different events according to the second parameter. For example, as the second parameter becomes larger, a game event that is more advantageous for the user (or more preferable for the user) is more likely to be caused.

That is, the game system 1 increases the first parameter by the predetermined value at a time by adding the predetermined value to the first parameter in response to the user's operation during the user's activity period (in many time, during a time zone in daytime during which the user is awake), and records the first parameter at a timing of start of the user's sleep. Furthermore, the game system 1 calculates the second parameter by multiplying the sleep parameter determined on the basis of the duration of the user's sleep time on the stored first parameter. Accordingly, the game system 1 can easily increase a value of the second parameter by increasing the sleep time.

Consequently, according to the game system 1, the user does not need to immerse in the game during the activity period, and can increase the first parameter at a timing at which the user has a time to spare. Furthermore, according to the game system 1, the user can easily increase the second parameter that is important to advance the game by sleeping well in a time zone except for the activity period, so that an incentive to sleep well works on the user and it is possible to improve enjoyability of the sleep game.

### <Overview of Flow of Game System 1>

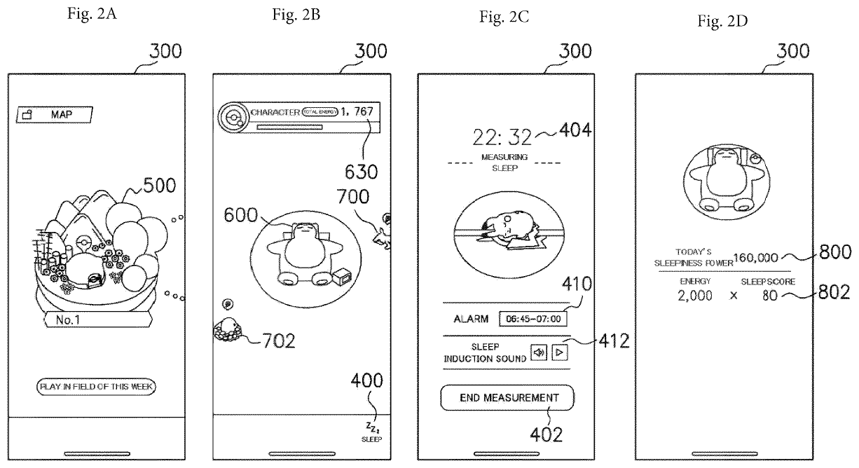

FIGS. 2A to 2D illustrates an overview of a flow of the game system according to the present embodiment. More specifically, FIGS. 2A to 2D illustrates an example of the flow of display of the terminal device 10 included in the game system 1 according to the present embodiment. FIGS. 2A to 2D illustrates that a time elapses from FIGS. 2A to 2D.

As an example, in the game system 1, a plurality of fields 500 exist in a virtual space in the game as illustrated in FIG. 2A, and a field character 600 lives in each field 500 as illustrated in FIG. 2B. The game system 1 raises the field character 600 based on a predetermined operation during the user's activity period and user's sleep information (e.g., sleep time). Furthermore, the game system 1 causes a game event based on predetermined parameters of the raised and grown field character 600. The game event is, for example, an event in which a character in a sleeping state appears around the field character 600.

Here, the game system 1 raises the field character 600 during each predetermined unit game period and during each unit game period to cause a predetermined game event, and, when the unit game period ends, accepts user's selection of the new field 500 to start raising the new field character 600 living in the selected field 500 again. That is, the game system 1 raises the field character 600 in a certain unit game period based on the user's predetermined operation or sleep to cause a predetermined game event, and ends raising the field character 600 that has been living in the field 500 so far at a timing to move to the next field 500. Furthermore, the game system 1 advances the game by repeating a cycle of determining the new field 500 and the field character 600 based on user's selection and starting raising the new field character 600.

As an example, an example will be described where the predetermined unit game period is one week (seven days) and the user starts the game from the morning of the beginning (the first day such as Monday) of the week.

First, as illustrated in FIG. 2A, the game system 1 causes a display unit 300 of the terminal device 10 to display the plurality of fields 500 in the morning at the beginning of the week, and accepts user's selection of the field 500. The field characters 600 having the same or different raising conditions live in the plurality of fields 500. The game system 1 determines the field character 600 of the field 500 selected by the user as the field character 600 to raise in this week.

Furthermore, the game system 1 gives to the field character 600 a predetermined item (e.g., a virtual nut in the game) or dish (a virtual dish in the game) in response to a user's operation during a user's activity period (e.g., a period during which the user is awake. This period is typically a daytime), and increases the first parameter associated with the field character 600. In the game system 1, as the first parameter increases, the field character 600 grows. As illustrated in, for example, FIG. 2B, the game system 1 adds to the first parameter the predetermined value associated with a predetermined item, and causes a first parameter display area 630 of the display unit 300 to display a value of the first parameter (“total energy” is displayed in FIG. 2B). Note that, at a time of initial activation of the game, an initial value that is not zero is set to the first parameter.

Here, the game system 1 causes the display unit 300 to display a character 700 and a character 702 (that may be referred to as “help characters” below) that help raise the field character 600 around the field character 600. These help characters are characters selected by the user from characters possessed by the user. These “help characters” collect and possess in the game a predetermined item (that is a virtual nut in the game, and may be referred to simply as a “nut” or a “direct growth item” below) that can be directly given to the field character 600, and/or an ingredient (that is an ingredient of a virtual dish in the game, and a dish obtained by cooking the ingredients can be given to the field character 600. The ingredient may be referred to simply as a “dish ingredient” or an “indirect growth item” below.) that can be indirectly given to the field character 600.

Furthermore, when accepting a user's tap operation on the “help character” during the activity period, the game system 1 gives the “nut” possessed by the “help character” to the field character 600, and adds the predetermined value associated with the “nut” to the first parameter. In a case where, for example, a certain type of the “nut” is associated with the predetermined value, the game system 1 adds the predetermined value to the first parameter immediately before the user taps the “help character”. When the “help character” possesses a plurality of “nuts” and gives these “nuts” to the field character 600, the game system 1 adds predetermined values associated with the “nuts” and adds this sum value to the first parameter.

Furthermore, when accepting the user's tap operation on the “help character”, the game system 1 stores the “dish ingredient” possessed by the “help character” in association with the user. Furthermore, the game system 1 accepts a user's instruction during the activity period, and cooks a dish for the field character 600 consuming the “dish ingredient”. The cooked dish is associated with a predetermined value for a dish, and the game system 1 gives the dish to the field character 600 in response to a user's instruction to add the predetermined value to the first parameter. As described above, as the first parameter of the field character 600 increases during the activity period of one day in the unit game period, the field character 600 grows.

Next, when it is night (here, the first night of the week, that is, Monday night), the user sleeps. In this case, the game system 1 accepts a user's operation input on a sleep button 400 displayed on the display unit 300 as illustrated in FIG. 2B, and starts acquiring sleep information that is information related to the user's sleep. After accepting the user's operation input on the sleep button 400, the game system 1 starts measuring the user's sleep time from a predetermined timing such as a timing at which the user's motion has stopped or a timing at which a user's deep sleep has been detected, on the basis of a measurement result of the sleep measurement unit 11. Furthermore, the game system 1 stores as the sleep start time parameter the first parameter at the point of time at which the game system 1 accepts the user's operation input on the sleep button 400. Furthermore, the game system 1 causes the display unit 300 to display a screen of “measuring sleep” together with a time display 404 as illustrated in FIG. 2C.

Note that, after accepting the user's operation input on the sleep button 400, the game system 1 can accept settings of an alarm and/or settings of a sleep induction sound. For example, as illustrated in FIG. 2C, the game system 1 displays an alarm settings area 410 on the display unit 300 and accepts user's alarm settings. Furthermore, the game system 1 displays a sleep induction sound settings area 412 on the display unit 300, and accepts settings of a sound and music output from the terminal device 10 in response to a user's instruction until the user starts sleeping.

Subsequently, the game system 1 stops acquiring the user's sleep information when detecting that the user has woken up via the terminal device 10. For example, as illustrated in FIG. 2C, the game system 1 accepts the user's operation on a measurement end button 402 displayed on the display unit 300, and stops acquiring the sleep information. Furthermore, the game system 1 calculates a sleep score as a sleep parameter based on the acquired sleep information. The sleep score may be a maximum score (e.g., “100”. That is, the maximum value of the sleep score is “100”.) in a case where the user takes, for example, a sleep for a duration of a predetermined sleep time (that may be referred to as a “reference sleep time” below) or more, and is set to a score obtained by subtracting a predetermined amount of a score from a maximum score as the sleep time becomes shorter than the reference sleep time.

The game system 1 calculates the second parameter by multiplying the calculated sleep score on the sleep start time parameter. For example, as illustrated in FIG. 2D, the game system 1 displays a value of a second parameter 800 together with a breakdown 802 of the second parameter on the display unit 300. In the example in FIG. 2D, the value of the second parameter 800 is “160,000” (the second parameter is displayed as “sleepiness power” in FIG. 2D), and the breakdown 802 of the second parameter 800 includes that the value of the sleep start time parameter (displayed as “energy” in the example in FIG. 2D) is “2,000” and the value of the sleep score is “80”.

Subsequently, the game system 1 executes determination of a game event to be caused and generation of game event information based on the calculated second parameter. For example, the game system 1 causes a character to appear around the field character 600 as a result obtained by executing predetermined drawing based on the second parameter. This drawing is such drawing that a result is obtained that, as the value of the second parameter becomes larger, an advantageous result for the user (e.g., a result that, for example, as the value of the second parameter becomes larger, a character having a sleeping face of higher rarity is more likely to appear) is obtained. Furthermore, in addition to the drawing, the game system 1 may obtain a predetermined item, a predetermined character, or the like in exchange with consumption of the second parameter in response to the user's instruction. That is, the game system 1 may give to the second parameter a function similar to a cryptocurrency in the game, and make the second parameter available in place of the cryptocurrency. Note that, when the character appears, the character appears in a sleeping state. Furthermore, in response to the user's operation, the game system 1 executes giving of a reward to a game event or the user such as acquisition of an image of the appearing character (a sleeping face image or a sleeping position image), giving of a predetermined item to the appearing character, and giving of the appearing character to the user when a predetermined condition is satisfied. The game system 1 outputs the user's sleep information and/or these game event results to the terminal device 10.

Furthermore, the game system 1 continues the game on the second day of the week (Tuesday in the above example). In this case, the game system 1 continues the game by taking over the first parameter increased on the first day to the first parameter on the second day as it is. As described above, the game system 1 advances the game on an nth day of the unit game period, and continues the game on an n+1th day (in this regard, n represents an integer equal to or more than one). Also on the n+1th day, during the user's activity period, a predetermined item or dish is given to the field character 600 in response to the user's operation, and, as the first parameter increases, the field character 600 grows. Furthermore, when the user takes a sleep, the first parameter on the n+1th day immediately before the user takes a sleep becomes a new sleep start time parameter, the second parameter is calculated in the morning on an n+2th day by multiplying this sleep start time parameter with a sleep score determined on the basis of the user's sleep information on the n+1th day, and a game event is determined and executed on the basis of the calculated second parameter. Accordingly, the first parameter on the n+1th day is larger among the first parameter on the nth day of the unit game period (the sleep start time parameter at the timing at which the user has started sleeping) and the first parameter on the n+1th day. That is, as days pass in the unit game period, the first parameter increases, that is, the field character 600 grows. Since the second parameter is calculated by multiplying the first parameter (the sleep start time parameter at the timing at which the user has started sleeping) with the sleep score, the second parameter also becomes larger in a more latter half of the unit game period. Consequently, drawing at a time at which the user wakes up is more likely to result in a more advantageous result in a more latter half of the unit game period.

Subsequently, the game system 1 causes the display unit 300 to display a summary of a game execution result in one unit game period at a timing at which a last day of the one unit game period switches to the first day of a next unit game period, and accepts user's selection of the new field 500. In this case, the game system 1 resets the first parameter in the one unit game period (i.e., resets the parameter related to the field character 600 living in the field 500 selected by the user in one unit game period.). Furthermore, the game system 1 starts raising again the new field character 600 living in the field 500 newly selected by the user. That is, when the user selects the new field 500 and starts raising the new field character 600, the game system 1 sets the first parameter accumulated in the one unit game period to “0”. Furthermore, the first parameter of this new field character 600 is started from “0”. Subsequently, in response to the user's operation input or the like in the next unit game period, the game system 1 performs processing of increasing the first parameter again, processing of calculating the second parameter, and game processing of, for example, causing a predetermined game event similarly to the above description. Note that, when one unit game period switches to a next unit game period, the game system 1 advances the game by taking over information related to the user (such as a user's rank), items possessed by the user, the character (help character) got by the user, information related to the character (such as status information), and other information.

As described above, the game system 1 advances the game according to the following flow in summary.
1) On the first day of the unit game period (e.g., the morning of Monday at the beginning of the week), the field 500 and the field character 600 are determined on the basis of user's selection.
2) A predetermined value is added to the first parameter of the field character 600 based on a predetermined operation/processing during an activity period (e.g., daytime) to increase the first parameter (i.e., grow the field character 600).
3) The first parameter at a timing (e.g., night) at which the user takes a sleep is recorded as the sleep start time parameter, and the user takes a sleep.
4) After the user wakes up, a sleep score determined on the basis of the sleep is calculated.
5) The calculated sleep score is multiplied on the sleep start time parameter to calculate the second parameter.
6) A game event to be caused is determined on the basis of the calculated second parameter to cause a game event such as an event that causes a character won by a lottery to appear around the field character 600. Here, as the second parameter becomes larger, a character of a lower drawing probability (a character having a sleeping face of higher rarity) is more likely to be won (i.e., the character is more likely to appear).
7) Above 2) to 6) are repeated from the next day of the first day to the last day of the unit game period. Note that the first parameter takes over a value of a previous day even if the previous day runs into a next day in the unit game period, and, a predetermined value is added to the taken over value of the first parameter based on a user's operation or the like on the next day. Consequently, as the first parameter becomes larger in a more latter half of the unit game period (i.e., as the field character 600 grows more), the second parameter also becomes larger, so that a character having a sleeping face of higher rarity is more likely to appear in a more latter half of the unit game period.
8) The first parameter increased in the unit game period is reset on the last day of the unit game period (e.g., a timing at which Sunday switches to Monday), and the field 500 and the field character 600 in the next unit game period are determined on the basis of user's selection. Thereafter, above 2) to 8) are repeatedly executed, and the user collects characters (characters, predetermined images of the characters, and the like) that appear around the field character 600.

Consequently, the game system 1 can determine the game event to be caused using the second parameter obtained by multiplying the first parameter with the sleep score that is based on the user's sleep time, so that the user can advance the game by sleeping well without taking a time for a game operation during the activity period. Furthermore, the game system 1 can repeat the game every unit game period, so that, even when the user cannot activate the game in a certain unit game period and has little opportunity to acquire sleep information, it is possible to resume the game without a significant disadvantage in a next unit game period. Furthermore, even if the user is busy with study, work, or the like in the real world in a certain unit game period and cannot take a large amount of sleep time, the game system 1 can resume the game without a significant disadvantage in the next unit game period or in the unit game period during which the study or the work settles down.

Note that the terminal device 10 may be connected to the one or plurality of sleep measurement units 11 by wire or wirelessly. Although the one sleep measurement unit 11 is connected or built in each terminal device 10 in FIG. 1, the plurality of sleep measurement units 11 may be connected to or built in the terminal device 10. In the following description, an example where the sleep measurement unit 11 is built in the terminal device 10 will be mainly described.

Furthermore, the terminal device 10 is a device that can be operated by the user. For example, the terminal device 10 may be a mobile telephone or a mobile terminal such as a smartphone or a tablet that support a mobile communication system. Alternatively, the terminal device 10 may be, for example, a stationary-type Personal Computer (PC), a laptop PC, a notebook PC, a portable game console and/or a household game console, a dedicated game console, or the like. According to the present embodiment, the terminal device 10 is preferably a smartphone from a viewpoint of facilitating a user's operation and enabling immediate acceptance of the user's operation at a time of start of sleep and at a time of wake-up. Furthermore, a communication network 80 is a mobile telephone network and/or a communication network such as the Internet. The communication network 80 can also include a communication network such as a wired LAN or a wireless LAN. Furthermore, while details of the game system 1 according to the present embodiment will be described below, it is to be understood that names, numerical values, and the like in the description given above and the description given below are merely exemplary, that the present disclosure is not limited to such names, numerical values, and the like, and that such names, numerical values, and the like are not necessarily related to actual names, numerical values, and the like.

### <Details of Game System 1>

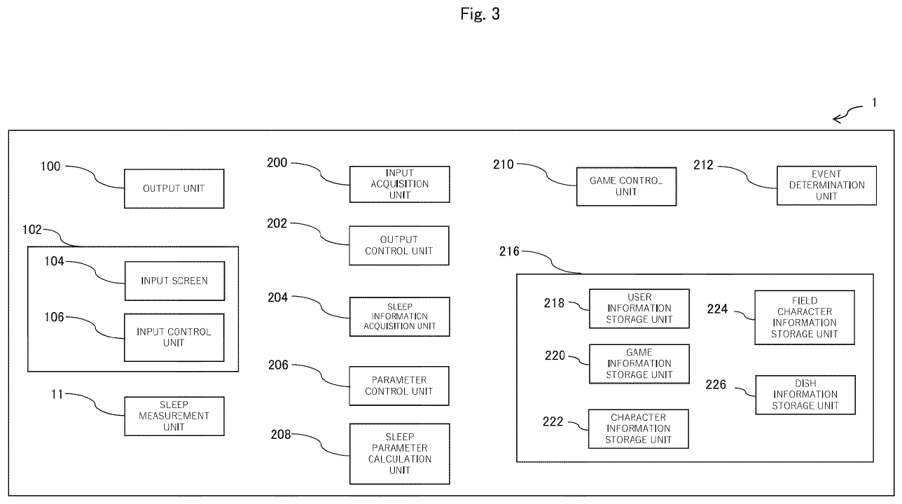

FIG. 3 illustrates an overview of a functional configuration of the game system according to the present embodiment.

### [Overview of Configuration of Game System 1]

The game system 1 is a system that executes the game using the sleep information related to a user's sleep. For example, the game system 1 is executed by the terminal device 10 to advance the game based on the user's sleep. The game system 1 includes an output unit 100 that outputs various information, an input unit 102 that accepts an input from the user, the sleep measurement unit 11 that measures the user's sleep state, an input acquisition unit 200 that acquires information related to the input accepted from the user, an output control unit 202 that controls outputting of information to the output unit 100, a sleep information acquisition unit 204 that acquires the user's sleep information, a parameter control unit 206 that, for example, calculates and increases/decreases various parameters, a sleep parameter calculation unit 208 that calculates the sleep parameter based on the user' sleep information, a game control unit 210 that controls various processing of a game progress, an event determination unit 212 that determines a game event (including generation/determination of the game event information), and a storing unit 216 that is a storage unit that stores various information. The storing unit 216 includes a user information storage unit 218 that stores information related to the user, a game information storage unit 220 that stores information related to the game, a character information storage unit 222 that stores information related to characters, a field character information storage unit 224 that stores information related to the field characters 600, and a dish information storage unit 226 that stores information related to virtual dishes in the game.

In the game system 1, for example, the game is executed in the terminal device 10 used by the user. In this case, the terminal device 10 is configured to include at least the output unit 100 and the input unit 102. Note that the game control unit 210 may have part or all of the functions of the other components included in the game system 1.

In the game system 1, the plurality of components described above may be physically included in the same device or at the same location, or some of the plurality of components described above may be installed at a physically remote position. In this case, the components may be connected by a communication network such as the Internet, for example. In, for example, the game system 1, part of the functions of the components may be performed by an external server. Alternatively, the game system 1 may be configured as one or a plurality of servers. In this case, the game system 1 is configured by combining the terminal device, components of one server, and components of another server. Furthermore, in the present embodiment, the devices (such as the terminal device and the server) can be also grasped as an information processing device. That is, an aggregate of the devices (a predetermined aggregate of the components) can be grasped as one “information processing device”, and the game system 1 may be formed as an aggregate of a plurality of information processing devices. A method for distributing the plurality of functions required to implement the game system 1 according to the present embodiment for one or a plurality of pieces of hardware can be determined as appropriate in consideration of the processing capacity of each hardware and/or the specifications required of the game system 1, and the like. Furthermore, the various information stored in the storing unit 216 may be updated according to an instruction from a user or information accepted via the input unit 102 or updated as needed by acquiring predetermined information from a predetermined server that exists outside of the game system 1.

### [Details of Configuration of Game System 1]

In the following description, a case where the game provided by the game system 1 is executed by the user mainly using the terminal device 10 (e.g., a smartphone, a tablet terminal, or the like) will be described as an example. Note that the server 20 manages user's information in the game system 1 and executes the game processing.

### (Game Control Unit 210)

The game control unit 210 performs communication between the terminal device 10 and the server 20, and controls and advances user's game play based on the user's sleep information received from the terminal device 10. The game control unit 210 can also control the operation of each component included in the game system 1. For example, the game control unit 210 controls processing of drawing game objects such as the field character 600, a predetermined character, and/or an item based on the user's sleep information acquired as game play advances (e.g., processing of determining the status of the field character 600, predetermined character appearance processing, processing of determining a type and a quantity of items or the like that are caused to appear, and the like), and processing of giving a predetermined character or item, or the like to the user. Note that the determined characters, items, and the like may be caused to appear not as possessions of the user during game play. Consequently, the user can have an experience of, for example, discovering a new game character based on the sleep information. For example, the game control unit 210 receives sleep time information or sleep quality information as the user's sleep information from the terminal device 10 of the user, draws an item or the like based on the user's sleep information, and gives the item or the like to the user.

Furthermore, the game control unit 210 executes predetermined game advancement processing and/or processing of drawing a character, an item, or the like based on the first parameter calculated by the parameter control unit 206 to be described later, the sleep parameter calculated by the sleep parameter calculation unit 208, the event determined by the event determination unit 212 to be described later, and the like. Here, the game control unit 210 may change a lottery table used for drawing or the number of lottery draws according to, for example, the user information and the sleep information of the user, the sleep parameter, and/or information of the field character 600. Consequently, when these pieces of information are different, a lottery algorithm also differs, and a game progress at a time of wake-up changes, so that it is possible to provide funs having variations at a time at which the user wakes up.

Furthermore, the game control unit 210 executes various game processing according to a user's operation input accepted via the input unit 102 and the user's sleep information acquired by the sleep information acquisition unit 204. For example, the game control unit 210 executes game processing such as processing of storing information of the user itself in the storing unit 216, processing of storing information related to characters in the storing unit 216, processing of giving a predetermined item to a character, processing of an operation of a character in a virtual space in the game in a case where the user designates the character, acquisition processing or cryptocurrency acquisition processing based on whether or not an item is for value or is free by the user, processing of consuming an item owned by the user, an output instruction to the output control unit 202 to output predetermined information to the output unit 100, and the like.

### (Output Unit 100 and Output Control Unit 202)

The output unit 100 is controlled by the output control unit 202 so as to output various information (e.g., text information, image information of static images and moving images, voice information, and the like) related to execution of the game. The output unit 100 outputs various processing results and the information stored in the storing unit 216 such that the user can perceive the processing results and the information. More specifically, the output control unit 202 causes the output unit 100 to output various processing results of each component, the information stored in the storing unit 216, and the like as, for example, data, static images, moving images, audios, texts, and/or vibration of predetermined formats. The output unit 100 may output information accepted from an external server. Note that the output unit 100 may be configured to include, for example, a display unit that displays the various information, a voice output unit such as a speaker that outputs a voice, and/or a vibration unit that causes vibration according to predetermined information. Furthermore, the display unit may be a liquid crystal display or an organic EL display, for example.

Furthermore, the output control unit 202 also controls outputting of the predetermined information to the output unit 100 in response to an instruction from each component of the game system 1. For example, the output control unit 202 causes the output unit 100 to output, for example, the sleep information acquired by the sleep information acquisition unit 204, the predetermined information accepted by a user's operation input, information of game effects determined by the game control unit 210 and the like, and/or various information of the game such as the game event determined by the event determination unit 212.

### (Input Unit 102, Input Screen 104, and Input Control Unit 106)

The input unit 102 accepts an input of a predetermined instruction or operation from the user. The input may be a voice input. The input unit 102 supplies the instruction to a predetermined component of the game system 1. Each component having accepted the instruction exhibits each predetermined function. The input unit 102 is an input device (e.g., a touch panel, a touch pad, a pointing device such as a mouse, a keyboard, a motion sensor, or the like) for accepting an operation input from the user. In the present embodiment, an example where the input unit 102 is a touch panel included in the terminal device 10 will be described. Note that the touch panel may be multi-touch-detectable. More specifically, the touch panel serving as the input unit 102 includes an input screen 104 on which operations and the like are input from the user, and an input control unit 106 that acquires information related to the operations input on the input screen 104. The touch panel is overlaid and disposed on the display unit 300 serving as the output unit 100, and the surface of the touch panel corresponds to the input screen 104.

For example, an area for accepting a predetermined instruction is displayed on the display unit 300, and the input screen 104 detects the predetermined instruction at a position designated by a user's operation (e.g., a touch operation, a tap operation, a swipe operation, or the like) performed on this area of the input screen 104. The input screen 104 supplies the detected information, that is, information indicating the predetermined instruction at the detected position to the input control unit 106. For example, an area for accepting a user's sleep start instruction, an area for accepting a user's wake-up instruction, and the like are displayed on the display unit 300. The input control unit 106 acquires information indicating the predetermined instruction from the input screen 104 and supplies this information to a predetermined component of the game system 1.

### (Sleep Measurement Unit 11)

The sleep measurement unit 11 acquires information related to the sleep of the user of the terminal device 10. The sleep measurement unit 11 supplies the acquired information to the sleep information acquisition unit 204. Note that, in a case where the terminal device 10 and the sleep measurement unit 11 are separate and independent devices, the terminal device 10 communicates with the sleep measurement unit 11 by short-range wireless communication such as Bluetooth (registered trademark) or Wi-Fi and accepts sensing results from the sleep measurement unit 11. Furthermore, the sleep measurement unit 11 may transmit a sensing result to the server 20 according to the communication standards of a mobile communication system such as 5G without depending on short-range wireless communication. In this case, the terminal device 10 may accept from the server 20 the sleep information acquired in the server 20 that has received the sensing result from the sleep measurement unit 11 to store.

The sleep measurement unit 11 is implemented by, for example, a sensor such as a motion sensor built in the terminal device 10. That is, the terminal device 10 and the sleep measurement unit 11 may be included in the same device. In this case, the terminal device 10 also functions as the sleep measurement unit 11. Furthermore, the sleep measurement unit 11 may be a wearable device of a wristwatch type, a ring type, an eye mask type, or the like worn on the body of the user, or may be configured to include a motion sensor such as a gyro sensor as a device that is independent of the terminal device 10. Furthermore, the sleep measurement unit 11 may be a device that is placed on a mattress on which the user sleeps, a headboard, or the like.

Here, the motion sensor can be configured to include an acceleration sensor, an angular velocity sensor, and the like, and senses a motion of the terminal device 10 and outputs a sensing result. For example, by placing the terminal device 10 on the mattress or the like of the bed on which the user sleeps, when the sleeping user moves on the mattress, the motion sensor can detect this motion. By using the sensing result acquired by the motion sensor, the sleep information acquisition unit 204 to be described below can determine whether the user is asleep or awake, whether the sleeping user is sleeping lightly or deeply, whether the user is in REM sleep or non-REM sleep, and the like, and can acquire this information as the sleep information.

Note that the user may simultaneously use the two or more sleep measurement units 11. For example, the user may wear the two wristwatch-type sleep measurement units 11 or may use a smartphone as the sleep measurement unit 11 while wearing the wristwatch-type sleep measurement unit 11. Consequently, it is possible to directly detect motions of the user's body during a sleep using a gyro sensor or the like. Furthermore, by accumulating sensing results sensed by various sensors while the user is asleep, the sleep information acquisition unit 204 can determine whether or not the user is sleeping, whether the user is in a light sleep state or a deep sleep state, whether the user is in REM sleep or non-REM sleep, and the like, and can acquire this information as the sleep information. By determining waveforms of REM sleep and non-REM sleep as described above, it is possible to evaluate the quality of the sleep of the user. For example, information related to cycles of REM sleep and non-REM sleep in a case of good-quality sleep is set in advance to the sleep information acquisition unit 204, or the sleep information acquisition unit 204 stores general information related to REM sleep and non-REM sleep in advance, so that it is possible to evaluate the quality of the user's sleep by comparing the waveforms of the REM sleep and non-REM sleep at the time of the user's sleep and these pieces of information, and acquire the quality of the user's sleep as the sleep information.

Furthermore, the sleep information acquisition unit 204 can detect that the user has gotten into bed (e.g., the user has laid down on a bed) and has fallen asleep after getting into bed (e.g., the user's motion has stopped or the user has fallen asleep deeply) based on, for example, the output of the motion sensor of the sleep measurement unit 11 or the like. Furthermore, the sleep information acquisition unit 204 can also determine whether or not the user has performed an input operation on the terminal device 10, whether or not the user has perceived the information to be output to the output unit 100 of the terminal device 10, and the like until the user falls asleep after getting into bed. That is, the sleep information acquisition unit 204 can determine whether or not the user who is about to fall asleep is operating the terminal device 10 before falling asleep.

Furthermore, the sleep measurement units 11 assumed in advance to be used by the game system 1 may be managed in a white list format. Note that, when the sleep information acquisition unit 204 to be described below acquires sleep information from the sleep measurement unit 11 that is not managed by the game system 1, the sleep information acquisition unit 204 may not accept the sleep information since the sleep measurement unit 11 cannot be specified by the server 20, or execute the subsequent processing using parameters for the sleep measurement unit 11 or the like that cannot be specified.

Furthermore, differences in the type of the sleep measurement unit 11 do not necessarily need to be differences in devices. That is, even the sleep measurement units 11 having the same device configuration may be managed as the different sleep measurement units 11 in the game system 1 according to types of software or applications used until the sleep information is supplied to the server 20. For example, even when sleep information is detected using the same sleep measurement unit 11, the sleep measurement unit 11 can be managed using different “sleep measurement unit IDs” in a case where a sleep measuring application A is used to process the sleep information and in a case where a sleep measuring application B different from the sleep measuring application A is used to process the sleep information. As described above, by managing the sleep measurement units using different “sleep measurement unit IDs” according to a combination of the type of device serving as the device configuration and the used application, it is possible to more flexibly generate the sleep information, and, as a result, exhibit enjoyability of the game matching the sleep state.

### (Input Acquisition Unit 200)

The input acquisition unit 200 acquires a user's operation input. That is, the input acquisition unit 200 acquires information indicating the user's operation input input to the input unit 102 (e.g., input screen 104) via the input control unit 106. The input acquisition unit 200 supplies the information indicating the acquired operation input to other predetermined components such as the game control unit 210.

### (Sleep Information Acquisition Unit 204)

The sleep information acquisition unit 204 acquires user's sleep information and/or error information (information indicating occurrence of an unexpected failure, occurrence of a failure of the sleep measurement unit 11, and the like) acquired by a sensor constituting the sleep measurement unit 11. More specifically, the sleep information acquisition unit 204 acquires from the sleep measurement unit 11 the information related to user's sleep, that is, the sleep information acquired by the sleep measurement unit 11. The sleep information is information on, for example, a user's awake/sleeping state, information of a user's motion, date information, a sleeping time, a bed entry time, a sleep onset time, a wake-up time, a sleep time, a depth of a user's sleep (that can be classified into, for example, a plurality of stages such as a “doze-off” stage, a “sleep-soundly” stage, a “sleep-well” stage.), quality of a sleep, a user's sleep type (as an example, a doze-off type, a sleep-soundly type, a sleep-well type, or the like) determined on the basis of the quality of the sleep or a time during which predetermined quality of the sleep continues during the sleep, and/or an environment audio during the sleep. For example, the sleep information acquisition unit 204 acquires the sleep information from start of a user's sleep (or when the user gets into bed or starts sleeping) constantly or at a predetermined time interval.

Furthermore, the sleep information acquisition unit 204 determines whether or not the user has started sleeping and whether or not the user has woken up based on the sleep information. More specifically, the sleep information acquisition unit 204 determines a point of time at which the user starts sleeping and a point of time at which the user starts waking up based on the sleep information acquired by the sleep measurement unit 11. The sleep information acquisition unit 204 supplies the acquired sleep information to the parameter control unit 206, the sleep parameter calculation unit 208, and the game control unit 210.

Furthermore, when the input acquisition unit 200 acquires an operation input of start of a sleep from the user via the input unit 102, the sleep measurement unit 11 can start acquiring information related to the user's sleep. In this case, the sleep information acquisition unit 204 determines that the user has started sleeping in response to this operation input or based on the sleep information (e.g., information such as a sensing result of the motion sensor) acquired by the sleep measurement unit 11. For example, the sleep measurement unit 11 starts acquiring the sleep information when the input acquisition unit 200 has acquired a user's sleep start instruction. Note that the sleep information acquisition unit 204 may start measuring the user's sleep time from, for example, a timing indicating a case where the measurement result of the sleep measurement unit 11 indicates that the user's motion is only a respiratory motion, and indicating a case where the user has fallen asleep deeply. Furthermore, when the input acquisition unit 200 acquires the operation input of wake-up from the user via the input unit 102, the sleep measurement unit 11 stops acquiring the sleep information of the user. In this case, the sleep information acquisition unit 204 determines that the user has woken up in response to this operation input or based on the sleep information acquired by the sleep measurement unit 11. The sleep information acquisition unit 204 acquires the sleep information measured by the sleep measurement unit 11 from start of sleep to wake-up of the user according to determination that the user has started sleeping and determination that the user has woken up.

Furthermore, the sleep measurement unit 11 may constantly acquire information related to the sleep of the user. In this case, the sleep information acquisition unit 204 determines that the user has started sleeping when the input acquisition unit 200 acquires the operation input of start of sleep from the user via the input unit 102 or based on the sleep information acquired by the sleep measurement unit 11. Furthermore, the sleep information acquisition unit 204 determines that the user has woken up when the input acquisition unit 200 acquires the operation input of wake-up from the user via the input unit 102 or based on the sleep information acquired by the sleep measurement unit 11. In this way, the sleep information acquisition unit 204 acquires the user's sleep information measured by the sleep measurement unit 11 from the time of determination that the user has started sleeping to the time of determination that the user has woken up, from sleep information that is constantly acquired.

### (Parameter Control Unit 206)

The parameter control unit 206 controls calculation of various parameters and increase/decrease of the parameters. In the game system 1, at least the following parameters are used to advance the game.
a) First parameter: The first parameter is a parameter associated with the field character 600, and is used as a parameter indicating a growth degree and an evaluation of the field character 600.
b) Sleep parameter: The sleep parameter is a parameter determined on the basis of the user's sleep information, and is determined according to the user's sleep time that is one of the sleep information. The sleep parameter may be also referred to as a “sleep score”.
c) Second parameter: The second parameter is a parameter obtained by multiplying the first parameter at a predetermined timing with the sleep parameter.

Here, the parameter control unit 206 mainly controls calculation and/or increase/decrease of the first parameter and the second parameter.

More specifically, the parameter control unit 206 increases the first parameter during an activity period except for a period during which the user is sleeping. The parameter control unit 206 may increase the first parameter during the activity period irrespectively of a user's sleep. More specifically, the parameter control unit 206 increases the first parameter by adding to the first parameter a sum value obtained by adding one or more predetermined values or sequentially adding one or more predetermined values to the first parameter during an activity period except for a period during which the user is sleeping. Note that the parameter control unit 206 supplies the first parameter to the game control unit 210 in real time, and the game control unit 210 stores the first parameter in the field character information storage unit 224 in real time (i.e., the parameter control unit 206 stores the calculated first parameter in the field character information storage unit 224 outside of the terminal device 10 to prevent a fraud.).

For example, the parameter control unit 206 calculates a sum value by adding one or more predetermined values every user's predetermined input operation accepted via the input unit 102. Furthermore, the parameter control unit 206 sets as a new first parameter a sum value obtained by adding the calculated sum value to the first parameter at the time of this input operation. In other words, when the user is awake, the parameter control unit 206 adds a predetermined value corresponding to a predetermined input operation from the user to the first parameter at the time of the user's predetermined input operation to the first parameter to obtain a new first parameter. As an example, the game control unit 210 causes a predetermined character (referred to as a “help character”) to appear in the field 500 and associates the predetermined character with a predetermined item. The predetermined item is associated with a given value (predetermined value). Furthermore, when accepting a user's predetermined operation on the character via the input unit 102, the parameter control unit 206 adds the predetermined value of the item associated with the character to the first parameter, and sets as a new first parameter the first parameter obtained after adding the predetermined value thereto.

Furthermore, the parameter control unit 206 can also determine the predetermined value based on the sleep information in the period during which the user is sleeping even when the game is left or when the game is not activated and/or without depending on the user's input operation. Furthermore, the parameter control unit 206 sets as a new first parameter a value obtained by adding the determined predetermined value to the first parameter. As an example, the parameter control unit 206 adds the predetermined value to the first parameter after the user wakes up after sleeping, and a predetermined game event caused by the game control unit 210 ends, and before the user starts sleeping next.

Furthermore, when the game is left, when the game is not activated, and/or when there is no user's predetermined input operation during the user's activity period, the parameter control unit 206 can also determine the predetermined value based on the duration of this activity period. Furthermore, before the user starts sleeping next, the parameter control unit 206 sets as a new first parameter a value obtained by adding this determined predetermined value to the first parameter. As an example, the parameter control unit 206 determines the predetermined value at a timing at which the user sleeps (e.g., a timing at which the user taps the sleep button 400 illustrated in FIG. 2B) based on a time of an activity period before the tap (e.g., a time from a time at which the user taps the measurement end button 402 illustrated in FIG. 2C to a time at which the user taps the sleep button 400 next), and adds the determined predetermined value to the first parameter to calculate a new first parameter.

Furthermore, the parameter control unit 206 stores the first parameter at the timing at which the user has started sleeping (e.g., the timing at which the user has tapped the sleep button 400 illustrated in FIG. 2B) as a sleep start time parameter (that may be referred to as “total energy” at a time of sleeping below) at the time of start of a sleep. Note that, when the sleep information acquired by the sleep information acquisition unit 204 indicates start of a user's sleep, the parameter control unit 206 may set the timing at which this sleep information has been acquired as the timing at which the user has started sleeping. The parameter control unit 206 may store the sleep start time parameters in, for example, the user information storage unit 218. Furthermore, the parameter control unit 206 may include a storage unit that stores the sleep start time parameter, and stores the sleep start time parameters in the storage unit in this case. The parameter control unit 206 supplies the calculated first parameter to the game control unit 210 and the event determination unit 212.

### (Sleep Parameter Calculation Unit 208)

The sleep parameter calculation unit 208 calculates the sleep parameter (that may be referred to as a “sleep score”) based on the user's sleep information acquired by the sleep information acquisition unit 204. For example, the sleep parameter is calculated on the basis of the user's sleep time. As an example, the sleep parameter calculation unit 208 determines a reference sleep time in advance, and, when the user takes a sleep time whose duration matches with the reference sleep time, sets the sleep parameter as a maximum value (e.g., “100”). Note that, not only when the duration of the user's sleep time completely matches with the reference sleep time, but also when a difference between the duration of the user's sleep time and the reference sleep time is within a predetermined time (e.g., approximately several minutes such as four minutes to five minutes), the sleep parameter calculation unit 208 may determine that the duration of the user's sleep time matches with the reference sleep time.

On the other hand, when the user's sleep time is shorter than the reference sleep time, the sleep parameter calculation unit 208 sets as a sleep parameter a value obtained by subtracting from “100” a predetermined amount calculated according to the difference between the reference sleep time and the user's sleep time. That is, as the user's sleep time becomes shorter than the reference sleep time, the sleep parameter decreases. Note that, even when the user's sleep time exceeds the reference sleep time, the sleep parameter calculation unit 208 sets the maximum value of the sleep parameter to the same value as that in a case where the sleep time and the reference sleep time match. In this regard, the sleep parameter calculation unit 208 can maintain user's health when the sleep time of a sleep took by the user exceeds the reference sleep time, and may calculate as the sleep parameter a value that exceeds the maximum value of the sleep parameter by the predetermined amount as long as the enjoyability of the game is not undermined. The predetermined amount may be determined according to, for example, the difference between the sleep time and the reference sleep time.

Here, the reference sleep time can be determined according to the user's personal characteristics such as an age or a generation, and/or a gender. For example, users' ages can be classified into less than 15 years, 15 years or more and 24 years or less, 25 years or more and 49 years or less, and 50 years or more, and sleep times that are considered appropriate for each classified age can be set as the reference sleep times. Furthermore, the reference sleep time may increase or decrease according to the season. For example, the reference sleep time may be made longer as the day duration time (a time from sunrise to sunset) becomes shorter, and the reference sleep time may be made shorter as the day duration time becomes longer.

The sleep parameter calculation unit 208 supplies the calculated sleep parameter to the game control unit 210 and the event determination unit 212.

### (Event Determination Unit 212)

The event determination unit 212 calculates the second parameter by multiplying the sleep parameter (i.e., sleep score) calculated by the sleep parameter calculation unit 208 with the sleep start time parameter. That is, the event determination unit 212 calculates the second parameter by multiplying the first parameter at the point of time of start of a user's sleep with the sleep parameter determined on the basis of the user's sleep time at the point of time at which the user wakes up. Furthermore, the event determination unit 212 determines a game event to be caused in the game based on the calculated second parameter. Furthermore, the event determination unit 212 also generates game event information that is information of the game event to be caused.

Note that the game event is various events that occur in the sleep game. Examples of the game event include an event that causes a character to appear around the field character 600 in the field 500, an event that gives an appearing character as a help character to the user based on a predetermined operation on the appearing character, an event that changes a status of the help character based on the user's sleep time, an event that gives a predetermined reward to the user, an event that gives to the user a predetermined point determined according to the user's sleep time, and the like.

The event determination unit 212 supplies the game event information to the game control unit 210. The game control unit 210 executes a predetermined game event based on the game event information, and causes the output unit 100 to output the contents of the game event via the output control unit 202. Furthermore, the game control unit 210 stores predetermined information based on the game event information and/or predetermined information based on execution of the game event in a predetermined storage unit of the storing unit 216.

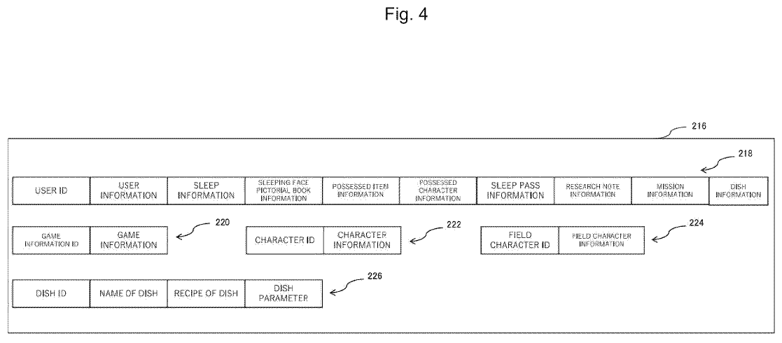

FIG. 4 illustrates an example of a data configuration of each storage unit included in a storing unit included in the game system according to the present embodiment.

### (Storing Unit 216)

The storing unit 216 stores various information related to the game system 1. Each storage unit included in the storing unit 216 supplies predetermined information to a predetermined component in response to a request from another component of the game system 1.

### (Storing Unit 216: User Information Storage Unit 218)

The user information storage unit 218 stores, in association with a user ID for identifying a user, for example, user information, sleep information that is information related to a user's sleep, sleeping face pictorial book information that is information related to a sleeping face pictorial book for storing image information of a character (such as image information of a sleeping face of the character) appearing in the game acquired by the game control unit 210 in response to a user's instruction, information related to a possessed item possessed by the user, information related to a possessed character possessed by the user, sleep pass information for recording a predetermined point (that may be referred to as a “sleep point” below) or the like to be given to the user as the game advances, research note information that is predetermined information recorded on the basis of a user's action in the game, mission information that is information related to a predetermined mission set to the user in the game, and/or dish information related to a virtual dish in the game.

Examples of the user information include a user name set by the user, a log-in ID, a password, a user's gender or birth date, a rank determined on the basis of the user's sleep time or the like, and/or information related to cryptocurrency in the game owned by the user (information related to the amount of owned cryptocurrency. Examples of the information include information of the amount of owned cryptocurrency given to the user for free, and information related to the amount of owned cryptocurrency given to the user for value). The user information may also include information related to a time of an alarm set by the user, game history information, and the like. The game history information is information related to an operation input executed by the user in the game.

The sleep information includes various user's sleep information (including the above-described sleep information and/or the number of continuous measurement days during which the sleep information has been acquired) measured by the sleep measurement unit 11, the sleep start time parameter, and the like. Furthermore, the sleep information may be associated with a date and time at which the sleep information acquisition unit 204 has acquired the sleep information. For example, the user information storage unit 218 can associate the user's sleep time as the sleep information with the date and time to store as sleep history.

The sleeping face pictorial book information includes information for various sleeping face pictorial books of characters that have appeared around the field character 600 and for which a user's operation input (a predetermined instruction such as a user's selection instruction by the user) has been made. Note that the character instructed by the user does not become a character possessed by the user according to the instruction, and, when a predetermined condition is satisfied, the character is given to the user. Furthermore, the sleeping face pictorial book information is, for example, an image of a character (e.g., images at a time at which the character is awake, sleeping face images, sleeping position images, and the like.), unique information of the character (e.g., a name, a sleep type indicating the degree of depth of a sleep, an explanation of the character, and the like), and the like, and is associated with a sleeping face pictorial book information identifier. Note that the sleeping face pictorial book information can be also stored in a storage unit different from the user information storage unit 218. In this case, the user information storage unit 218 stores the sleeping face pictorial book information identifier of the character for which the user's operation input has been performed as sleeping face pictorial book information such that the game control unit 210 can acquire the sleeping face pictorial book information of the character requested by the user from this different storage unit at any time.

Examples of possessed item information include information related to a game item possessed by the user. Examples of the game item include an item that is drawn by the game control unit 210 based on the user's sleep information and given to the user, an item that is given to the user during an activity period, an item that is given to the user when the contents of declaration made by the user is executed, and/or an item that is given to the user as the user executes a predetermined game operation. These game items may be items that are given as rewards to the user and/or items that are given to the user when the user consumes cryptocurrency in the game. The possessed item information also includes information such as the type and the quantity of each game item. Furthermore, the possessed item information also includes information related to a stamp card to be described later.

The possessed character information is information related to a character acquired by the user in the game, and includes, for example, information such as a character ID of the possessed character, a level of the possessed character, a skill of the possessed character, a sleep time during which the possessed character sleeps together with the user, and the like. Note that the game control unit 210 enables the character acquired by the user to be used as a help character in response to a user's instruction. Here, the help character refers to a character that supports the user to grow the field character 600 in the field 500 in the game, and executes an action of, for example, automatically collecting predetermined items in the game without a user's operation. Here, the game control unit 210 organizes a predetermined number of characters among characters possessed by the user as a party, and causes the characters as the help characters (the party of the help characters) to assist the user to execute the game. When the user takes a sleep, the game control unit 210 regards that the character organized in the party has slept together with the user, and sets the user's sleep time as the sleep time during which the character organized in the party has taken a sleep. That is, when the user records the sleep, the user information storage unit 218 accumulates and stores information of the user's sleep time as one of the possessed character information per possessed character. Consequently, each character possessed by the user is associated with a sleep time that has been taken so far (a time during which each character has been considered to take a sleep together with the user, that is, an accumulated sleep time.). Furthermore, the game control unit 210 can output the accumulated sleep time (cumulative sleep time) of each possessed characters to the output unit 100 or the like in response to a user's instruction. As described above, the user information storage unit 218 can store the cumulative sleep time of each possessed character and the user can refer to this cumulative sleep time, so that the game system 1 can provide the user with such an experience that the user and the character (including user's favorite characters) possessed by the user have taken a sleep together.

Note that, in response to a user's predetermined operation, the game control unit 210 may output information that is related to the possessed character and stored in the character information storage unit 222 in association with a character ID of the possessed character, and that the user is permitted to browse, from the output unit 100 such that the user can perceive the information. Consequently, the user can grasp the characteristics of the character (e.g., a help ability to be described later) possessed by the user and execute the game.

Examples of the sleep pass information include information such as a sleep pass type (e.g., a type indicating a pass for non-in-app purchase or a pass for in-app purchase), a sleep point given to the user based on the user's sleep information, a browsing condition of user's past sleep data (part or all of data extracted from the user's sleep information acquired by the sleep information acquisition unit 204), and a predetermined benefit in a case of the pass for in-app purchase. Note that the sleep point may be, for example, a point given to the user according to the sleep parameter (sleep score) determined on the basis of the user's sleep time (as an example, for one point of the sleep score, one point of the sleep point is given to the user.). The sleep point may be used for exchange with an item of a relatively high price (e.g., an item that can be got only in exchange with consumption of the sleep point during the game) in exchange with consumption of a predetermined amount of the sleep point according to user's selection.

The research note information includes information related to items or the like discovered in the game by the user by executing the game (e.g., information related to the names of the discovered items, an explanation of the items, and the like). Furthermore, the mission information includes information related to a predetermined mission set to the user by the game control unit 210. The mission information is information that defines a goal that the user needs to achieve within one unit game period. Examples of the mission information include information such as a goal for collecting sleeping face images of a predetermined number of characters in one unit game period, a goal for getting a predetermined number of characters, or a goal for increasing the level of the field character 600 to a predetermined level. The game control unit 210 gives a predetermined reward to the user when the user achieves a mission.

The dish information includes information related to dishes executed by the user in the past. For example, the number of times of execution of a recipe of the dish, a level of the recipe (recipe level) determined on the basis of the number of times of execution, and/or a recipe level bonus (a bonus for increasing a dish parameter associated with the dish by a predetermined amount) determined on the basis of the recipe level, and the like are recorded as user's dish information in association with a dish ID for identifying the dish. The recipe level is a value that increases as a dish is cooked using the same recipe. Furthermore, as the recipe level increases, a predetermined value (recipe level bonus value) determined according to the increase is added to the dish parameter.

### (Storing Unit 216: Game Information Storage Unit 220)

The game information storage unit 220 stores the game information in association with a game information ID. The game information includes various information such as information related to the one or more fields 500 existing in the virtual space in the game (e.g., information of field names, information related to characters appearing in the fields, information related to conditions recommended when the user visits the field, and the like), information related to items in the game, information related to drawing of an item (e.g., information related to a predetermined lottery table), information related to cryptocurrency in the game, useful information related to a sleep, statistics information related to the sleep, and/or predetermined audio and music information. Note that the game information storage unit 220 may store game information for users who have little game experience as game information for a tutorial or beginners. Furthermore, the game information storage unit 220 may store the lottery table used to draw a character. The lottery table is stored in the game information storage unit 220 in association with, for example, the type of field 500, the type of a user's sleep, or the like.

### (Storing Unit 216: Character Information Storage Unit 222)

The character information storage unit 222 stores character information in association with a character ID for identifying a character. The character information includes information related to various images/moving images/audios of the character, rarity (the degree of rareness) of the sleeping face of the character, the type (attribute) of the character (e.g., information indicating an attribute of the character such as an electricity type, a flame type, or a grass type), a sleep type (as an example, a doze-off type, a sleep-soundly type, a sleep-well type, and the like), a type/name, a gender (note that there may be also characters that have no gender), a personality, an experience value, a level, an energy parameter (as the “energy” parameter is larger, execution efficiency of predetermined processing becomes higher during the user's activity period. The energy parameter may be referred to simply as “energy” below), a skill, a special point indicating the strength of the character (note that the special point increases as the level of the character improves.), a character evolution condition, the degree of intimacy with the user, and/or information related to the help ability.

Note that the character image may include a plurality of types of images (sleeping face images or sleeping position images) of one character. Furthermore, there may be images of an extremely special sleeping face (special sleeping face) in association with each of the plurality of types of images of one character. In a case where, for example, there is one type of an image of one character, there may be one type of a special sleeping face image corresponding to the one type of the image.

Furthermore, the image of the character may be, for example, an image that differs per sleep type. Furthermore, the type (attribute) of the character and the sleep type of the character may be associated. For example, a sleep type of the “sleep-soundly type” may be associated with a character whose attribute is “flame” or “electricity”. Similarly, a predetermined sleep type may be also associated with other attributes. Furthermore, the degree of intimacy with the user can be expressed by a numerical value, and a maximum value of the numerical value may be different or identical per character. Furthermore, the maximum value of the degree of intimacy may increase according to the level of the character. Furthermore, the evolution of the character means that, when a predetermined condition is satisfied, the character changes to an evolution target character of different character information.

Here, when the degree of intimacy of the character reaches the maximum value, the game control unit 210 may give the character to the user. The degree of intimacy between the character and the user increases when the character and the user encounter and, for example, the user gives a predetermined item to the character. The predetermined item has a function of increasing the degree of intimacy by a predetermined amount (e.g., the predetermined item is associated with a predetermined numerical value, and, when the user gives the item to the character, the associated numerical value is added to the numerical value of the degree of intimacy.). Furthermore, when the user gives the predetermined item to the character, the game control unit 210 compares the numerical value (post-addition numerical value) of the degree of intimacy of the character obtained after adding the numerical value associated with the item, and a maximum value of the degree of intimacy associated with the character in advance, and, when the post-addition numerical value reaches the maximum value, makes the character a character possessed by the user. On the other hand, when the post-addition numerical value of the character to which the predetermined item has been given does not reach the maximum value associated with the degree of intimacy in advance, the game control unit 210 stores the post-addition numerical value. When the predetermined item is given to the character again, the game control unit 210 adds the numerical value associated with the predetermined item given again to the stored post-addition numerical value. Furthermore, the game control unit 210 determines whether or not a numerical value obtained by the addition reaches the maximum value associated with the degree of intimacy in advance. As described above, when the user gives to the character the predetermined item for improving the degree of intimacy, even if the item is given once, and the post-addition numerical value does not reach the maximum value associated with the degree of intimacy in advance, the game control unit 210 can take over the post-addition numerical value to a next or subsequent day. Furthermore, when the predetermined item is given to the character again at a next or subsequent time, the game control unit 210 can repeat a process of improving the degree of intimacy by adding a numerical value associated with a newly given predetermined item to the taken-over post-addition numerical value. Consequently, the user can repeatedly give a predetermined item to a character by repeating sleeping, and acquire the character by setting the degree of intimacy of the character to the maximum value.

Furthermore, when the game control unit 210 gives a character to the user by a lottery, the game control unit 210 also determines the personality of the character by the lottery. The game control unit 210 can execute, for example, calculation of a getting probability of items (e.g., a growth item 650 that is a direct growth item to be described later or an ingredient that is an indirect growth item), calculation of a recovery amount of “energy”, and/or calculation of the got amount of experience values based on the personality. Furthermore, the help ability is information related to a predetermined item (an item such as the growth item 650 to be described later, an ingredient of a dish, and the like) that is easily won by a predetermined lottery (that is, is easily collected by the character in the game) when the character becomes a help character.

### (Storing Unit 216: Field Character Information Storage Unit 224)

The field character information storage unit 224 stores information related to a field character in association with a field character ID for identifying the field character 600. Examples of the information related to the field character include various images/moving images/audios of the field character 600, the level of the field character 600, information related to an item (favorite food information) that is a favorite food of the field character 600, information (request information) related to a dish in the game requested by the field character 600, and the like. Note that the field character information storage unit 224 may store field character information for users who have little game experience as information for the tutorial or beginners.

### (Storing Unit 216: Dish Information Storage Unit 226)

The dish information storage unit 226 stores information related to a dish in association with a dish ID for identifying the dish. The information related to the dish includes information such as a dish name, a dish recipe, and a dish parameter. The dish recipe is information related to virtual ingredients in the game required for cooking the dish, and includes information of the types and the number of ingredients required for the cooking. Furthermore, the dish parameter is a value associated with the dish, and is a value that is added to the first parameter of the field character when the dish is given to the field character.

### [Flow of Processing of Game System 1]

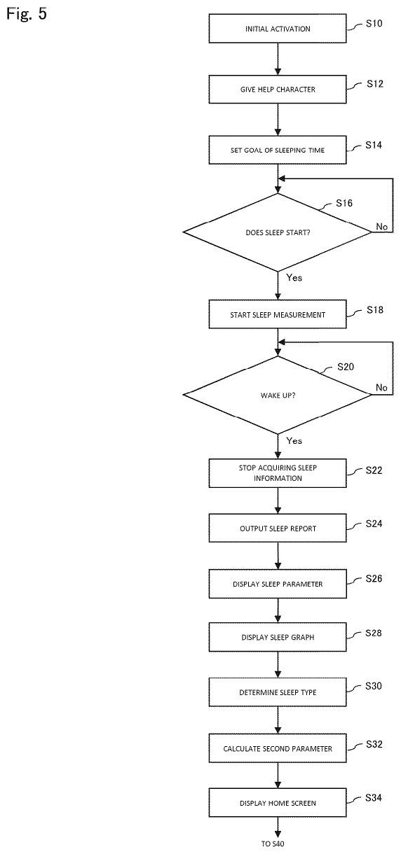

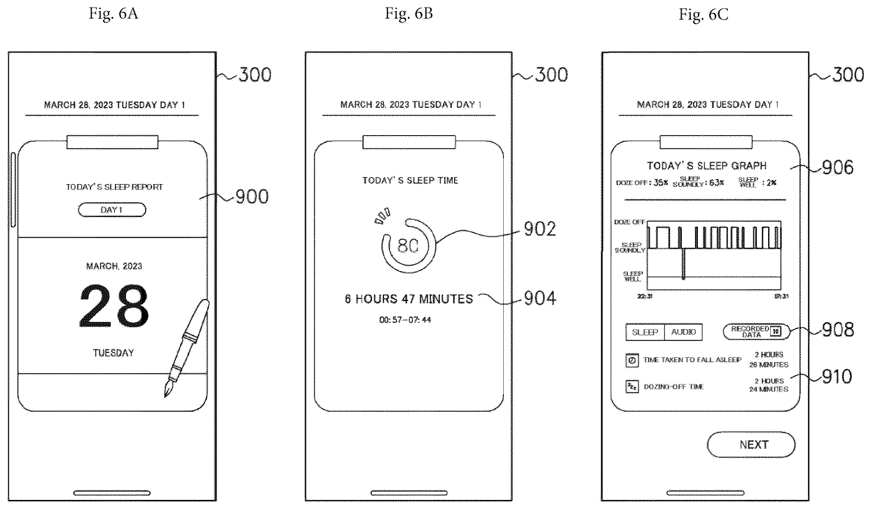

FIGS. 5, 8, 13, 17 to 19, 22, and 23 illustrate examples of a flow of processing of the game system according to the present embodiment. Furthermore, FIGS. 6A-6C, 7A-7C, 9A-9C to 12A-12C, 14A-14C to 16A-16C, 20A-20C, and 21 illustrate examples of display contents in the game system according to present embodiment. Note that the case where the user uses the terminal device 10 will be described below.

In the game system 1, a tutorial is started at a time of initial activation. In this regard, at a time of start of this tutorial, only a minimum necessary operation input is accepted from the user. Furthermore, a detailed tutorial is executed after the user sleeps and wakes up, and, after execution of the tutorial ends, part of information in the game processing in the tutorial is taken over to a first unit game period, and the first unit game period is started. Thereafter, after one unit game period ends after this first unit game period, the game system 1 takes over part of information in the one unit game period to a next unit game period of the one unit game period (resets the rest of information), and repeats the flow of advancing the game in the next unit game period. Here, an overview of the flow of the processing of the game system 1 will be described in the following order. In the following description, an example where the unit game period is seven days will be described. Note that the steps are represented as “S” in the following description.
(A) Overview of worldview of game system 1
(B) Processing from point of time after initial activation to start of unit game period
(b-1) Processing from initial activation to point of time after start of sleep (S10 to S18)
(b-2) Processing at time of wake-up (S20 to S52)
(b-3) Unit game period start processing (S54 to S56)
(C) Processing after start of unit game period
(c-1) Processing from middle of activity period to start of sleep
(c-1-1) Field character growth processing using item/dish
(c-1-1-1) Field character growth processing using item (S60 to S110)
(c-1-1-2) Field character growth processing using dish (S60 to S110)
(c-1-1-3) Game assist processing
(c-1-2) Field character automatic growth processing (S90 to S100)
(c-2) Processing after start of sleep (S102 to S110)
(c-3) Processing at time of wake-up (S200 to S238)
(D) Processing on last day of unit game period (S250 to S260)
(E) Other processing
(e-1) Main menu
(e-2) Help character level increase and evolution processing (S300 to S312)
(e-3) Change of sleep information by manual input (S400 to S406)
(e-4) Sleep pass processing
(e-5) Field bonus processing

### <(A) Overview of Worldview of Game System 1>

The game system 1 expresses that, in a field in the virtual space in the game, a field character lives and various other characters live. By visiting this field and taking a sleep in the real world together with a help character possessed by the user, the user collects information of other characters that appear around the field character. Thus, the game intends to collect information and images of various fields and various characters living in each field to make a pictorial book. More specifically, the user gives an instruction to a character (help character) possessed by the user, and the help character raises (grows) the field character by giving a predetermined item (a nut, a dish, and the like) to the field character. Predetermined energy (first parameter) of the field character increases in response to this raising. Furthermore, another character visits to sleep around the field character according to the magnitude of the energy (second parameter) calculated by multiplying on the first parameter a sleep score determined on the basis of sleep information of a sleep when the user takes the sleep. The user acquires an image of another character that has visited to sleep, and thereby the user acquires various information of the another character and registers the acquired various information in the pictorial book. Furthermore, when the user gives a predetermined item to the another character, the degree of intimacy between the user and the another character increases. When the degree of intimacy reaches a predetermined threshold, the user can acquire the another character and use the got another character as a new character. As described above, in the game system 1, a user's sleep in the real world plays an important role in getting various characters.

<(B) Processing from Point of Time after Initial Activation to Start of Unit Game Period>
[(b-1) Processing from Initial Activation to Point of Time after Start of Sleep]

First, after initial activation, the game system 1 executes the tutorial and accepts only a minimum necessary game operation until the user sleeps. Thus, the game system 1 according to the present embodiment makes the user take an initial sleep without making the user perform an operation as much as possible immediately before the sleep from viewpoints of preventing the user from immersing in the game immediately before the sleep and enabling the user to take the appropriate sleep. Hence, the game system 1 notifies the user of details of the game at a timing at which the user wakes up after the user sleeps after initial activation of the game. Accordingly, from initial activation to the time of start of sleep, the game system 1 executes limited steps such as an operation at the time of initial activation (S10), giving of a help character (S12), setting of a goal of a sleeping time (S14), and start of acquisition of sleep information based on start of sleep (S16) to start measuring a user's sleep (S18), and notifies the user of details of the game while advancing the game after the user wakes up (S20 or subsequent steps).

Note that the game system 1 may ban or restrict execution of, for example, the following functions before the tutorial is completed.
a) Function of purchasing items and passes by in-app purchase
b) Function of increasing and raising first parameter of field character
c) Function of collecting growth items by help character
d) Function of cooking dish to be given to field character
e) Help character party organization function

Hereinafter, a flow of processing of the game system 1 will be described in detail.

First, when the game is activated for the first time in the game system 1, a tutorial part is started. That is, as illustrated in FIG. 5, when acquiring a user's input operation to start game for the first time from the input acquisition unit 200 via the input unit 102, the game control unit 210 determines that the game has been started for the first time, and starts the tutorial of the game (S10). In this case, the game control unit 210 determines in advance the field 500 (the field 500 as illustrated in FIG. 2A) that the user visits. That is, the game control unit 210 determines the field 500 and the field character 600 in advance such that any user does not get confused with a game operation in the game at the time of initial activation. Note that the game control unit 210 may refer to the game information storage unit 220 and the field character information storage unit 224, and sets the field 500 and the field character 600 for the tutorial or beginners as the field 500 and field character 600 determined in advance. Here, the level of this field character 600 may be an initial value (e.g., level 1). Furthermore, the game control unit 210 controls the output control unit 202 to cause the output unit 100 to output limited information related to the overview of the game (i.e., a small amount of information that does not bother the user's sleeping motion. The information is typically an amount of information that can be sent within 30 seconds to three minutes.) in formats such as texts, images, and/or audios.

Next, the game control unit 210 gives a predetermined character as a help character to the user (S12). The game control unit 210 gives to the user a predetermined type of a character among the characters stored in the character information storage unit 222 (note that the number of characters to be given may be one). The game control unit 210 stores information related to the character given to the user as possessed character information in the user information storage unit 218. Thus, this help character becomes a character possessed by the user.

Furthermore, the game control unit 210 controls the output control unit 202 to cause the output unit 100 to output a form for accepting goal settings (that may be referred to as a “promise of sleep”) of a time at which the user sleeps. The game control unit 210 sets the time acquired from the form by the input acquisition unit 200 via the input unit 102 and input by the user to a goal of the sleeping time (that may be referred to as a “goal sleeping time” below.) (S14). The game control unit 210 compares a user's sleeping time indicated by the sleep information acquired by the sleep information acquisition unit 204 and the goal sleeping time, and manages a user's goal achievement status. After the promise of sleep is set, the game control unit 210 controls the output control unit 202 to cause the output unit 100 to output a home screen (e.g., a screen on which the field character 600 is displayed in the field 500 as illustrated in FIG. 2B). This home screen displays the sleep button 400 that accepts start of a sleep from the user as illustrated in, for example, FIG. 2B.

Subsequently, the sleep information acquisition unit 204 determines whether or not the user starts sleeping based on the user's sleep start instruction accepted via the input unit 102 (e.g., it is possible to determine that the user has made the instruction when detecting a user's operation input on the sleep button 400.) (S16). First, when determining that the user has not started sleeping (No in S16), the sleep information acquisition unit 204 stands by for acquisition of the sleep information until the user starts sleeping. On the other hand, when the sleep information acquisition unit 204 determines that the user starts sleeping (Yes in S16), the sleep information acquisition unit 204 causes the output unit 100 to output a button (e.g., a button “to start sleep measurement”) for accepting an instruction to start sleep measurement from the user. Furthermore, when accepting the user's instruction on the button via the input unit 102, the sleep information acquisition unit 204 starts acquiring the user's sleep information (i.e., sleep measurement) measured by the sleep measurement unit 11 (S18).

Note that the sleep information acquisition unit 204 starts measuring a sleep time that is one of the sleep information from a timing at which user's motion information included in the sleep information indicates stop of a user's motion or a timing at which information of quality of a user's sleep included in the sleep information indicates that the user has fallen asleep deeply. For example, the sleep information acquisition unit 204 acquires information (vibration information) related to vibration during a user's sleep via an acceleration sensor or the like constituting the sleep measurement unit 11, and starts measuring the sleep time when the vibration information indicates that the user's motion stops or becomes a motion of a predetermined criterion or less (i.e., when the user falls asleep).

Here, the game control unit 210 may not cause the output unit 100 to output the time at which the user has fallen asleep (a measurement start time of the sleep time) until the user wakes up (i.e., the time may be encrypted until the user wakes up). Consequently, it is possible to make it difficult for the user to grasp a user's actual sleep time until it is determined that the user has woken up, and consequently improve enjoyability of the sleep game.

Furthermore, the sleep information acquisition unit 204 causes the sleep measurement unit 11 to start measurement when the sleep measurement unit 11 is not performing a measurement operation, and starts acquiring the sleep information measured by the sleep measurement unit 11 from the point of time of start of a user's sleep when the sleep measurement unit 11 is constantly performing measurement. Note that the sleep information acquisition unit 204 may set a condition for acquiring the sleep information of sleep measurement and/or a condition of the number of times of sleep measurement that can be performed a day. For example, the condition for acquiring the sleep information may be a condition for acquiring the sleep information when the sleep information acquisition unit 204 acquires continuation of sleep measurement for a predetermined time (as an example, 1 hour 30 minutes) or more. Furthermore, the condition of the number of times of sleep measurement may be a condition that enables sleep measurement up to two times a day. Consequently, the game system 1 can permit the user to fall back asleep or to take a segmented sleep, that is, permit the user to sleep a plurality of times, and can support a variety of user's lifestyle. After, for example, tapping the button “to start sleep measurement”, the user places on the bedside or the like the terminal device 10 that is left with the game activated, and sleeps.

Note that the sleep information acquisition unit 204 acquires an environmental audio during a user's sleep constantly or at a predetermined time interval as sleep measurement starts. For example, the sleep information acquisition unit 204 activates a microphone of the terminal device 10 and constantly acquires an environment audio using the microphone. The sleep information acquisition unit 204 stores the acquired environment audio in the terminal device 10 in association with a recording date and time, and does not store the environment audio in a storage unit outside of the terminal device 10.

Furthermore, after the sleep information acquisition unit 204 starts the sleep measurement, the game control unit 210 causes the display unit 300 to display, for example, a screen that displays that the sleep measurement is being performed as illustrated in FIG. 2C. Here, the game control unit 210 causes the screen to display a button that accepts the following settings.

### a) Alarm Settings

The game control unit 210 causes the display unit 300 to display the alarm settings area 410, and makes it possible to accept an input from the user and set an alarm time (i.e., a time at which an alarm is set out at a time designated by the user). The game control unit 210 causes the output unit 100 to output a predetermined alarm sound when the time set by the user comes. Furthermore, the game control unit 210 can also set a smart alarm. That is, the game control unit 210 detects and estimates a timing at which the user easily wakes up based on the sleep information acquired by the sleep information acquisition unit 204, and can also cause the output unit 100 to output an alarm sound at a time that is before an alarm time set by the user and is earlier by the time set by the user (the time set by the user can be set to, for example, 0 minute, 5 minutes, 10 minutes, or 15 minutes, and, when the set time is “0 minute”, the smart alarm does not operate.). By setting the smart alarm, the alarm sound may be output from the output unit 100 before the time set by the user. Note that the game control unit 210 may accept a user's operation input on the alarm settings area 410, and cause the display unit 300 to display various settings screens for an alarm such as settings of a type of the alarm sound, settings of a volume of the alarm sound, and/or settings of snooze. The game control unit 210 accepts a user's operation input on the various settings screens, and executes settings such as the type of the alarm sound, the volume of the alarm sound, and/or whether or not to set snooze.

### b) Settings of Sleep Induction Sound

The game control unit 210 causes the display unit 300 to display a sleep induction sound settings area 412, accepts an input from the user, and makes it possible to output a sleep introduction sound. The game control unit 210 causes the output unit 100 to output the sleep induction sound set by the user as the sleep information acquisition unit 204 starts the sleep measurement. Furthermore, when the sleep information acquired by the sleep information acquisition unit 204 indicates a predetermined state in, for example, a case where the user's motion stops or a case where the user falls asleep deeply, the game control unit 210 stops the output of the sleep induction sound from the output unit 100. Note that the game control unit 210 can also gradually lower the volume of the sleep induction sound output from the output unit 100 based on the sleep information acquired by the sleep information acquisition unit 204 and an elapsed time from start of the sleep measurement.

[(b-2) Processing at Time of Wake-Up]

Furthermore, the sleep information acquisition unit 204 determines whether or not the user has woken up based on measurement contents of the sleep measurement unit 11 or the user's wake-up instruction accepted via the input unit 102 (S20). When the sleep information acquisition unit 204 determines that the user is not awake (No in S20), the sleep information acquisition unit 204 continues acquiring the sleep information. On the other hand, when the sleep information acquisition unit 204 determines that the user has woken up (Yes in S20), the sleep information acquisition unit 204 stops acquiring the user's sleep information measured by the sleep measurement unit 11 (S22). For example, the sleep information acquisition unit 204 causes the output unit 100 to output a button (as an example, a button “to end measurement” as illustrated in FIG. 2C) that accepts an instruction to end the sleep measurement from the user. Furthermore, when accepting the user's instruction on the button via the input unit 102, the sleep information acquisition unit 204 stops acquiring the user's sleep information measured by the sleep measurement unit 11 (S22). Note that the sleep information acquisition unit 204 may stop measuring the sleep time at a timing at which the sleep information indicates, for example, that the user's motion indicates a predetermined motion. At a timing at which the sleep information acquisition unit 204 stops acquiring the sleep information, the sleep information acquired by the sleep information acquisition unit 204 is collectively supplied to the sleep parameter calculation unit 208 and the game control unit 210 (is collectively supplied to the server when these components are provided in the server).

Subsequently, the game control unit 210 causes the output unit 100 to output a sleep report (a report of information such as a game progress result determined on the basis of a user's sleep and a status of the user's sleep) based on the accepted sleep information (S24). Hereinafter, a case where the output unit 100 is the display unit 300 will be mainly described. Note that the game control unit 210 may skip following S24 to S32 in response to an instruction from the user.

First, the game control unit 210 causes the display unit 300 to display information indicating what day of a unit game period a year, a month, and a date in which the user wakes up and a day on which the user wakes up is as a sleep report 900 based on the sleep information (see FIG. 6A). In an example in FIG. 6A, the “first day” of the unit game period, and the year, the month, and the date, and the day of the week of the “first day” are displayed as a today's sleep report.

Subsequently, when the input unit 102 accepts a user's operation input, the game control unit 210 displays a user's sleep time 904 calculated on the basis of the sleep information on the display unit 300 as illustrated in FIG. 6B. Furthermore, in this case, the sleep parameter calculation unit 208 calculates a sleep parameter (sleep score) based on the user's sleep time included in the sleep information. Furthermore, the sleep parameter calculation unit 208 displays a sleep parameter 902 calculated as illustrated in FIG. 6B around the sleep time 904 of the display unit 300 (on the upper side of the sleep time 904 in the example in FIG. 6B) (S26). The sleep parameter, that is, the sleep score is determined on the basis of the duration of the sleep time. As an example, in a case where the user is an adult, the reference sleep time is set to 8 hours 30 minutes, and, in a case where this reference sleep time and the user's sleep time match (or in a case where a difference between the reference sleep time and the user's sleep time is within a predetermined time), the sleep score is set to “100” points. Furthermore, in a case where the user's sleep time is shorter than the reference sleep time, the sleep score is subtracted from the “100” points according to the difference between the reference sleep time and the user's sleep time. The example in FIG. 6B indicates that the sleep parameter 902 is “80” points and the sleep time 904 is 6 hours 47 minutes. As described above, by causing the display unit 300 to display the sleep parameter 902 such that the user can perceive the sleep parameter 902, user's consciousness to take a long time of a sleep as much as possible readily works.

Next, the game control unit 210 displays a user's sleep graph 906 created on the basis of the sleep information on the display unit 300 as illustrated in FIG. 6C (S28). The sleep graph 906 is a graph indicating the user's sleep depth at each time from a time of start of a user's sleep to a time of wake-up, and the horizontal axis indicates the time and the vertical axis indicates the sleep depth. For example, the sleep depth is divided into a plurality of stages according to the depth of a user's sleep indicated by the sleep information. As an example, the plurality of stages may be three stages of the shallowest sleep stage (“doze-off” stage), the second shallowest sleep stage (“sleep-soundly” stage), and the deepest sleep stage (“sleep-well” stage). The game control unit 210 classifies the sleep depth at each time during the user's sleep into any of the three stages based on the sleep information, then generates the sleep graph 906 by graphing the stages of the sleep depth in time series, and displays the sleep depth on the display unit 300. In this case, the game control unit 210 can calculate the ratio of the duration of time at each stage of the sleep depth with respect to the user's sleep time as a numerical value, and include the numerical value in the sleep graph 906. In the example in FIG. 6C, the sleep graph 906 indicates that the “doze-off” stage is a duration that is 35% of the user's sleep time, the “sleep-soundly” stage is 63%, and the “sleep-well” stage is 2%.

Furthermore, using the sleep information, the game control unit 210 may cause a sleep contents display area 910 of the display unit 300 to display together with the sleep graph 906 a time (a “time taken to fall asleep”) required until the user sleeps (e.g., a timing at which the user's motion stops or a timing at which the user falls asleep deeply) after the user gets into bed (from, for example, a timing at which sleep measurement is started in response to a user's instruction in S18), and a time of each stage of the sleep depth. The sleep contents display area 910 is arranged below the sleep graph 906 in the display unit 300. The example in FIG. 6C indicates the “time taken to sleep asleep” is “2 hours 26 minutes”, and the time at the “doze-off” stage is “2 hours 24 minutes” below the sleep graph 906. Note that information of times at the other stages of the sleep depth is arranged below the time at the “doze-off” stage, and can be displayed on the display unit 300 by a user's swipe operation on the display unit 300.

Here, the game control unit 210 can also cause the output unit 100 to output an environment audio during a user's sleep in response to the user's instruction accepted via the input unit 102. As illustrated in, for example, FIG. 6C, the game control unit 210 displays a recorded data 908 button in a predetermined area of the display unit 300. When the input unit 102 accepts a user's instruction on the recorded data 908 button, the game control unit 210 outputs the environment audio during the sleep time from the output unit 100. Here, the environment audio is recorded every divided predetermined interval (e.g., 10 minutes). That is, the environment audio is stored in the terminal device 10 as a plurality of unit environment audios obtained by dividing by the intervals a time from the time of start of sleep to the time of wake-up. The game control unit 210 can cause the output unit 100 to output an arbitrary unit environment audio in response to a user's instruction. Note that the game control unit 210 does not supply the environment audio to the outside of the terminal device 10.

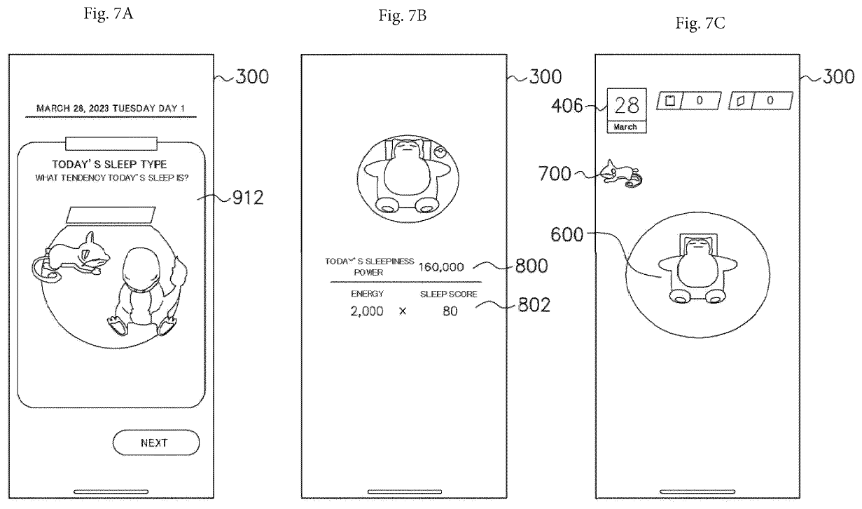

Next, the game control unit 210 determines a user's sleep type based on the sleep information acquired by the sleep information acquisition unit 204 (S30). The game control unit 210 displays the determined sleep type in a sleep type display area 912 of the display unit 300 as illustrated in FIG. 7A. In an example in FIG. 7A, a “sleep-soundly type” is displayed. Note that a “doze-off type” and a “sleep-well type” may be defined as sleep types in addition to the “sleep-soundly type”. Here, the sleep type indicates characteristics of a user's sleep on a day on which the user takes a sleep. More specifically, the game control unit 210 compares user's past sleep information (e.g., information such as the sleep depth and a continuation time of the sleep depth) stored in the user information storage unit 218 and the sleep information on the day on which the user takes a sleep, and determines the sleep type. When there is no sleep information stored in the user information storage unit 218 and the sleep information is less than a predetermined amount, the game control unit 210 may compare the sleep information and general sleep information (that may be stored in, for example, the game information storage unit 220), and determines the user's sleep type. Furthermore, the game control unit 210 can reflect a more fine change in the characteristics of a user's individual sleep in the sleep type by repeating sleep measurement for a user's sleep. When, for example, the sleep information on the day on which the user takes a sleep is deeper than the user's past sleep information (e.g., sleep information indicating the “sleep-soundly” type), the game control unit 210 may determine the “sleep-soundly type” as the sleep type.

Furthermore, the event determination unit 212 calculates the second parameter by multiplying the sleep parameter (sleep score) calculated by the sleep parameter calculation unit 208 with the sleep start time parameter (S32). In this regard, the tutorial is being executed in this case, and the function of increasing and raising the first parameter of the field character is restricted (typically stopped). Hence, when the first parameter is set to zero (i.e., the initial value is set to zero) at the point of time at which the user has started the tutorial, the sleep start time parameter also becomes zero together with the first parameter, and the second parameter calculated by multiplying the sleep start time parameter also becomes zero. Hence, the event determination unit 212 sets a value that is not zero as the initial value of the sleep start time parameter. As an example, as illustrated in FIG. 7B, the event determination unit 212 sets “2,000” as the initial value of the sleep start time parameter (i.e., the first parameter and a parameter at the time of start of the user's sleep). Furthermore, the event determination unit 212 calculates the second parameter by multiplying the initial value with the sleep score. In the example in FIG. 7B, the display unit 300 displays the second parameter 800 (“today's sleepiness power”) as “160,000”, and the sleep start time parameter (displayed as “energy”) is displayed as “2,000” and the sleep score is displayed as “80” as the breakdown 802 of the second parameter 800 below the second parameter 800.

Hereinafter, the significance of the first parameter and the second parameter in the game will be described.
a) The first parameter is a value that increases as a result of a predetermined action or the like during the user's activity period, and represents a degree of growth or a growth degree of the field character 600. Furthermore, an evaluation (character evaluation) of the field character 600 is determined according to the magnitude of the first parameter. Note that the evaluation is determined stepwise according to the first parameter. Furthermore, the game control unit 210 changes the lottery table used to draw a character appearing around the field character as the “evaluation” increases, and changes the character that appears as a result of the drawing. In response to the increase in this evaluation, the lottery table may be used from which a character having a sleeping face of high rarity can be easily won. Here, the game control unit 210 can also change drawing conditions of characters appearing around the field character as the “evaluation” increases (e.g., the game control unit 210 can change the drawing conditions to conditions advantageous for the user such that a character having a sleeping face of high rarity for the user is easily won.). Furthermore, the first parameter is mainly a parameter stored before the user wakes up (before the user falls asleep). Note that the game control unit 210 enlarges the size of a field character 602 displayed on the display unit 300 according to the evaluation of the field character 602 (may increase the size as the evaluation is higher.).
b) The second parameter is a value that indicates power shown by the field character 600, and the number of characters (characters that visit to sleep) appearing around the field character 600 increases according to the magnitude of the power. Furthermore, as the second parameter becomes larger, it becomes easier to discover a character of a higher degree of rarity or a sleeping face of a character of a higher degree of rarity.

### (Sleep Research)

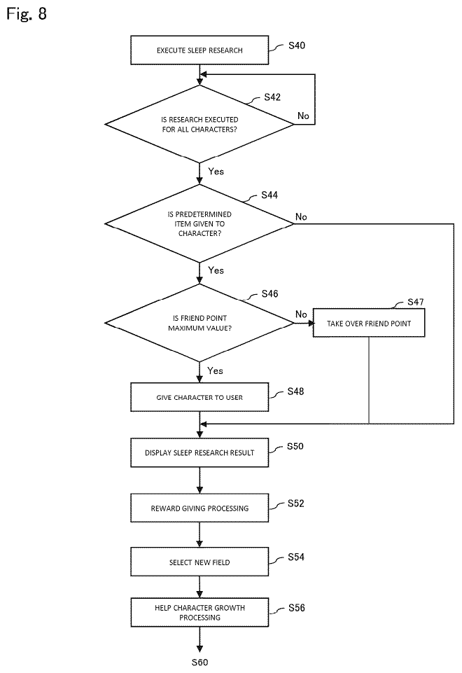

Furthermore, the game control unit 210 causes the display unit 300 to display the home screen as illustrated in FIG. 7C (S34), and executes sleep research as illustrated in FIG. 8 (S40). Note that the home screen may display various information together with a date display 406. Furthermore, sleep research is a process of executing a game event or the like determined by the event determination unit 212 according to the user's sleep information, a user's action up to a previous day, and a user's operation after wake-up.

First, the event determination unit 212 draws and determines a character that appears around the field character 600 or on the field character 600 (e.g., on the belly of the field character 600) as a game event to be caused in the game based on the calculated second parameter. Here, for example, the drawing is executed using the lottery table determined on the basis of the following conditions.
Condition a): Evaluation of field character 600 at timing at which user sleeps
Condition b): User's sleep type of that day
Condition c): Type of field 500 selected by user at time of drawing

Here, the lottery table has contents that differs per field 500, and each field 500 has contents in which at least one different character can appear. That is, different types of lottery tables are used according to the type of the field 500. Furthermore, a target drawn from the lottery table is, for example, a sleeping position of a character (i.e., an image of the sleeping position or an image of a sleeping face. Hereinafter, simply referred to as a “sleeping face” or a “sleeping face image”.). In the lottery table, a plurality of characters are associated with a plurality of sleeping faces. Furthermore, each of the plurality of sleeping faces is associated with a predetermined probability and rarity. Furthermore, the lottery table may be stored in the game information storage unit 220.

### (Appearance of Character)

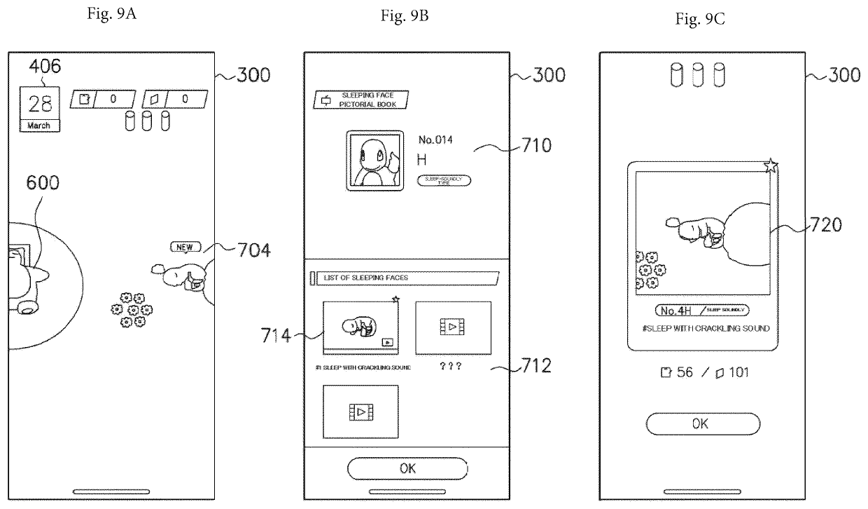

More specifically, the event determination unit 212 executes drawing using the lottery table determined on the basis of the above condition a) to condition c) and further using the second parameter (i.e., which character and the sleeping face of which character are drawn in the lottery table are determined on the basis of the second parameter.), and determines at least one character that appears around the field character 600. Furthermore, the game control unit 210 arranges the sleeping face image of the character determined by the event determination unit 212 around the field character 600 of the field 500 or on the field character 600, and causes the display unit 300 to display the sleeping face image arranged around or on the field character 600. For example, the game control unit 210 causes the character 700 in a sleeping state to appear around the field character 600 as illustrated in FIG. 7C, and causes a character 704 in the sleeping state to appear as illustrated in FIG. 9A. When the game control unit 210 refers to the sleeping face pictorial book information of the user information storage unit 218, and determines that the sleeping face of the appearing character is not included in the sleeping face pictorial book information, information (e.g., “new”) indicating that the sleeping face of the character is a new sleeping face may be displayed around the appearing character (“new” is displayed on the upper side of the character 704 in the example in FIG. 9A.).

Note that, since the game control unit 210 displays on the display unit 300 only part of an area in which the field character 600 exists, the game control unit 210 causes the display unit 300 to display states of other areas around the field character 600 in response to a user's predetermined operation (e.g., swipe operation) on the input unit 102 (e.g., in the situation in FIG. 9A, the user executes the swipe operation with respect to the display unit 300 in the situation in FIG. 7C, and thereby the character 704 that is not displayed in the situation in FIG. 7C is displayed.). Accordingly, the user can enjoy an operation of investigating the state around the field character 600 all over, and finding out a character that appears around the field character 600 and is in a sleeping state.

Furthermore, as the level of the field character 600 under the condition a) is higher, a lottery table including a sleeping face image of a character of higher rarity (i.e., lower drawing probability) may be used. For example, the event determination unit 212 may use the lottery table from which a sleeping face image of a character of higher rarity is more likely to be won as the level of the field character 600 is higher, or change a probability associated with the sleeping face image of the character of higher rarity in the lottery table to a probability higher than the probability. Furthermore, the event determination unit 212 causes the character associated with the same sleep type as the user's sleep type under the condition b) to be won by the lottery. That is, the event determination unit 212 uses the lottery table in which a predetermined character associated with a predetermined sleep type can be given to the user by the lottery.

Furthermore, the user can use a possessed character as a help character. In this case, the game control unit 210 can organize one or more help characters selected by the user as a party of the help characters from characters possessed by the user. Here, each character is associated with a special point indicating the strength of each character. Hence, when the user organizes a party, the game control unit 210 calculates a special point of the party based on the special point of each character belonging to the party (as an example, a value obtained by adding up the special points associated with the characters is set as the special point of the party.). Furthermore, the special point of the party may be defined for the field 500 as a recommended condition for visiting the field 500. In this case, when the value of the special point of the party organized by the user is equal to or more than the value of the special point associated with the field 500, the event determination unit 212 may make a character having a sleeping face of high rarity in the lottery table more likely to be won by, for example, multiplying the lottery table with a predetermined coefficient. Furthermore, the event determination unit 212 may make a character having a sleeping face of higher rarity more likely to be won as the special point of the party becomes higher. Furthermore, as the value of the special point associated with the field 500 is larger, a character having the sleeping face of higher rarity may be made more likely to appear in the field 500 (i.e., a lottery table used to draw a character is replaced with such a lottery table that a character having the sleeping face of higher rarity is more likely to be won to perform drawing.).

### (Execution of Research for Appearing Character)

Furthermore, the game control unit 210 accepts a user's operation (e.g., a character designation operation by a tap operation) on the character appearing on the display unit 300 via the input unit 102. When accepting the operation via the input unit 102, the game control unit 210 may record a sleeping face image (a sleeping face image in a state displayed on the display unit 300 at the time of designation) of a character designated by the user (that may be referred to as a “designated character” below) in the face pictorial book information in the user information storage unit 218. Here, the game control unit 210 compares the sleeping face image to be recorded and sleeping face images of the sleeping face pictorial book information stored in the user information storage unit 218, and, when the sleeping face image of the designated character is not yet stored in the user information storage unit 218, determines that a sleeping face of a new character has been discovered. Furthermore, the game control unit 210 displays on the display unit 300 information (that may be referred to as “new sleeping face pictorial book information” below) indicating that the sleeping face of the new character has been discovered. Note that, since characters designated at the beginning by the user in the tutorial are not recorded as the sleeping face pictorial book information, the game control unit 210 determines without fail that a sleeping face of a new character has been discovered.

As illustrated in, for example, FIG. 9B, the game control unit 210 displays the new sleeping face pictorial book information on the display unit 300. The game control unit 210 displays a pictorial book explanation 710 of the character 704 and an image (an image stored in the user information storage unit 218, that is, a stored picture) recorded as the pictorial book information so far together with the pictorial book explanation 710 in an image list display area 712. The image list display area 712 is provided near a display area of the pictorial book explanation 710.

More specifically, the game control unit 210 causes the display unit 300 to display a “sleeping face pictorial book” as the new sleeping face pictorial book information, and display an image in a state where an appearing character is awake, an ID (“No. 014” in FIG. 9B) of the appearing character, the name of the character (“H” in FIG. 9B), the rarity of the sleeping face of the character, the sleep type of the character (the “sleep-soundly type” in FIG. 9B), the explanation of the character, and the like as the pictorial book explanation 710. Furthermore, the game control unit 210 displays the sleeping face image of the character 700 recorded as the sleeping face pictorial book information as a stored image 714 together with the pictorial book explanation 710 in the image list display area 712. The stored image 714 is displayed together with a name of a sleeping position of a character (“sleep with crackling sound” in FIG. 9B). Consequently, the sleeping face of a character that newly appears around the field character 600 is registered in the sleeping face pictorial book information in the user information storage unit 218. The game control unit 210 can cause the display unit 300 to display information related to the sleeping face pictorial book at any time according to a predetermined instruction on the sleeping face pictorial book of the user accepted via the input unit 102.

On the other hand, the game control unit 210 compares the sleeping face image to be recorded and the sleeping face image of the sleeping face pictorial book information stored in the user information storage unit 218, and, in a case where the sleeping face image of the designated character is already stored in the user information storage unit 218, determines that a sleeping face of an already discovered character has been designated. Furthermore, the game control unit 210 does not display the new sleeping face pictorial book information, and displays the sleeping face image in a state displayed on the display unit 300 as an acquired image 720 on the display unit 300 based on the information already recorded in the sleeping face pictorial book in the user information storage unit 218 and at a time of designation together with minimum information related to the discovered character. For example, as illustrated in FIG. 9C, the game control unit 210 displays a character ID of the character (“No. 4” in FIG. 9C), a sleep type (“soundly” in FIG. 9C), and the name of the sleeping position (“sleep with crackling sound” in FIG. 9C) as the acquired image 720 on the display unit 300 together the sleeping face image of the character at the time of designation by the user. Note that the game control unit 210 may display the acquired image 720 again after displaying the new sleeping face pictorial book information on the display unit 300. In this way, the game control unit 210 executes research for one designated character.

The game control unit 210 accepts a user's instruction on characters and enables execution of research similarly to the above until research for all the characters appearing around the field character 600 ends (No in S42). On the other hand, when the research for all characters ends (Yes in S42), the game control unit 210 displays that the research has ended (e.g., information indicating that “research for all characters has been completed”) on the display unit 300. Note that, when there is a character that has been previously researched by the user among the characters appearing around the field character 600, that is, when the sleeping face image of the character is already stored in the user information storage unit 218, the game control unit 210 can perform processing of skipping displaying a sleeping face image or the like related to the sleeping face of the already discovered character on the display unit 300. Consequently, according to the game system 1, the user who refers to the display unit 300 during execution of the game can effectively utilize a precious time in the morning.

### (Snack Time)

Subsequently, the game control unit 210 enables execution of a process of giving a predetermined item to the appearing character (the process may be referred to as a “snack time” below). The game control unit 210 may display an explanation on the “snack time” on the display unit 300. The “snack time” is a process of increasing the degree of intimacy between a character and the user by giving a predetermined item from the user to the character appearing in the field 500, and, when the degree of intimacy becomes a predetermined value or more (when, for example, the degree of intimacy becomes equal to or more than a maximum value of the degree of intimacy associated with the character), giving the character to the user.

More specifically, when accepting a user's instruction (e.g., a user's tap operation on the character) to give a predetermined item (that may be referred to as an “intimacy degree improvement item” below) to the appearing character via the input unit 102 (Yes in S44), the game control unit 210 consumes the intimacy degree improvement item, and increases the degree of intimacy or the degree of reliability (hereinafter referred to as a “friend point”) of the character for the user to which the intimacy degree improvement item has been given according to the type of the intimacy degree improvement item. As the intimacy degree improvement item, there may be a plurality of types of intimacy degree improvement items depending on a difference between increase amounts of friend points when the intimacy degree improvement item is given to the character (e.g., the plurality of types of intimacy degree improvement items can be set such that the increase amounts of the degree of intimacy increase in order of the first intimacy degree improvement item<the second intimacy degree improvement item<the third intimacy degree improvement item.).

Note that the game control unit 210 may give an intimacy degree improvement item (hereinafter referred to as a “free item”) whose increase amount of the friend point is minimum to the user for free once a day among a plurality of types of intimacy degree improvement items (the intimacy degree improvement item given to the user may be recorded as possessed item information of the user information storage unit 218.). When the game control unit 210 gives the free item to the user at the snack time, the given free item is available only during the snack time. When, for example, the game control unit 210 executes processing of giving the free item to a character selected by the user during the snack time, or the user does not select a character, the game control unit 210 automatically gives the free item to a character selected at random by the game control unit 210 or a character having the sleeping face of the highest rarity among the plurality of characters. Consequently, the game control unit 210 makes the free item available only during the snack time during which the free item is given to the user.

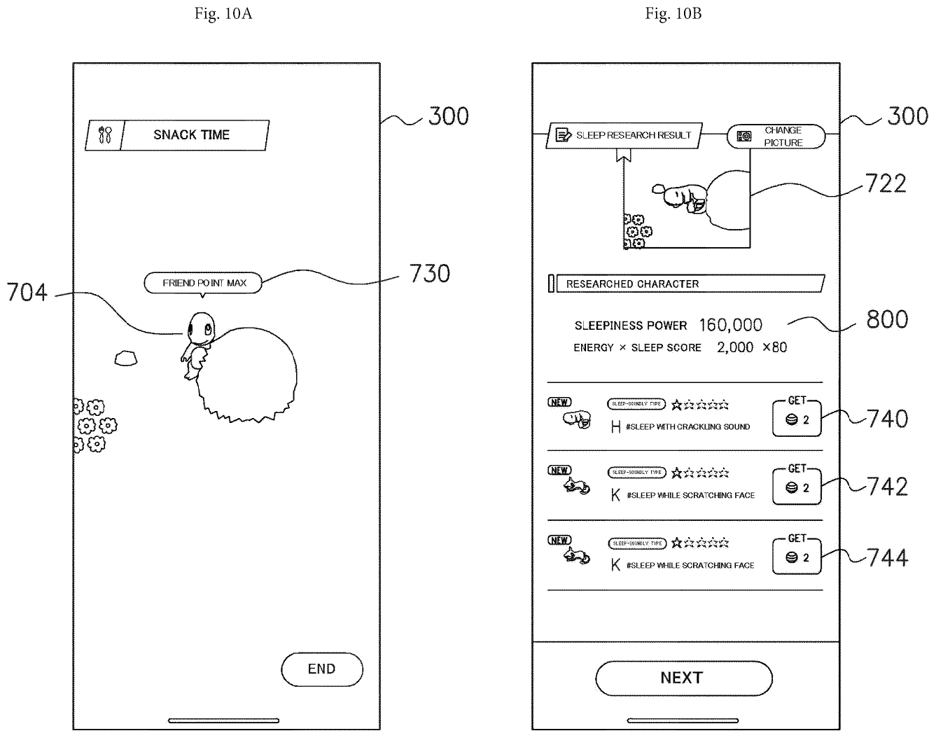

As illustrated in FIG. 10A, the game control unit 210 causes the display unit 300 to display the friend point of the character to which the intimacy degree improvement item has been given, as a friend point display 730 near the character 704. Furthermore, when the friend point of the character is the maximum value (Yes in S46), the game control unit 210 gives the character as a reward to the user (S48). The game control unit 210 gives the character to the user by storing information related to the character as possessed character information in the user information storage unit 218 (S48). Consequently, the user can use the given character as a help character (i.e., the given character becomes a user's friend.).

### (Display of Sleep Research Result)

Furthermore, when there is no instruction to give a predetermined item to the appearing character (No in S44), when the instruction to give the item is made, yet the friend point of the character to which the item has been given does not reach the maximum value (No in S46), or when the snack time ends according to a user's instruction after the character is given to the user, the game control unit 210 causes the display unit 300 to display words for effort (e.g., “thank you for your effort”) or the like of the user. Here, when the friend point of the character to which the item has been given does not reach the maximum value (No in S46), the game control unit 210 does not give the character (referred to as a “friend point unachieved character”) to the user, and associates with the friend point unachieved character a friend point that has been increased by giving the item to take over to a next or subsequent day (S47). That is, the game control unit 210 stores a friend point increased by giving an item in association with a friend point unachieved character, and, when the friend point unachieved character is included in characters appearing around the field character 600 on the next or subsequent day and the user gives a predetermined item to the friend point unachieved character, adds a predetermined point matching the newly given item to the friend point associated with the friend point unachieved character to increase the friend point. Furthermore, when the increased friend point reaches the maximum value of the friend point of the character (Yes in S46), the game control unit 210 gives the character as a reward to the user (S48). Consequently, the user can give a predetermined item to an appearing character and increase a friend point, so that, even when it is not possible to increase the friend point to the maximum value by giving an item once, it is possible to increase the friend point to the maximum value by giving the predetermined item to the character on the next or subsequent day (by giving the predetermined item once a day over a plurality of days depending on cases). Consequently, the user can possess (make a friend with) a character by continuing sleeping, repeatedly encountering the character, and giving a predetermined item, so that the game system 1 can improve a user's sleep experience.

Furthermore, the game control unit 210 selects as a “today's image” one of sleeping face images selected by the user from the sleeping face images (stored images) of the character recorded as the sleeping face pictorial book information in the process of above S40. Furthermore, the game control unit 210 displays the sleep research result on the display unit 300 (S50). For example, as illustrated in FIG. 10B, the game control unit 210 displays an image selected as the “image of today” as a today's image 722 as a sleep research result at the upper part of the display unit 300. Furthermore, the value of the second parameter 800 used by the event determination unit 212 and the breakdown of the second parameter 800 are displayed below the today's image 722 (the second parameter 800 is displayed as “sleepiness power” in the example in FIG. 10B). Furthermore, a list of images of each character (that may be referred to as a “discovered character” below) that has appeared around the field character 600 in the process of above S40, that the user has researched, and whose sleeping face image has been acquired, and information related to each character is displayed below the second parameter. In the example in FIG. 10B, the images and information of a discovered character 740, a discovered character 742, and a discovered character 744 are displayed in order below display of the second parameter 800.

Here, examples of the information of the discovered character include the sleep type (the “sleep-soundly type” is displayed in the example in FIG. 10B. This is because the user's sleep type of that day is the “sleep-soundly type”, and therefore a character of the same sleep type has been drawn.), rarity of a sleeping face of the character (that is indicated by the number of stars, and, as the number of stars is larger, the rarity of the sleeping face becomes higher), a name of the character, a name of the recorded sleeping face image (in the example in FIG. 10B, “sleep with crackling sound” is displayed for the discovered character 740 and “sleep while scratching face” is displayed for the discovered character 742 and the discovered character 744.), and a reward given to the user as the sleeping face image is recorded (the number of rewards is displayed below “GET” display in the example in FIG. 10B. The reward may be referred to as a “candy” below.). Note that the “candy” is used to increase a level of a character or evolve the character.

### (Giving of Reward)

Next, the game control unit 210 executes processing of giving a reward to the user. The game control unit 210 gives to the user a reward determined according to the result mainly based on the following results, and displays a result on the display unit 300 (S52). The reward to be given to the user is recorded in the possessed item information in the user information storage unit 218 and thereby becomes an item possessed by the user.
a) The number of sleeping face images of a character discovered by the user during sleep research (i.e., the number of discovered characters).
b) A research experience value (that may be referred to as a “research EXP” below.) determined according to the number of sleeping face images of the character discovered by the user, and a user's rank determined on the basis of the research EXP. The game control unit 210 associates the research EXP with the user once a day, and determines a user's rank (research rank) according to a sum value of the associated search EXPs.
c) Whether or not a user's research rank has increased as the research EXP is accumulated.

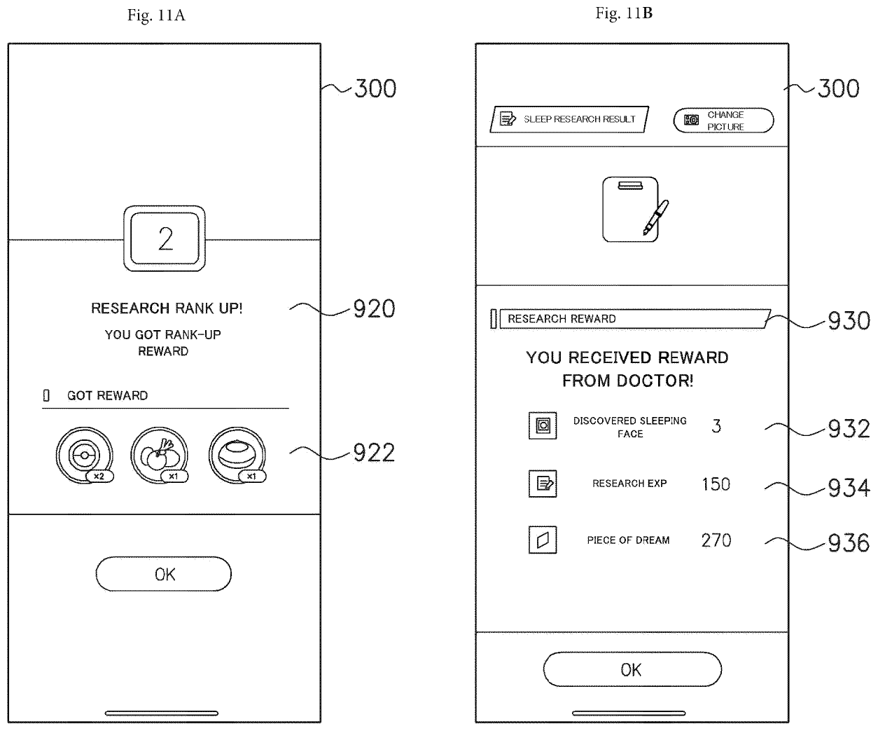

For example, the game control unit 210 determines the user's research rank based on the accumulated research EXP according to the number of sleeping face images of the character discovered by the user. Furthermore, when the research rank increases, the game control unit 210 gives a rank-up reward to the user. As illustrated in, for example, FIG. 11A, the game control unit 210 displays the user's research rank in a user rank display area 920 (the increase in the user's research rank from “1” to “2” is displayed in FIG. 11A.), and displays on the display unit 300 that the research rank has increased and that the reward accompanying the rank increase is given. Furthermore, the game control unit 210 displays the contents of the reward to be given to the user as the rank increases in a reward display area 922 below the user rank display area 920 (FIG. 11A illustrates an example where three types of rewards are given by a predetermined amount.). The rank-up reward is, for example, an intimacy degree improvement item, an ingredient for a dish to be described later, an item that makes various statuses of the field character 600 and the help characters advantageous contents for the user, and the like.

Furthermore, when the research rank does not increase or when giving the rank-up reward ends, the game control unit 210 gives a predetermined reward accompanying a user's sleep as illustrated in FIG. 11B, and displays another reward given to the user on the display unit 300. In the example in FIG. 11B, a list of rewards to be given to the user is displayed in a research reward display area 930 of the display unit 300. Examples of the reward include the number of sleeping face images of the character recorded as the new sleeping face pictorial book information in the sleeping face pictorial book information in the user information storage unit 218 (that is displayed as a “discovered sleeping face” in a reward display area 932 in FIG. 11B), a research EXP (that is displayed as a “research EXP” in a reward display area 934 in FIG. 11B) determined according to the number of images, and an item (that is displayed as a “piece of dream” in a reward display area 936 in FIG. 11B) given to the user by, for example, executing sleep research. Note that the “piece of dream” is used to, for example, increase the level of a character, and expand a tool (cooking tool) used for cooking. When, for example, the user applies the “piece of dream” to a cooking tool, the game control unit 210 increases the amount of an ingredient that can be put in the cooking tool and used by a predetermined amount compared to a predetermined amount.

Furthermore, the game control unit 210 manages a goal achievement status of a user's sleeping time set in S14. That is, the game control unit 210 determines that, when the user's sleeping time (e.g., a time at which the user gets into bed) indicated by the sleep information acquired by the sleep information acquisition unit 204 is around the goal sleeping time, a sleeping time goal has been achieved, and gives a predetermined reward (e.g., cryptocurrency in the game) to the user. “Around the goal sleeping time” includes not only a case where the sleeping time and the goal sleeping time match, but also a case where a difference between the sleeping time and the goal sleeping time is within a predetermined time (e.g., several minutes to 30 minutes). The game control unit 210 sets the unit game period as one unit, and determines whether or not the sleeping time goal has been achieved per day in the unit game period. Furthermore, the game control unit 210 manages the user's goal achievement status in, for example, a stamp card format (that is, for example, a card including digital information that can be displayed on the display unit 300, the card is provided with frames for the number of days constituting the unit game period, and, when the user achieves the goal, a predetermined mark is given to a frame of a goal achievement day and a predetermined reward associated with the frame is given to the user.). That is, when the user achieves the sleeping time goal, the game control unit 210 gives a predetermined mark to the frame of a day on which the goal of the unit game period has been achieved, and gives a predetermined reward associated with the frame to the user.

Note that the configuration of the frame of the card is not limited to the above, and, for example, a card (hereinafter referred to as a “cumulative card”) configured by a frame for counting the number of days on which the user has achieved a goal may be used. That is, the cumulative card is provided with frames for a predetermined number of times. More specifically, an nth cumulative card is provided with first to xth (where x represents an integer equal to or more than two) frames (where n represents a positive integer), and the first frame of the n+1th cumulative card is a next (x+1th) frame continuing to the xth frame that is the last time of the nth cumulative card. The game control unit 210 gives a predetermined mark to the frame of the cumulative card in response to the user's achievement of the sleeping time goal, and gives a predetermined reward associated with the frame to the user. Consequently, according to the cumulative card, it is possible to express the user's goal achievement status by a cumulative number of times (i.e., a cumulative number of days of goal achievement). That is, the cumulative card makes it possible to intelligibly present to the user “how many days goal achievement has cumulatively continued”. Here, when the user changes the goal sleeping time, the game control unit 210 may reset the mark already given to the cumulative card including the frame of the day on which the change has been made. In this regard, marks already given to other cumulative cards except for the cumulative card are not reset. Consequently, the game system 1 can accept change of the goal sleeping time without giving excessive disadvantages to the user.

The game control unit 210 stores the reward given to the user as the possessed item information in the user information storage unit 218, and also stores information of the stamp card as one of the possessed item information in the user information storage unit 218. The game control unit 210 manages the achievement status of the user's goal sleeping time using a new stamp card for a next unit game period at a timing at which the unit game period ends. Alternatively, when a predetermined mark is given to all frames of the stamp card provided with frames for a predetermined number of days or a predetermined number of times, the game control unit 210 manages the achievement status of the user's goal sleeping time using a new stamp card (in this case, when the predetermined mark is given to all frames of one stamp card, that is, when the goal is achieved for a predetermined number of days or a predetermined number of times, a stamp card shifts to a new stamp card irrespectively of whether or not the unit game period ends.). Note that, although the above example has described the example where the achievement status of the goal sleeping time is managed, the achievement status of the goal of a wake-up time (i.e., goal wake-up time) may be managed together with or separately from the goal sleeping time. In a case where the achievement status of the goal wake-up time is managed separately from the goal sleeping time, frames of the stamp card are frames to which a predetermined mark is given when the goal wake-up time is achieved. On the other hand, in a case where the achievement status of the goal wake-up time is managed together with the goal sleeping time, the stamp card may be configured in a format including frames for achieving the goal sleeping time and a frame for achieving the goal wake-up time, or may be configured in a format including frames for giving one mark when both the goal sleeping time and the goal wake-up time are achieved.

[(b-3) Unit Game Period Start Processing]

After processing of giving a reward to the user ends in the tutorial, the game control unit 210 outputs to the display unit 300 an explanation of a summary of minimum operations that the user needs to perform in the game. For example, the game control unit 210 outputs following information to the display unit 300.
Information for recommending to give a predetermined item to a field character until the user sleeps after waking up, and increase the first parameter as much as possible.
Information for reminding the user of execution of sleep measurement when the user sleeps.
Information for recommending to execute sleep research after the user wakes up, register a sleeping face of a character appearing in the sleeping face pictorial book, and completing the sleeping face pictorial book.

Subsequently, the game control unit 210 displays on the display unit 300 an image or information of a character given to the user during the sleep research after the user sleeps. Furthermore, the game control unit 210 ends the game for the field 500 and the field character 600 determined in advance by the game control unit 210 in the tutorial. In this case, the game control unit 210 causes the display unit 300 to output such a direction that the user leaves the field 500.

Note that, after the tutorial (first sleep) is completed, the game system 1 enables, for example, execution of the following functions (i.e., make the following functions executable.).
a) Function of purchasing items and passes by in-app purchase
b) Function of increasing and raising first parameter of field character
c) Function of collecting growth items by help character
d) Function of cooking dish to be given to field character
e) Help character party organization function

Subsequently, the game control unit 210 causes the user to select the new field 500 as the first step of processing of starting a new unit game period (S54). Hereinafter, a flow from the first day of the new unit game period will be described.

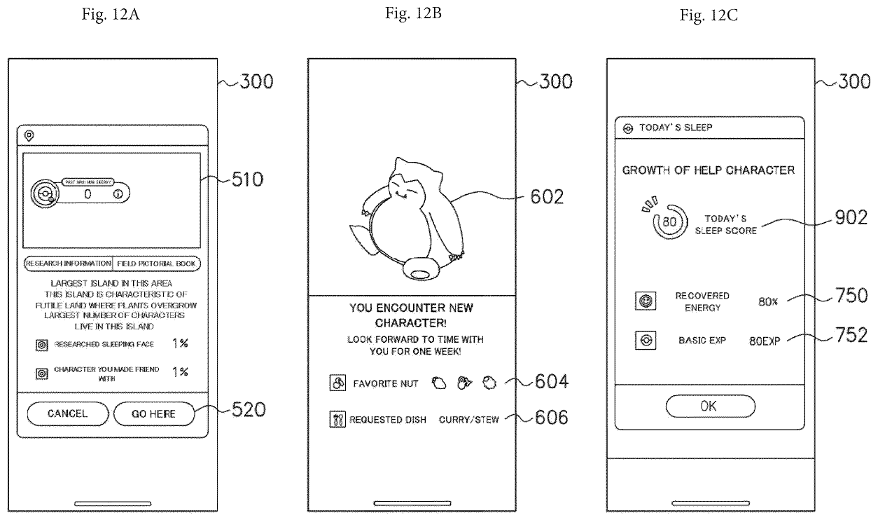

For example, the game control unit 210 displays a map illustrating the entire field 500 illustrated in FIG. 2A on the display unit 300, and the input unit 102 accepts a user's selection instruction of the field 500. Furthermore, the game control unit 210 displays information related to the field 500 selected by the user on the display unit 300. More specifically, as illustrated in FIG. 12A, the information related to the field 500, that is, field information 510 is displayed on the display unit 300. Examples of the field information 510 include a field name, an explanation of a field situation, a rate of the number of sleeping faces of characters acquired in the past in the field 500 (as an example, a rate of the number of sleeping faces of characters already discovered and recorded in the sleeping face pictorial book information by the user with respect to the total number of sleeping faces of characters that can be discovered in the field 500), a rate of the number of characters that the user has come to possess in the field 500 (as an example, a rate of the number of characters already got, possessed, and recorded by the user with respect to the total number of characters that can be got in the field 500), and/or a special point of a party (a party in which help characters have been organized) that is considered to be appropriate to execute the game in the field. Furthermore, a maximum value of the level of the field character 600 raised in the past in the field 500 and a maximum value of the first parameter are also displayed in the field information 510.

When the user actually selects the field 500 that is being selected by the user, that is, when, for example, a user's selection instruction on a selection button 520 (“go here” is displayed in FIG. 12A) is accepted via the input unit 102, the game control unit 210 selects the field 500 as the new field 500 and starts a new unit game period. Furthermore, as illustrated in FIG. 12B, the game control unit 210 displays, for example, the new field character 602 living in the new field 500 together with information such as “You encounter new character!” or the like on the display unit 300.

Note that a plurality of fields exist in the virtual game space. Furthermore, the game control unit 210 may associate a release condition for enabling user's selection with other fields except for the field that the user can visit from the beginning. When the user satisfies the release condition, the game control unit 210 enables the user to select a field whose release condition has been satisfied. The release condition may be, for example, a condition determined in advance based on the number of types of characters recorded in the sleeping face pictorial book by the user, the rarity of the sleeping faces of the characters, and the like.

Here, the game control unit 210 refers to the field character information storage unit 224 or also displays information related to an item required to efficiently raise the field character 602 by a lottery. Note that raising the field character 602 corresponds to increasing the first parameter in the game system 1. Furthermore, examples of the information related to the item required to efficiently raise the field character 602 include favorite food information 604 indicating items that the field character 602 likes, and request information 606 indicating information of dishes or the like desired by the field character 602 in the game.

When the new field 500 is selected after initial activation of the game and after the user takes a sleep once, the game control unit 210 displays an explanation of the significance for growing the field character 602 on the display unit 300 (note that the explanation may not be displayed thereafter.). That is, the explanation is displayed that indicates that, to, for example, discover a sleeping face of a rare character during sleep research or acquire a character having a sleeping face of high rarity, it is required for the user to grow the field character 602 as large as possible (i.e., increase the first parameter as large as possible), and it is required to repeat sleep research (processing in S20 to S52) every morning while accumulating the first parameters over seven days from the first day to the last day of the unit game period.

Furthermore, the game control unit 210 executes the help character growth processing as illustrated in FIG. 12C (S56). In the tutorial, growth processing is executed only for the help characters given to the user in S12. The help character growth processing refers to processing of recovering “energy” of a help character based on the user's sleep information and processing of giving an experience value (illustrated as “basic EXP” in FIG. 12C.). Here, “energy” is the physical strength of a character, and, when, for example, the help character executes a predetermined action (e.g., an action of collecting growth items or the like described later) during the user's activity period, is a value that decreases as a result of the execution of the action. When the value of the “energy” decreases, a frequency or the like of the character to execute the action lowers (i.e., the “energy” is a parameter that is consumed by the character to collect items.). Furthermore, the “energy” recovers by a predetermined amount in conjunction with the user's sleep time after the user wakes up (more specifically, when the user takes a sleep in a state where the character is organized in the party, the “energy” recovers by a predetermined amount according to the user's sleep time.).

Furthermore, an experience value given to a help character accumulates every time the user sleeps and wakes up, and a level of the help character increases every time the experience value exceeds a predetermined criterion value. In the example in FIG. 12C, the game control unit 210 recovers the “energy” of the help character by the predetermined amount based on the user's sleep time, gives a predetermined amount of the experience value to the help character based on the user's sleep time, and displays on the display unit 300 a recovery amount 750 of the “energy” of the help character and a got experience value 752 together with the sleep parameter 902 calculated in S26. The game control unit 210 increases the level of the help character when a cumulative value of the got experience values of the help character reaches a predetermined criterion. Note that information related to the “energy”, the got experience value, and the level of the help character is recorded in the possessed character information in the user information storage unit 218.

In the tutorial, the game control unit 210 may display the method for raising the field character on the display unit 300 to explain. That is, the game control unit 210 displays on the display unit 300 the explanation indicating that, for example, the first parameter is increased by tapping a help character existing on the home screen during the user's activity period as described later and giving an item possessed by the help character to the field character, sleep measurement is started when the user takes a sleep, and the above-described sleep research is executed after wake-up. After the explanation, the game control unit 210 may give a reward based on completion of the tutorial to the user. Note that the game control unit 210 may not display on the display unit 300 a predetermined explanation or the like displayed on the display unit 300 thereafter until a predetermined timing after initial activation of the game and after the user takes a sleep once (i.e., after completion of the tutorial or a reward is given on the basis of completion of the tutorial) as long as a special instruction or the like from the user is made.

<(C) Processing after Start of Unit Game Period>
[(c-1) Processing from Middle of Activity Period to Start of Sleep]

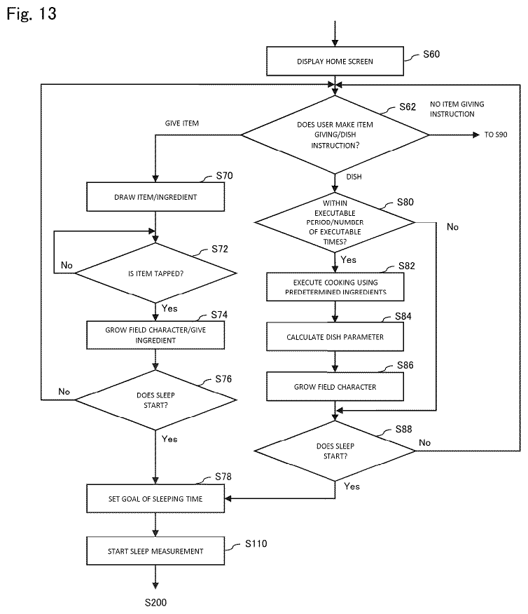

After the help character growth processing ends, the game control unit 210 displays the home screen as illustrated in FIG. 13 (S60). The game control unit 210 executes predetermined game processing in response to user's selection during the user's activity period.

((c-1-1) Field Character Growth Processing Using Item/Dish)
((c-1-1-1) Field Character Growth Processing Using Item)

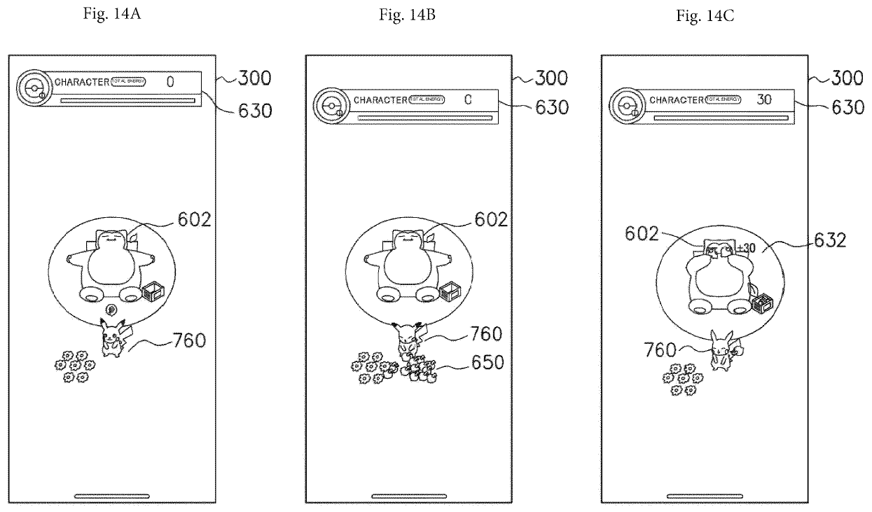

By increasing the first parameter associated with the field character 602, the field character 602 grows. Furthermore, every time the first parameter associated with the field character 602 reaches a predetermined value, a character evaluation of the field character 602 (indicating the degree of growth of the field character 602.) increases. One of methods for increasing the first parameter (the value of the first parameter is displayed as “total energy” in a first parameter display area 630 in FIG. 14A.) includes giving a predetermined item (that may be referred to as a “growth item” below) as a direct growth item to the field character 602 from the help character.

The game control unit 210 gives a growth item to the field character 602 when an instruction to give the item is made from the user via the input unit 102 (“item giving” in S62). More specifically, as illustrated in FIG. 14A, when the input unit 102 accepts the user's instruction (tap operation) on a help character 760 displayed on the display unit 300, the game control unit 210 determines a growth item that the help character 760 is caused to possess and/or an ingredient (indirect growth item) of a dish to be described later by a lottery (S70). The game control unit 210 causes the help character 760 to possess the growth item and/or the ingredient determined by the lottery. Note that a maximum number of the growth items 650 that can be possessed by the help character 760 and a maximum number of ingredients that can be possessed may vary depending on the type of the help character 760.

Subsequently, as illustrated in FIG. 14B, the game control unit 210 causes the growth item 650 and/or the ingredient possessed by the help character 760 to be displayed near the feet of the help character 760. The game control unit 210 may cause the display unit 300 to display how to drop (release) the growth item 650 and/or the ingredient to the feet of the help character 760. Furthermore, when the input unit 102 accepts the user's instruction (tap operation) on the growth item 650 and/or the ingredient (Yes in S72), the game control unit 210 gives the growth item 650 to the field character 602 as illustrated in FIG. 14C, and displays that the field character 602 is caused to eat the growth item 650 to grow (S74). Note that the game control unit 210 may also display on the display unit 300 a state where the growth item 650 released by the help character 760 is in a container such as a basket disposed near the field character 602, and display on the display unit 300 a state where, as the field character 602 eats the growth item 650, the growth item 650 in the container gradually decreases. Furthermore, when there is no user's instruction on the growth item 650 and/or the ingredient (No in S72), the game control unit 210 can stand by until the user's instruction is made. Furthermore, when the input unit 102 accepts a user's instruction on the growth item 650 for the ingredient possessed by the help character 760 (Yes in S72), the game control unit 210 records information related to the ingredient in the possessed item information in the user information storage unit 218 to give to the user (S74). That is, the ingredient itself is not given to the field character 602.

Note that, in S70, the growth item and/or the ingredient possessed by the help character 760 are drawn at a timing of the user's instruction on the help character 760. Here, the game control unit 210 may execute the drawing timing at a different timing.

For example, the game control unit 210 may execute drawing every time a predetermined time (that may be referred to as a “collection time” below. This collection time may vary depending on the type, the personality, and the like of the help character 760. This collection time can be set to, for example, to three minutes or the like.) elapses in a time zone during which the user's instruction on the help character 760 is not made. Furthermore, the game control unit 210 may maintain a state where the help character 760 is caused to possess the growth item 650 and/or the ingredient determined by a lottery until the user's instruction on the help character 760 is made (note that the number of the growth items 650 determined by a lottery once, and/or the number of ingredients are each one or more.). Furthermore, when executing drawing at a timing at which the collection time elapses in the time zone during which there is no user's instruction on the help character 760, the game control unit 210 decreases the “energy” parameter of the help character 760 by a predetermined amount. This predetermined amount may vary depending on the type, the personality, and the like of the help character 760. Furthermore, when decreasing the “energy” parameter of the help character 760, the game control unit 210 changes the collection time to a long time based on the decrease amount, and executes next drawing at a timing at which the changed collection time elapses. Accordingly, as the time elapses, a time interval at which the help character 760 collects items or the like (i.e., drawing time interval) gradually increases.

Furthermore, the game control unit 210 may store the number of times of repetition of the collection time included in a “time without instruction” on the help character 760 from the user as the number of times of collection. In this regard, the next collection time after the first collection time elapses is longer than the first collection time. That is, when an nth collection time elapses, an n+1th collection time longer than the nth collection time is set to elapse next (in this regard, n represents a positive integer). Furthermore, a total duration of times of a first collection time to the nth collection time is within the “time without instruction”, the number of times of collection is “n”. Furthermore, when there is the user's instruction on the help character 760, the game control unit 210 may execute drawing a number of times corresponding to the number of times of collection at a timing of the instruction, assume that the help character 760 collects and possesses the growth item 650 and/or the ingredient determined by the lottery, and display the growth item 650 and/or the ingredient at the feet of the help character 760.

Furthermore, for each type of the help character 760 (and/or other properties such as personalities), the type of the growth item 650 and the type of the ingredient that each help character 760 easily possesses (i.e., that are likely to be won by a lottery) may be determined in advance. Note that, during the user's activity period, the game control unit 210 can display information indicating which types of the growth item 650 and the ingredient are easy to collect together with the name, the status, characteristics, and the like of the help character (and a character possessed by the user) on the display unit 300 at any time in response to the user's instruction.

Consequently, the user can refer to the favorite food information 604 of the field character 602, and organize a party including the help character 760 that easily collects the growth items 650 associated with the favorite food information 604. Note that the type and/or the maximum number of the growth items 650 that can be possessed by the help character 760 at a time, and the type and/or the maximum number of ingredients may be determined according to the level of the help character 760. For example, as the level of the help character 760 becomes higher, more types of the growth items 650 and/or ingredients and larger numbers of the growth items 650 and/or the ingredients can be possessed.

Here, in the game system 1, there are a plurality of types of the growth items 650, and a different value is associated in advance with each type of the growth item 650. The game control unit 210 adds a value associated with the growth item 650 to the first parameter by giving the growth item 650 to the field character 602. In examples in FIGS. 14B and 14C, the one growth item 650 is associated with a value of “30”, and, by giving the one growth item 650 to the field character 602, a value of “30” is added as a got parameter 632 to the first parameter of the field character 602, and the value of the first parameter after the value is added is displayed in the first parameter display area 630. That is, the game control unit 210 adds a value associated with the growth item 650 given to the field character 602 to the first parameter obtained before the growth item 650 is given to the field character 600 to calculate a new first parameter. In the examples in FIGS. 14B and 14C, display of the first parameter display area 630 increases from “0” to “30”. When a plurality of the growth items 650 are given to the field character 602, the game control unit 210 sequentially adds values associated with the growth items 650 to the first parameter. Accordingly, when the one or more growth items 650 are given to the field character 602, every time the growth item 650 is given, the value associated with the given growth item 650 is added to the first parameter, and the first parameter increases. Furthermore, when the value of the first parameter reaches the predetermined criterion value, the game control unit 210 increases the evaluation of the field character 600.

Thereafter, the sleep information acquisition unit 204 determines whether or not the user starts sleeping based on the user's sleep start instruction accepted via the input unit 102 similarly to S16 (S76). When the sleep information acquisition unit 204 determines that the user does not start sleeping (No in S76), the game control unit 210 repeats S62. On the other hand, when the sleep information acquisition unit 204 determines that the user starts sleeping (Yes in S76), the sleep information acquisition unit 204 accepts settings or change of the goal sleeping time similarly to S14 (S78), and then causes the output unit 100 to output the button for accepting from the user an instruction to start sleep measurement. Furthermore, when accepting the user's instruction on the button via the input unit 102, the sleep information acquisition unit 204 starts acquiring the user's sleep information similarly to S18 (S110). Furthermore, in response to start of acquisition of the sleep information, the parameter control unit 206 records the first parameter as the sleep start time parameter at the time of start of acquisition.

((c-1-1-2) Field Character Growth Processing Using Dish)

A second method for increasing the first parameter includes cooking a virtual dish in the game and giving the cooked dish to the field character 602.

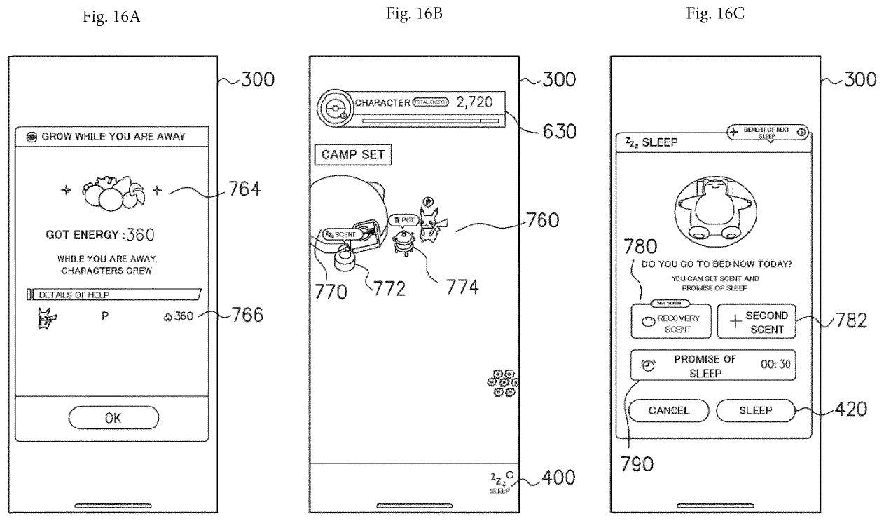

When there is an instruction to cook (hereinafter referred to as a “cooking instruction”) from the user via the input unit 102 (“dish” in S62), the game control unit 210 gives the cooked dish to the field character 602. More specifically, when the input unit 102 accepts a user's operation (e.g., tap operation) on the field character 602 or a user's operation on a predetermined icon arranged at a predetermined place in the field 500, the game control unit 210 determines whether or not cooking is possible. For example, as illustrated in FIG. 16B, a predetermined icon (e.g., pot icon) arranged in the field is a dish start button 774, and the game control unit 210 accepts a user's tap operation on the dish start button 774 or a tap operation on the field character 602, and starts determining whether or not cooking is possible.

The game control unit 210 refers to a time at which the cooking instruction has been accepted and the number of times of acceptance of the cooking instruction already accepted on a day on which the cooking instruction has been accepted, and determines whether or not the time is within a period during which execution of cooking is permitted or whether or not the number of times of cooking is within the permitted number of times of execution of cooking (S80). For example, a timing at which a dish can be given to the field character 602 in the game system 1 is limited to periods of morning (e.g., 6:00 to 12:00), noon (e.g., 12:00 to 18:00), and night (e.g., 18:00 to 6:00 on the next day). Furthermore, the number of times that a dish can be given to the field character 602 is limited to one in each period. That is, three times in total including one time in the morning, one time at noon, and one time at night is a maximum number of times that the dish can be given to the field character 602 a day.

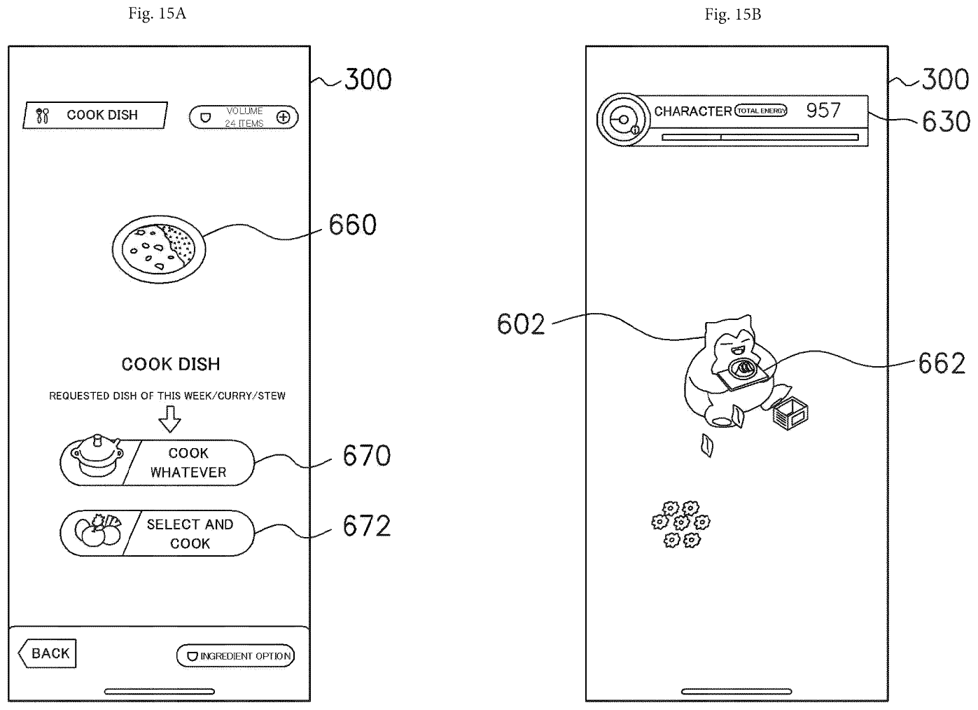

When determining that a period is a period during which execution of cooking is permitted and the number of times of cooking is within the permitted number of times of the execution of cooking (Yes in S80), the game control unit 210 displays a cooking execution button together with a dish image 660 on the display unit 300 as illustrated in FIG. 15A. Two types of the cooking execution buttons can be provided. The first button is a cooking execution button 670 for automatically selecting a recipe of a dish that can be cooked using ingredients of the dish (i.e., ingredient information stored in the user information storage unit 218) possessed by the user at a timing at which a user's operation has been performed on the cooking execution button (“cook whatever” is displayed FIG. 15A.). The second button is a cooking execution button 672 for executing cooking using ingredients selected by the user from the ingredients of the dish possessed by the user at the timing at which the user's operation has been performed on the cooking execution button (“select and cook” is displayed in see FIG. 15A.). The game control unit 210 accepts the user's operation on the cooking execution button 670 or the cooking execution button 672 via the input unit 102, and executes cooking by consuming predetermined amounts of predetermined ingredients based on an instruction on one of the cooking execution buttons (S82).

Note that, when the user executes the operation on the cooking execution button 672, the game control unit 210 refers to the possessed item information recorded in the user information storage unit 218, displays the ingredients possessed by the user on the display unit 300, determines the numbers of ingredients to consume from the displayed ingredients, and uses the ingredients of the selected types to execute cooking. The game control unit 210 deletes the ingredients used for the cooking from the possessed item information. Furthermore, during execution of cooking, the game control unit 210 can refer to the game information storage unit 220, and display useful information (sleep Tips) related to a sleep in a predetermined area of the display unit 300. The sleep Tips may be useful information stored in advance in the game information storage unit 220, or may be useful information acquired from an external server (that may be a server different from a server included in the game system 1) via the communication network 80.). Furthermore, the game control unit 210 records a period and the number of times of execution of cooking (e.g., records the period and the number of times of execution of cooking in the dish information in the user information storage unit 218.).

After completion of cooking, the game control unit 210 determines workmanship of the dish by a lottery or at random. The workmanship of the dish can be classified into a plurality of stages, and classified into, for example, “ordinary” workmanship, “huge success” workmanship, and the like. Furthermore, the game control unit 210 calculates a dish parameter of the completed dish based on the ingredients used for the cooking (S84). That is, the ingredients of the dish are associated with a predetermined point per ingredient type. The game control unit 210 calculates the dish parameter based on the types of ingredients used for cooking and the number of ingredients. For example, a value obtained by multiplying a point a (where a represents a positive number) of the ingredient by the number of used ingredients b (where b represents zero or a positive integer) is calculated for each ingredient used for cooking, and a sum value of the calculated values is the dish parameter (the dish parameter based on the ingredients). Furthermore, when there is a recipe level bonus exists for the recipe used for the cooking, a value obtained by adding a recipe level bonus value to the dish parameter based on the ingredient is set as a final dish parameter. As an example, an ingredient A and an ingredient B are used for cooking, and the final dish parameter in a case where there is the recipe level bonus is “point of ingredient A×number of ingredients A+point of ingredient B×number of ingredients B+recipe level bonus value”. Here, when the workmanship of the dish determined by the game control unit 210 is “huge success”, a value obtained by multiplying “dish parameter based on ingredient” or “value obtained by adding recipe level bonus value to dish parameter based on ingredient” with a predetermined coefficient is used as a final dish parameter. This predetermined coefficient can be set as appropriate in consideration of a game balance, and, for example, the coefficient can be set to “2”. Consequently, when the dish is “huge success”, the dish parameter (final dish parameter) that is twice as large as the “ordinary” workmanship is calculated.

The game control unit 210 gives the completed dish to the field character 602. For example, as illustrated in FIG. 15B, the game control unit 210 displays how the field character 602 eats a dish 662 on the display unit 300. Furthermore, the game control unit 210 adds the calculated final dish parameter to the first parameter at a point of time at which cooking has been started to calculate a new first parameter, and display the new first parameter in the first parameter display area 630. Consequently, the first parameter of the field character 602 increases compared to the first parameter before the field character 602 eats the dish, and the field character 602 grows (S86).

Note that the game control unit 210 increases the recipe level of the recipe according to the number of times that the recipe of the dish is used. Furthermore, the game control unit 210 determines a recipe level bonus value in response to an increase in the recipe level. The game control unit 210 executes update of the number of times of recipes used for the cooking stored in the user information storage unit 218 every time the cooking is executed, update of the recipe level in a case where the recipe level increases as the number of times of recipes is updated, and/or update of the recipe level bonus value determined on the basis of the recipe level. Consequently, the user can increase the recipe level by repeatedly executing cooking using the same recipe, and, even if the workmanship of the dish is not “huge success”, it is possible to increase the final dish parameter by repeating execution of the dish. Consequently, when the user continues the game and repeatedly executes cooking, it is easy to increase the first parameter.

Thereafter, the sleep information acquisition unit 204 determines whether or not the user starts sleeping based on the user's sleep start instruction accepted via the input unit 102 similarly to S16 (S88). When determining that a period is not a period during which execution of cooking is permitted and/or the number of times of cooking is within the permitted number of times of the execution of cooking (No in S80), the game control unit 210 also executes S88 likewise. When the sleep information acquisition unit 204 determines that the user does not start sleeping (No in S88), the game control unit 210 repeats S62. On the other hand, when the sleep information acquisition unit 204 determines that the user starts sleeping (Yes in S88), steps in S78 and S110 are executed similarly to the above. Furthermore, in response to start of acquisition of the sleep information, the parameter control unit 206 records the first parameter as the sleep start time parameter at the time of start of acquisition.

((c-1-1-3) Game Assist Processing)

The game control unit 210 can also execute game assist processing of enabling the user to advantageously advance the game by enabling the user to use various items in response to a user's instruction. Furthermore, the game control unit 210 can organize characters selected by the user as a party and handle the characters belonging to the party as help characters.

### (Camp Set Processing)

As illustrated in FIG. 16B, the game control unit 210 arranges a camp set 770 at a predetermined position in the field. By consuming a predetermined item possessed by the user, the camp set 770 produces a game effect advantageous for the user for a predetermined time (e.g., a unit game period such as one week (168 hours)). Examples of the advantageous game effect include the following effects.
Effect a): An effect of, when the event determination unit 212 determines a character that is caused to appear around the field character 600 or on the field character 600 by a lottery based on the second parameter, increasing the number of characters determined by the lottery, and giving a friend point to the user without maximizing the friend point for the increased characters.
Effect b): An effect of increasing the upper limit of a predetermined amount of a predetermined ingredient that can be used when the user executes cooking in above S82. For example, a predetermined amount is multiplied with a predetermined coefficient to increase the upper limit.
Effect c): An effect of shortening the collection time in above S70 and S90 to be described later (an effect of increasing help characters' collection speeds of items). For example, the collection time is multiplied with a predetermined coefficient to shorten the collection time.
Effect d) An effect of increasing an upper limit of a quantity of items that can be possessed by the help character. For example, the quantity is multiplied with a predetermined coefficient to increase the upper limit.

### (Processing of Sleep Assist Item)

As illustrated in FIG. 16B, the game control unit 210 arranges an item set button 772 that allows a sleep assist item to be set to a predetermined position of the field (a “scent” is displayed in FIG. 16B.). When accepting a user's tap operation on the item set button 772 via the input unit 102, the game control unit 210 displays a list of sleep assist items possessed by the user at a time of the acceptance on the display unit 300. Furthermore, the game control unit 210 accepts user's selection, and produces an effect associated with the sleep assist item selected by the user at a timing at which the user has started sleeping next. The effect exhibited by the sleep assist item is, for example, an effect of increasing a recovery amount in processing of recovering “energy” of the help character described in S56 (as an example, the recovery amount of “energy” determined on the basis of the user's sleep time is multiplied with a predetermined coefficient to increase the recovery amount). The effects exhibited by the sleep assist items may vary depending on the types of the sleep assist items. For example, the effects of the sleep assist items include an effect of increasing a got amount of an experience value of the help character (a value determined on the basis of a time, a sleep time, and the like of the user's activity period) while increasing the recovery amount of “energy” or separately from increasing the recovery amount.

### (Party Organization Processing)

The game control unit 210 can accept a user's selection instruction of a character possessed by the user via the input unit 102, and organize a party. The game control unit 210 can handle characters selected and organized in the party by the user as help characters. Note that the upper limit of the number of characters that can be included in the party is determined in advance. A plurality of characters included in the party may have respectively different types and/or different characteristics (levels, personalities, and the like). The game control unit 210 causes a character included in the party to collect items in the description of above S70 and S90 described later during the user's activity period. That is, the game control unit 210 executes drawing based on, for example, the type and/or the characteristics of each character included in the party, associates the growth item 650 and/or the ingredient of the dish with each character, and thereby causes each character to possess the growth item 650 and/or the ingredient of the dish.

((c-1-2) Field Character Automatic Growth Processing)

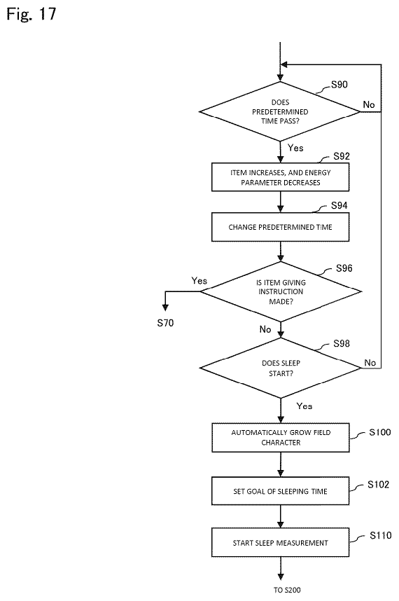

A third method for increasing the first parameter is a method where the user does not perform an operation during the activity period. FIG. 17 illustrates an example of an overview of a flow of processing of the game system 1 in this case.

When there is no instruction to give an item from the user via the input unit 102 (“no instruction” in S62), the game control unit 210 determines whether or not the predetermined time (i.e., collection time) has elapsed (S90). When the collection time does not elapse (No in S90), the game control unit 210 stands by until the collection time elapses. When the collection time elapses (Yes in S90), the game control unit 210 determines types of items by a lottery, causes the help character 760 to possess a predetermined number of items of the determined types, and reduces the “energy” parameter (S92). The items to be increased may be only the growth items 650. Furthermore, the game control unit 210 decreases the “energy” parameter, and changes the duration of the collection time (S94). For example, the game control unit 210 changes the collection time to a longer time. When there are the plurality of help characters 760, the game control unit 210 executes processing in S90 to S94 for each of the plurality of help characters 760.

Note that the collection time may vary depending on each type of the help character 760. Furthermore, when the collection time elapses, the game control unit 210 can set the amount of items that the help character 760 is caused to possess to, for example, “one”, and set the decrease amount of the “energy” parameter to, for example, a minimum unit amount of “energy” (as an example, one “energy”). In this regard, the amount of items determined by the lottery (and the maximum number of items that the character can possess) and/or the decrease amount of the “energy” parameter may be varied depending on the type of the help character 760. Furthermore, the type of the item (the type of the growth item 650) that the game control unit 210 causes the help character 760 to possess, that is, the type of the item determined by the lottery may vary depending on each type of the help character 760.

Furthermore, when there is an instruction to give an item from the user via the input unit 102 (Yes in S96), the game control unit 210 executes processing in or after S70. On the other hand, when there is no instruction to give an item from the user (No in S96), the sleep information acquisition unit 204 determines whether or not the user starts sleeping based on the user's sleep start instruction accepted via the input unit 102 similarly to S16 (S98). When the sleep information acquisition unit 204 determines that the user does not start sleeping (No in S98), the game control unit 210 repeats S90. On the other hand, when the sleep information acquisition unit 204 determines that the user starts sleeping (Yes in S98), the parameter control unit 206 executes field character automatic growth processing (S100). Although an example where the parameter control unit 206 executes the automatic growth processing will be described below, the automatic growth processing may be executed by the game control unit 210.

More specifically, every time the collection time elapses, the parameter control unit 206 adds a value associated with each of one or more items that the game control unit 210 causes the help character 760 to possess, that is, the one or more growth items 650 to the first parameter at a timing at which the sleep information acquisition unit 204 determines that the user starts sleeping, and calculate a new first parameter. As illustrated in, for example, FIG. 16A, the parameter control unit 206 displays the value to be added in an automatic got parameter display area 764 of the display unit 300 (a value “360” is displayed as “got energy” in FIG. 16A), and displays a sum value of values associated with one or more items that the help character is caused to possess as an automatic got parameter 766 for each help character (a value “360” is displayed in association with the help character whose name is “P” in FIG. 16A).

Consequently, the game system 1 can give to the field character 602 the growth item 650 automatically collected by the help character 760 even when the user does not perform a game operation during the user's activity period, and increase the first parameter. Furthermore, the game system 1 can express that, while the help character 760 automatically collects items even when the user does not perform a game operation during the user's activity period, “energy” of the help character 760 decreases as items are collected (the help character 760 gets tired), and a time to collect the items gradually increases.

Here, the parameter control unit 206 may execute the automatic growth processing according to user's selection even when the game is not activated. Note that the user may execute the above camp set processing, sleep assist item processing, and party organization processing at an arbitrary timing in a time zone (i.e., during the activity period) except for a time during a user's sleep. In this regard, to produce the predetermined effects based on these processing in association with the user's sleep information, the user needs to execute these processing before taking a sleep of that time.

[(c-2) Processing after Start of Sleep]

After the field character automatic growth processing in S100 is executed, the game control unit 210 accepts settings of the sleeping time goal (S102) similarly to S78. Here, the game control unit 210 can set the sleeping time goal and also accept settings and change of the sleeping assist item. For example, as illustrated in FIG. 16C, the game control unit 210 displays on the display unit 300 a goal setting button 790 that accepts the settings of the sleeping time goal together with a sleep assist item setting button (an item set button 780 and an item set button 782).

### (Sleep Assist Item Setting Processing)

When the input unit 102 accepts a user's tap operation on the item set button 780 and/or the item set button 782 illustrated in FIG. 16C, the game control unit 210 displays on the display unit 300 a list of the sleep assist items possessed by the user at the time of acceptance. Furthermore, the game control unit 210 accepts user's selection, enables use of the sleep assist item selected by the user, and superimposes and displays an image of the sleep assist item selected by the user on each of the item set button 780 and/or the item set button 782. The game control unit 210 produces an effect of the sleep assist item at a timing at which the user has started sleeping. The effect of the sleep assist item is similar to the above.

### (Sleeping Time Goal Setting Processing)

When the input unit 102 accepts a user's tap operation on the goal setting button 790, the game control unit 210 enables acceptance of the settings of the sleeping time goal or the change processing of the already set sleeping time goal. Since the specific setting processing is similar to that in the S14, detailed description thereof will be omitted.

Furthermore, when the input unit 102 accepts a user's tap operation on a predetermined button 420 (a button that is displayed as “sleep” in the example in FIG. 16C) displayed on the display unit 300, the game control unit 210 starts sleep measurement (S110). Furthermore, in response to start of acquisition of the sleep information (start of sleep measurement), the parameter control unit 206 records the first parameter (the first parameter after execution of the field character automatic growth processing) at the time of start of acquisition as a sleep start time parameter. Note that, when the sleep measurement is started, the game control unit 210 may store in the user information storage unit 218 information indicating that the sleep measurement has started. Furthermore, since the processing (acquisition of an environment audio, alarm settings, sleep induction sound settings, and the like) to processing in S110 to S200 is similar to processing in S18 to S20, detailed description thereof will be omitted.

[(c-3) Processing at Time of Wake-Up]

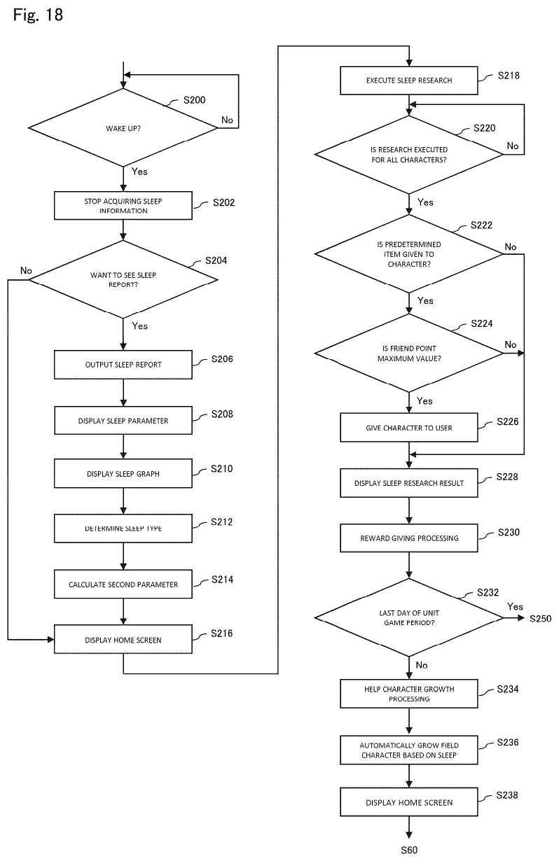

Furthermore, after the user wakes up, sleep research is executed. FIG. 18 illustrates an example of an overview of a flow of processing at a time when the user wakes up during a unit game period that does not include the tutorial.

Furthermore, the sleep information acquisition unit 204 determines whether or not the user has woken up similarly to S20 (S200). When the sleep information acquisition unit 204 determines that the user has not woken up (No in S200), the sleep information acquisition unit 204 continues acquiring the sleep information. On the other hand, when the sleep information acquisition unit 204 determines that the user has woken up (Yes in S200), the sleep information acquisition unit 204 stops acquiring the user's sleep information measured by the sleep measurement unit 11 similarly to S22 (S202). The game control unit 210 collectively records the sleep information acquired at a timing of stop of acquisition as the sleep information in the user information storage unit 218 (in a case where the user information storage unit 218 is provided in the server, the terminal device 10 collectively supplies the sleep information to the user information storage unit 218 of the server.).

Subsequently, the game control unit 210 accepts user's selection via the input unit 102, and determines whether or not to cause the output unit 100 to output a sleep report (S204). When the user has selected not to see the sleep report (No in S204), the game control unit 210 skips display of the sleep report and displays the home screen on the display unit 300 (S216). On the other hand, when the user selects to see the sleep report (Yes in S204), the game control unit 210 outputs the sleep report to the display unit 300 similarly to S24 (S206). Furthermore, the game control unit 210 executes sleep parameter display processing (S208), sleep graph display processing (S210), and sleep type determination processing (S212), and the event determination unit 212 executes second parameter calculation processing (S214). Here, since similar processing in S208 to S26, similar processing in S210 to S28, similar processing in S212 to S30, and similar processing in S214 to S32 are executed, detailed description thereof will be omitted.

When accepting a request to display the sleep report after displaying the home screen (S216), the game control unit 210 executes the sleep research similarly to S40 (S218). That is, the event determination unit 212 executes drawing using a predetermined lottery table based on the calculated second parameter, and determines characters that appear around the field character 602, for example. The game control unit 210 arranges the sleeping face images of the characters determined by the event determination unit 212 around the field character 602, for example, and displays the sleep face images on the display unit 300. Furthermore, the game control unit 210 accepts a character designation operation of a user's tap operation on a character appearing on the display unit 300 via the input unit 102. When accepting the operation via the input unit 102, the game control unit 210 records the sleeping face image at a time of designation of a designated character designated by the user in sleeping face pictorial book information in the user information storage unit 218. Here, when determining that a sleeping face of a new character has been discovered, the game control unit 210 displays the new sleeping face pictorial book information on the display unit 300. Furthermore, the game control unit 210 may display an image (that may be an image of that day on which a character is newly discovered) recorded as the sleeping face pictorial book information so far together with the pictorial book explanation 710 of the character in the image list display area 712. Consequently, the sleeping face of the character that has newly appeared around the field character 602 is registered in the sleeping face pictorial book information in the user information storage unit 218. On the other hand, when the sleeping face image of the designated character is already stored in the user information storage unit 218, the game control unit 210 determines that the sleeping face of the already discovered character has been designated. Furthermore, the game control unit 210 does not execute display of the new sleeping face pictorial book information, and displays on the display unit 300 the sleeping face image in the state displayed on the display unit 300 at the time of designation as the acquired image 720 together with minimum information related to the discovered character.

Note that, when the event determination unit 212 executes drawing based on the second parameter and determines an appearing character (i.e., when the character is won by the lottery), a character having an extremely special sleeping face (hereinafter referred to as a “special sleeping face character”.) may be won. For example, the event determination unit 212 determines the type of a character that is caused to appear by executing drawing based on the second parameter, and then determines whether or not the character is a special sleeping face character by a lottery (special lottery). A winning probability of the special lottery may be a certain probability with respect to any character irrespectively of rarity of the sleeping face of the character or the like. In this regard, the wining probability of the special lottery may be a probability lower than a probability used to determine the character appearing in the field based on the second parameter.

Until research for all characters appearing around the field character 600 ends, the game control unit 210 accepts a user's instruction on the character and executes research similarly to the above (No in S220). On the other hand, when the research for all characters ends (Yes in S220), the game control unit 210 causes the display unit 300 to display that the research has ended.

Subsequently, the game control unit 210 executes processing as to whether or not to give an intimacy degree improvement item to the appearing character similarly to the S44 (S222). When the user selects not to give the intimacy degree improvement item to the appearing character (No in S222), the game control unit 210 displays a sleep research result on the display unit 300 (S228). On the other hand, when the user selects to give the intimacy degree improvement item to the appearing character (Yes in S222), processing similar to processing in or after Yes in S44 (the processing in S46 and S48) is executed. That is, since processing in S224 (processing of determining whether or not a friend point has reached the maximum value) is similar to the processing in S46, and processing in S226 (processing of giving the appearing character to the user) is similar to the processing in S48, detailed description thereof will be omitted. When the friend point do not reach the maximum value (No in S224) and as the friend point reaches the maximum value (Yes in S224), the game control unit 210 gives the appearing character to the user (S226), and then displays the sleep research result on the display unit 300 similarly to S50 (S228). Furthermore, the game control unit 210 gives a reward to the user similarly in S52 (S230).

Note that, when the user selects to give the intimacy degree improvement item to the special sleeping face character (Yes in S222), the game control unit 210 gives this special sleeping face character to the user irrespectively of a value of the friend point. Although a probability of appearance of the special sleeping face character in the field is very low, when the character appears once in the field, the user can get the character by giving the intimacy degree improvement item to the special sleeping face character. The game system 1 executes predetermined drawing based on the sleep information of the user's sleep. Here, for the user who is a human being, sleep is not an action that the user can take a plurality of times a day. That is, since the user cannot sleep (repeat sleeping and waking up) over and over during the day and can sleep only once a day, the number of times that the user can execute drawing during the day is limited to one (drawing cannot be performed a plurality of times in the first place.). In this regard, this game is different from a game whose mode enables execution of a plurality of times of drawing a day like a normal game, or a game that enables execution of drawing only once on a day depending on game design. Accordingly, when the special sleeping face character appears in the field, the game system 1 enables the user to get the special sleeping face character only by giving the intimacy degree improvement item to the special sleeping face character, and makes it possible to prevent the user from feeling disappointed because the user cannot get the special sleeping face character even though the special sleeping face character appears.

Furthermore, the game control unit 210 gives a reward to the user, and then determines whether or not a day on which the reward is given is the last day of the unit game period (S232). When determining that the day is not the last day (No in S232), the game control unit 210 executes the help character growth processing similarly to S56 (S234). That is, the game control unit 210 executes the processing of recovering the “energy” of the help character and the processing of giving the experience value (basic EXP) as the help character growing processing based on the user's sleep information (sleep time).

After the help character growth processing, the parameter control unit 206 automatically grows the field character 602 by increasing the first parameter by a predetermined amount based on the user's sleep information on that day (S236). That is, the game control unit 210 determines the type and the number of the growth items 650 by a lottery based on, for example, the type and/or characteristics of the help character organized in the party every time a predetermined time (i.e., collection time) elapses from a timing of start of measurement of a user's sleep (a timing at which S110 is started), associates the determined type and number of the growth items 650 with the help character, and thereby causes the help character to possess the growth items 650. Note that ingredients of a dish are not drawn by this lottery.

The collection time may vary per type of the help character. Furthermore, the game control unit 210 may determine by a lottery the type of the growth item 650 that the help character is caused to possess when the collection time elapses, and set the number of the growth items 650 to, for example, “1” in advance. Furthermore, the type of the growth item 650 determined by the lottery may be varied depending on the type of the help character.

The game control unit 210 executes drawing every time the collection time elapses until the user wakes up (until Yes in S200), and associates the types and the number of the growth items 650 determined by the lottery with the help character. Here, when field character automatic growth processing is executed during the user's activity (see the description of (c-1-2)), every time the collection time elapses, the “energy” of the help character decreases. However, it is considered in processing in S236 that, while the user is sleeping, the help character organized in the party is also taking a break, and “energy” is recovered according to the user's sleep time. That is, while the user is sleeping, the game control unit 210 performs processing different from the processing during the activity period during which the help character organized in the party automatically collects the growth items 650, yet the “energy” is recovered without decreasing.

Note that the recovery amount of the “energy” of the help character is determined on the basis of predetermined characteristics (such as personality and the like) of the help character and/or whether or not predetermined items (e.g., sleep assist items) are set before the user takes a sleep on that day. In a case where, for example, the user has set the sleep assist items before sleeping, the recovery amount of “energy” increases by an amount matching the type of the set sleep assist item compared to the case where the recovery amount is not set. Here, help characters whose amounts of “energy” recover may be help characters organized in the party. In this regard, although characters are not organized in the party in the modified example of the game system 1, the amount of “energy” may be also recovered according to a user's sleep for the characters stored in the user information storage unit 218 (i.e., the characters possessed by the user). Furthermore, the game system 1 may give to the user a sleep assist item that has the function of recovering the amount of “energy” in response to a user's sleep for characters that are not organized in the party, and, when the user sets the sleep assist item, recover the amount of “energy” in response to the user's sleep for the characters that are not organized in the party (note that the recovery amount in this case may be set to a smaller recovery amount than the recovery amount of a help character organized in the party.).

The game control unit 210 executes similar processing for each of the plurality of help characters when there are a plurality of help characters. Furthermore, the parameter control unit 206 adds a value associated with each of the one or more growth items 650 that the game control unit 210 has caused the help character 760 to possess every time the collection time elapses (every time the collection time elapses during a user's sleep) to, for example, the first parameter at any timing between a timing at which calculation of the second parameter has ended (after S214) and a timing at which a reward has been given to the user (a timing in S230), and calculates a new first parameter (this new first parameter is used at a time when the user wakes up next after sleeping.). That is, the value determined on the basis of the growth items collected by the help characters while the user sleeps is added to the first parameter at any timing after the second parameter calculation processing at the time when the user wakes up ends. Consequently, the game system 1 can automatically give to the field character 602 the growth item 650 automatically collected by the help character during the user's sleep and increase the first parameter, so that, even when the user does not execute the game at all during the activity period, it is possible to get the first parameter without fail only by executing sleep measurement. As a result, the second parameter is also calculated only by taking a sleep, so that any user can enjoy the game without being left behind. Furthermore, the game control unit 210 displays the home screen (S238), and repeats processing from S60. That is, similar processing is repeated from a first day to a previous day of a last day of a unit game period.

### (Regarding First Parameter During Unit Game Period)

During the unit game period, each processing such as “field character growth processing using item/dish” during a user's activity period, “field character automatic growth processing” during the activity period, and/or “field character automatic growth processing based sleep” increases the first parameter of the field character. That is, the first parameter is increased at least by “field character growth processing using item/dish” during the activity period on the nth day (n represents an integer equal to or larger than one) of the unit game period or “field character automatic growth processing” during the activity period, is recorded once as the sleep start time parameter at the time of start of a user's sleep, and is used to calculate the second parameter at the time when the user wakes up on the n+1th day. Furthermore, after being used to calculate the second parameter, the first parameter is further increased by “field character automatic growth processing based on sleep” to a new first parameter, and further increases during the activity period on the n+1th day similarly to the nth day. In this way, as days pass from the first day in the unit game period, the first parameter is gradually accumulated and increases.

### <(D) Processing on Last Day of Unit Game Period>

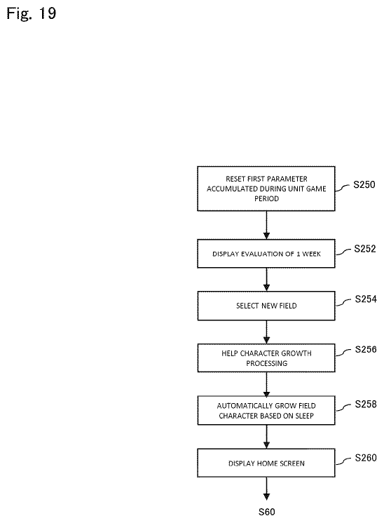

The game control unit 210 gives a reward to the user, then determines whether or not the day on which the reward has been given is the last day of the unit game period (S232), and, when determining that the day is the last day (Yes in S232), executes processing on the last day. As illustrated in FIG. 19, first, the game control unit 210 resets the first parameters accumulated during the unit game period (S250). As a result, the first parameter becomes “0” once. Here, the game control unit 210 does not reset various other parameters except for the first parameter and parameters related to the first parameter, and takes over the various other parameters to a next unit game period. As an example, the game control unit 210 resets following parameters or elements, and takes over the other parameters or elements to the next unit game period.

### (Parameters or Elements Reset on Last Day of Unit Game Period)

First parameter
Evaluation of field character determined on the basis of first parameter
Information related to mission (mission information)

### (Parameters or Elements to be Taken Over to Next Unit Game Period)

User's rank
Various statuses (information such as a level, a skill, and a sleep time taken together with the user) of help characters
Possessed items (growth items and ingredients that are collected by the help character and are not given to the field character, intimacy degree improvement items, sleep assist items, and/or various other items acquired or purchased in the game)
Sleep point
Research note collection status (research note information)
A collection status of sleeping face pictorial books (i.e., accumulated sleeping face pictorial book information), and a goal related to the sleeping face pictorial book (e.g., information proposed to the user by the game control unit 210 and related to a predetermined goal for completion of the sleeping face pictorial book)
Data related to a user's sleep (sleep data), information related to a user's sleep rhythm (i.e., information of a user's unit game period such as a sleep rhythm of each week and information related to a predetermined evaluation on the information, and the like), statistics information of the sleep (e.g., information of a time zone during which the user wakes up, information of a time zone during which the user sleeps, and the like)
Information of a stamp card indicating an achievement status of a goal sleeping time

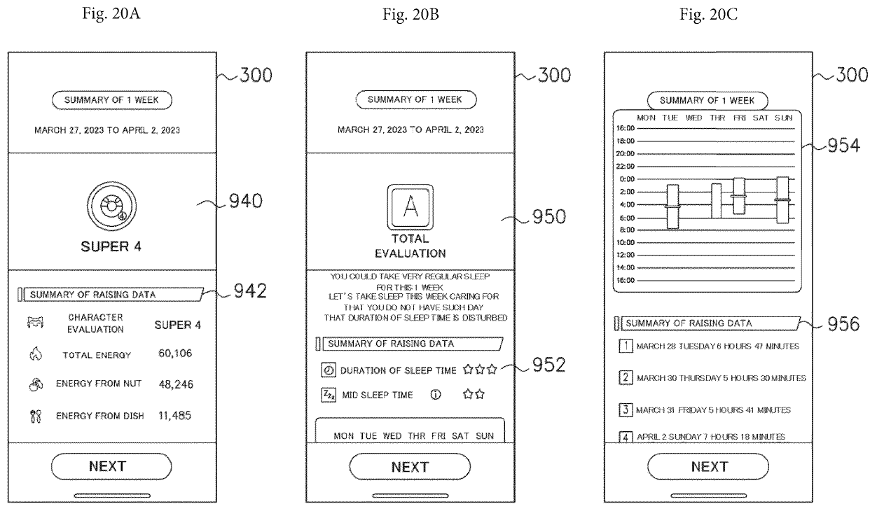

Subsequently, the game control unit 210 displays a summary of the evaluation of the game in the unit game period (here, one week) on the display unit 300 (S252). As, for example, illustrated in FIG. 20A, the game control unit 210 displays on the display unit 300 a character evaluation 940 that is an evaluation of the field character 602 determined on the basis of the total of the first parameters, and displays the total of the first parameters of the field character 602 and a breakdown of the total of the first parameters in the unit game period in a got parameter display area 942 near the character evaluation 940.

The evaluation on the field character 602 (a “character evaluation” is displayed in FIG. 20A and is displayed as “super 4”) is determined on the basis of the total of the first parameters (the “total energy” is displayed in FIG. 20A and is displayed as “60,106”) accumulated during the unit game period. The evaluation may be a high evaluation depending on the magnitude of the total of the first parameters. Note that the breakdown of the total of the first parameters accumulated in the unit game period, that is, the amount of the first parameters increased by the growth item 650 (the “energy from nut” is displayed in in FIG. 20A and is displayed as “48,246”), the amount of the first parameters increased by a dish (“energy from the dish” is displayed in FIG. 20A and is displayed as “11,485”), and the amount of the first parameters increased by other factors (the increase amount resulting from the other factors is not displayed in FIG. 20A) are displayed as numerical values as illustrated in FIG. 20A.

Furthermore, as illustrated in FIGS. 20B and 20C, the game control unit 210 displays, for example, an evaluation display 950 of an overall evaluation on the user, summary data 952 of a user's sleep (e.g., data such as suitability of a duration of a user's sleep time and a rate of a depth of a predetermined sleep with respect to the sleep time), a summary graph 954 from a sleep start time to a wake-up time on each day in the unit game period, and/or sleep time details 956 on each day in the unit game period (i.e., the duration of the sleep time on each day) as a summary of the evaluation of the game on the display unit 300. Consequently, the user can objectively grasp a user's sleep status in the unit game period. Note that FIGS. 20B and 20C are a series of information, and, when the user performs a swipe operation on the display unit 300 in FIG. 20B, the game control unit 210 moves the information from FIG. 20B to FIG. 20C and displays the information on the display unit 300.

After displaying the evaluation of one week ends, the game control unit 210 ends the game (sleep research) in the field 500 and the field character 602 selected by the user on the first day of the unit game period. In this case, the game control unit 210 causes the display unit 300 to output such a direction that the user leaves the field 500 and the field character 602 bids farewell to the user. Subsequently, the game control unit 210 causes the user to select the new field 500 as the first step of processing of starting the next unit game period (S254). Since processing in S254 is processing similar to processing in S54, detailed description thereof will be omitted. When the unit game period switches to the next unit game period (e.g., when the first day of the first unit game period is Monday, the next week comes), the field changes to a new field, and then a new field character is selected. That is, the user can have such an experience that the user bids farewell to the field character in a previous week at a timing at which the unit game period up to the previous week ends and switches to the unit game period of the next week, and a field character of a new field becomes a partner of the game.

In this regard, the game control unit 210 also permits the user to select the same field 500 again. In this case, the game control unit 210 selects a field character that is the same field 500 yet is different from the field character 602 in the previous unit game period.

When the user selects the new field, the new field character is selected, and the new field character is associated with the predetermined favorite food information 604 and the predetermined request information 606. When the user selects as a new field a field that has been selected so far, a new field character is selected. When the user selects the new field, the game control unit 210 causes the display unit 300 to display the favorite food information 604 and the request information 606 of the new field. The user can refer to this display and organize a party of help characters that is advantageous to advance the game. For example, the user may consider incorporating in the party a help character that easily collects a predetermined item indicated by the favorite food information 604 of the field character, and/or incorporating in the party a help character that easily collects ingredients of a dish indicated by the request information 606. Consequently, the game system 1 can enjoy a combination of party organization of help characters for a field character.

After the user selects a new field, the game control unit 210 executes the help character growth processing similarly to S234 (S256). Subsequently, the parameter control unit 206 increases the first parameter by the predetermined amount based on the user's sleep information (the sleep information on the last day of the previous unit game period in this case) similarly to S236 to automatically grow the newly selected field character (S258). Furthermore, the game control unit 210 displays the home screen (S260), and executes processing in or after S60.

### <(E) Other Processing>

In the game system 1, the game control unit 210 can also mainly execute following various processing during the user's activity period.

[(e-1) Main Menu]

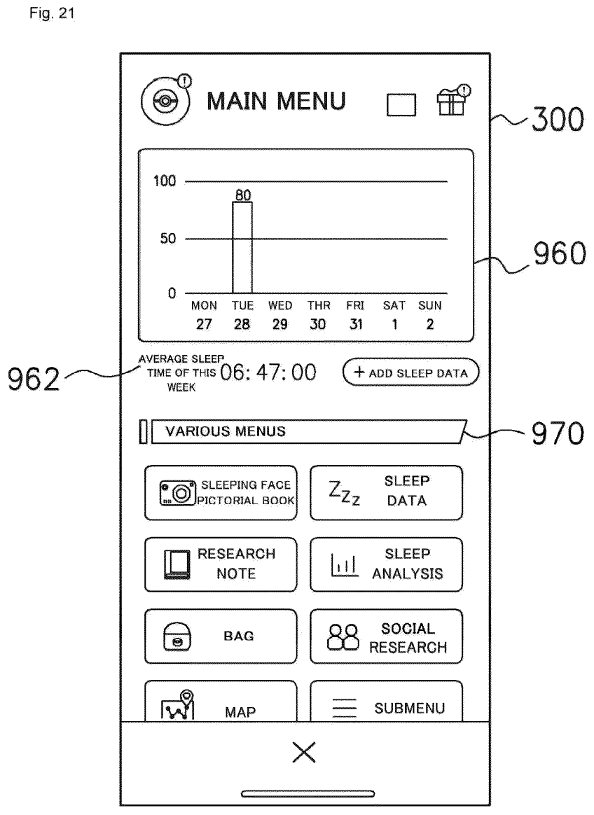

FIG. 21 illustrates an example of an overview of a main menu of the game displayed on the display unit of the game system according to present embodiment.

The game control unit 210 displays various menus 970 together with a sleep graph 960 and an average sleep time 962 indicating a sleep score in the unit game period of the game currently played by the user in the main menu on the display unit 300. When accepting a user's selection instruction on a predetermined menu via the input unit 102, the game control unit 210 displays predetermined information related to the selected menu on the display unit 300, and executes predetermined processing in the menu based on a user's predetermined instruction accepted in the selected menu. Note that, in the sleep graph 960, the horizontal axis indicates a date and a day of the week of each day included in the unit game period, and the vertical axis indicates the sleep parameter calculated on each day by the sleep parameter calculation unit 208. Furthermore, the average sleep time 962 may be also an arithmetic mean of the sleep times calculated from the user's sleep information on each day in the unit game period.

### Menu a): “Sleeping Face Pictorial Book”

This menu displays information of a sleeping face of a character recorded in the sleeping face pictorial book information in the user information storage unit 218 and the like (images of the sleeping face or a sleeping position of the character that has appeared during sleep research and been acquired by the user by giving a predetermined instruction, information such as a status or an explanation of the character, and the like) on the display unit 300. Note that the special sleeping face character is also recorded in the sleeping face pictorial book information. Here, in a case where one type of an image of one character, another type of an image of one character, and one type of an image of a special sleeping face character corresponding to the one type of the image of the one character are recorded in the sleeping face pictorial book information, since, while the game control unit 210 can cause the display unit 300 to display the image of the one type of the special sleeping face character, the image of the another type of the special sleeping face character corresponding to the another type of the image is not recorded, and the image of the another type of the special sleeping face character is not displayed on the display unit 300.

### Menu b): “Sleep Data”

The menu displays the user's sleep information acquired by the sleep information acquisition unit 204 on the display unit 300. Examples of the sleep information to be displayed include a user's average sleep time in a unit game period, a sleep time of each day of the unit game period, a reliable sleep depth/quality in the unit game period, an environment audio data during a sleep, and the like.

### Menu c): “Research Note”

This menu can refer to various items (including various items that are, for example, items given as growth items, dish ingredients, and, in addition, a game reward and are not possessed by the user) discovered by the user by executing the game, and/or names or explanations of items (growth items) and dishes given to field characters.

### Menu d): “Analysis of Sleep”

This menu displays on the display unit 300 an analysis result of the user's sleep information acquired by the sleep information acquisition unit 204. Examples of the analysis result include an average sleep time of each day of the week that is also calculated using the user's sleep information in a past unit game period, information related to a user's sleep rhythm, and/or statistics information related to a user's sleep. Note that examples of a method for displaying information of a time zone during which the user wakes up and information of the time zone during which the user sleeps as the statistics information of the user's sleep include taking a time (that has scales having predetermined time intervals such as 15-minute interval in this regard) on the horizontal axis, and taking a cumulative number of times in a corresponding time zone during which the user wakes up/sleeps on the vertical axis. As an example, a graph of the time zone to wake up/sleep is configured by taking scales at 15-minute intervals on the horizontal axis, and displaying a cumulative value of the number of times that the user wakes up/sleeps between one time x and a time that is 15 minutes after the one time x (e.g., the number of times that the user wakes up between 7:30 and 7:45 is displayed as a bar graph at a portion of the horizontal axis corresponding to 7:30 to 7:45, and the number of times that the user wakes up between 7:45 and 8:00 is displayed as a bar graph at a portion of the horizontal axis corresponding to 7:45 to 8:00.).

### Menu e): “Bag”

This menu can refer to names and explanations of various items (such as items that are given as growth items, dish ingredients, and, in addition, game rewards) acquired by the user by executing the game, and possessed by the user at a point of time when the user's selection instruction on a “bag” is accepted.

### Menu f): “Social Research”

The game control unit 210 supplies predetermined information (e.g., friend request information for requesting friend settings for making the user and another user become friends) to the terminal device 10 of the another user via the communication network 80 in response to a user's instruction, and, when the another user approves the predetermined information, sets the user and the another user as the friends. Furthermore, “social research” is a menu that enables execution of share settings of predetermined game data with a friend. Examples of information for which the share settings can be made include a sleep score of that day, a value of a second parameter of that day, a sleep type of that day, a total sleep time, a maximum value among the past second parameters, sleeping faces of the characters got by the user, and the like. The information for which the share settings have been made can be referred to by another user using the terminal device 10 of the another user.

### Menu g): “Map Menu”

The menu displays a map of the virtual space of the game system 1. For example, the entire virtual space and details of each field can be displayed.

### Menu h): “Submenu”

Examples of various other menus include a menu for changing the name of the user, a take-over menu of game data in a case where, for example, the user switches the terminal device 10 to another terminal device, an account cooperation processing menu, notifications from game providers, and the like.

[(e-2) Help Character Level Increase and Evolution Processing]

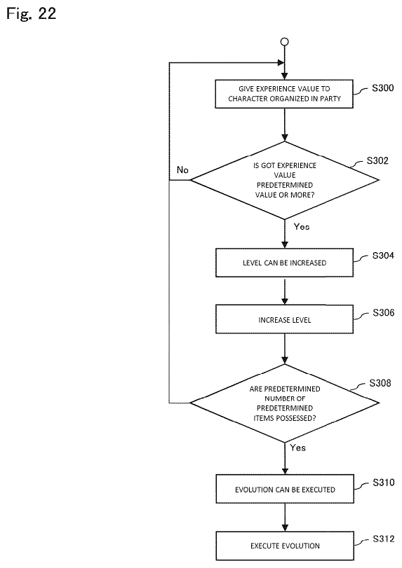

FIG. 22 illustrates an example of an overview of a flow of help character level increase and evolution processing in the game system 1 according to the present embodiment.

### (Precondition of Help Character)

First, the game control unit 210 can display the possessed character information in the user information storage unit 218 on the display unit 300 in, for example, a mode that the possessed character is in a predetermined box (character box). Furthermore, when accepting a user's predetermined operation instruction on the box via the input unit 102, the game control unit 210 displays the state in the box on the display unit 300. The game control unit 210 displays, for each of one or more characters in the box, a name of a character, a personality (nature), a special point, an energy parameter, an experience value, a level, condition information (level up condition) required for increasing the level, a skill, evolution target information, condition information (evolution condition) required for evolution, a help ability (i.e., information related to the type of the growth items 650 that the character easily collects in the field 500, a maximum number of the growth items 650 that can be collected, a type of an ingredient, and the maximum number of ingredients that can be collected), a sleep time for sleeping together with the user, a cumulative time of a party organization state (a time of the user's activity period in the party organization state, the user's sleep time in the party organization state, or a total time of the time of the user's activity period in the party organization state and the user's sleep time in the party organization state), a time and a place for encountering the user (i.e., a time at which the user has gotten a possessed character, and a field name).

The experience value (basic EXP) may be determined according to, for example, the duration of the user's activity period while the help characters are organized in a party, the duration of the user's sleep time, and/or the type or the number of predetermined items collected by the help character during the activity period (i.e., the type and the number of items determined by the lottery). Furthermore, the level is determined according to a cumulative value of experience values that the help character has gotten (note that the experience values are also added by giving a predetermined “candy” item to the help character.). The level up condition may be, for example, a condition that the cumulative value of experience values reaches a predetermined threshold (this threshold may increase according to the level.). Furthermore, the evolution condition may include that, for example, the level of the help character reaches a predetermined level and a predetermined amount of a predetermined item (e.g., “candy”) is consumed.

Here, the help ability improves according to the level increase. For example, the type of the growth items 650 that are easy to collect and/or the maximum number of the growth items 650 that can be collected can be increased when the character exceeds a predetermined level. Furthermore, the skill is a special function that the character has per character, and is a function of producing an advantageous effect for the game. The game control unit 210 exhibits a skill every time a predetermined time elapses or when the input unit 102 accepts a user's instruction on the character having the skill, and produces an effect advantageous for the game (e.g., an effect such as addition of a predetermined value to the first parameter resulting from exhibition of the skill, acquisition of a predetermined item (e.g., items that can be given to the help character to get an experience value or items that are used to evolve the help character), collection of items before the collection time elapses, temporary improvement of the help ability, and recovery of the “energy” parameter). When the level of the character increases, the number of skills also increases.

Note that the type of the skill possessed by the character is also determined by the lottery at a timing at which the character is given to the user by the lottery. In this case, when determining by the lottery a character already recorded in the possessed character information in the user information storage unit 218, the game control unit 210 may determine that the user already possesses the same character, and make it easy to win by the lottery a skill that makes the character newly determined by the lottery produce a more advantageous effect than that produced by the character already possessed by the user.

Furthermore, the sleep time for sleeping together with the user is a numerical value obtained by accumulating user's sleep times when the user takes a sleep in a state where the character is organized in the party. When the user takes a sleep in a case where the character is organized in the party, the sleep time for sleeping together with the user increases. Note that a parameter indicating a relationship between the user and the character may be increased according to the duration of the sleep time for sleeping together with the user separately from the sleep time for sleeping together with the user.

### (Level Increase/Evolution of Help Character)

The game control unit 210 gives to each of one or more help characters organized in the party an experience value determined on the basis of the duration of the sleep time included in the user's sleep information acquired by the sleep information acquisition unit 204, and an experience value determined on the basis of the duration of the activity period (S300). Thus, each help character gets the experience value. The game control unit 210 determines whether or not the experience values got by the help character have become a predetermined value or more (S302). This predetermined value may be a value that varies per type and characteristics of the help character. When the experience value got by the help character does not become the predetermined value or more (No in S302), the game control unit repeats S300.

On the other hand, when the experience value got by the help character becomes the predetermined value or more (Yes in S302), the game control unit 210 increases the level of the help character (S304). When, for example, accepting a user's predetermined operation instruction on a character box via the input unit 102, the game control unit 210 displays the state in the box on the display unit 300. Furthermore, the game control unit 210 displays information of the character selected by the user in response to the user's selection instruction. The game control unit 210 displays that the level can be increased on the display unit 300 when the level of the character can be increased. Furthermore, when accepting a level up instruction on the character from the user, the game control unit 210 increases the level of the character (S306). The increase in the level improves the help ability of the character and/or gives a predetermined skill (the type of the skill may be determined by the lottery.). Note that the game control unit 210 may increase the level of the character without a user's instruction.

Furthermore, the game control unit 210 determines whether or not the user owns a predetermined number of predetermined items (S308). When the user does not own the predetermined number of predetermined items (No in S308), the game control unit 210 repeats S300. When the user owns the predetermined number of predetermined items (Yes in S308), the game control unit 210 enables execution of the help character evolution processing (S310). Furthermore, when accepting an evolution instruction of the character from the user, the game control unit 210 executes the character evolution processing in exchange with consumption of the predetermined number of the predetermined items owned by the user (S312). Accordingly, the character becomes an evolved character after the evolution. Note that the predetermined item may be one type of an item or a plurality of types of items. For example, a large amount of energy, a large maximum number of growth items that can be possessed, a large maximum number of ingredients that can be possessed, and the like may be set to an evolved character compared to pre-evolution characters.

Note that a specific character can be evolved by sleeping together with the user for a certain period of time. That is, instead of determining in S308 whether or not the user owns the predetermined number of predetermined items, when the user takes a sleep in a state where the specific character is organized in the party, and the user's sleep time or the cumulative time of user's sleep times is a predetermined duration of time (evolution time) or more, the game control unit 210 evolves the specific character (S312).

[(e-3) Change of Sleep Information by Manual Input]

The game system 1 can enable acquisition of sleep information by manual input when, for example, the user forgets measuring the sleep information. That is, the game system 1 generates changed sleep information based on the sleeping time and the wake-up time manually input by the user without using the sleep information acquired by the sleep information acquisition unit 204 based on the measurement result of the sensor that uses the sleep measurement unit 11. Furthermore, the game system 1 can execute game event processing, and processing such as recovery of a predetermined parameter of a character such as a help character possessed by the user, and giving of a predetermined item to the user using this changed sleep information instead of the sleep information. Consequently, according to the game system 1, even if, for example, the user forgets acquiring the sleep information, it is possible to make it easy to continue the game.

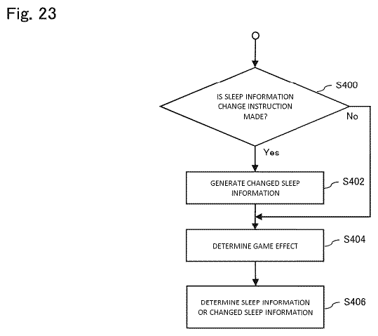

First, when outputting, for example, the sleep report described in S206, as illustrated in FIG. 23, the game control unit 210 displays on the display unit 300 a predetermined operator that accepts whether it is requested or unnecessary to correct or register at least part of the sleep information, and accepts whether or not there is a sleep information change instruction (S400). When accepting the user's operation input (hereinafter referred to as a “manual input”) in response to the request for registration of the operator via the input unit 102 (Yes in S400), the game control unit 210 outputs a form for accepting the contents of the correction or the registration to the output unit 100. Furthermore, when acquiring input contents related to the user's sleep start time and/or wake-up time with respect to the form (hereinafter referred to as a “manual input form”) via the input unit 102, the game control unit 210 generates changed sleep information based on this input contents (S402). Subsequently, the event determination unit 212 determines a game event to be caused on the basis of this changed sleep information, and the game control unit 210 determines predetermined processing such as the game effect based on this changed sleep information (S404). Note that the game control unit 210 accepts an input of only latest sleep information as the user's input contents. The game control unit 210 may disable acceptance of a past date and time that exceed the predetermined time as the sleep start time and the wake-up time. Furthermore, the game control unit 210 disables acceptance of manual input even when the manually input sleep start time and/or wake-up time overlap the user's past sleep start time and/or wake-up time. Furthermore, the predetermined time from a point of time of acceptance of the manual input may be such a duration that, even when a timing at which the user recognizes that, for example, the user has forgotten starting sleep measurement on a certain day or the like exceeds a sleeping timing on the next day of the certain day, the user can input the changed sleep information with a time to spare. For example, the predetermined time may be 30 hours or less.

On the other hand, when the game control unit 210 accepts an operation input that is associated with the operator and is associated with a corresponding operator indicating that it is unnecessary to correct or register at least part of the sleep information via the input unit 102 (No in S400), the event determination unit 212 determines the game event to be caused on the basis of the sleep information acquired by the sleep information acquisition unit 204, and the game control unit 210 officially determines predetermined processing on, for example, a game effect based on the sleep information (S404). When there is no sleep information acquired by the sleep information acquisition unit 204, the event determination unit 212 may determine in advance the game effect for a case where there is no sleep information or the like, and determine the predetermined processing on a predetermined game effect or the like. Furthermore, until the user starts sleeping next after the game effect or the like is officially determined on the basis of the sleep information or the changed sleep information, the game control unit 210 determines the contents of the sleep information or the changed sleep information used to determine the effect of the game, and bans correction and/or registration of part or all or the contents (S406). That is, after determining the game effect, a game event, or the like on a day on which the user wakes up once, the game control unit 210 bans generation of the changed sleep information obtained by correcting again the sleep information or the changed sleep information used to determine the effect by the game control unit 210 or the like. Consequently, it is possible to prevent an action of determining the game effect or the like based on the changed sleep information for which inappropriate sleep information has been used, acquiring a reward, and then rewriting the sleep information to appropriate contents again.

[(e-4) Sleep Pass Processing]

The game system 1 can give to the user a pass (sleep pass) for giving a predetermined benefit to the user by executing the sleep game. As types of the sleep pass, two types of a “normal pass” for a non-in-app purchase user and a “premium pass” for an in-app purchase user can be set.

### (Normal Pass)

The game control unit 210 may give the normal pass to the user when the user starts the game (more specifically, after the game starts and after the tutorial ends). The following benefits are given to the user who possesses the normal pass.
Benefit a): A sleep point is given on the basis of the sleep score calculated by the sleep parameter calculation unit 208. For example, “one point” is given as a sleep point for each sleep score “one point”.
Benefit b): User's sleep data of a predetermined number of days (e.g., past 60 days) can be referred to. That is, in the Benefit b), the user can refer to only sleep information of a predetermined number of days instead of all of user's sleep information recorded in the sleep information in the user information storage unit 218. Note that, although all of the sleep information from a point of time at which the user has started the game is recorded in the sleep information in the user information storage unit 218, the user having the normal pass can refer to only the sleep information of days from the current time to a predetermined number of past days instead of all of the sleep information.

Note that the game control unit 210 may be provided with an exchange that can acquire a predetermined item in the game in exchange with consumption of the sleep point. The user possessing the normal pass can acquire the predetermined item at a “normal exchange” in exchange with consumption of the sleep point. The “normal exchange” can be used by any user who possesses the sleep pass irrespectively of the sleep pass type.

### (Premium Pass)

The game control unit 210 gives a premium pass to the user in response to user's payment using the actual currency (purchase price). The following benefits are given to users who possesses the premium pass. Note that the premium pass may be a subscription plan. A usage fee may be paid, for example, every one month or every six months.
Benefit a): This benefit is the same as the Benefit a) of the normal pass.
Benefit b′): User's sleep data and sleep statistics data can be referred to without limitation of a time limit.
Benefit c): An increase amount of a friend point of a character by an intimacy degree improvement item is increased by a predetermined amount.
Benefit d): A predetermined point (e.g., 100 points) of a sleep point is given every day.
Benefit e): At a “premium exchange” that only a user possessing the premium pass can use, a predetermined item can be acquired in exchange with consumption of the sleep point. The “premium exchange” is an exchange that enables acquisition of items that cannot be acquired at the “normal exchange”.
Benefit f): A predetermined amount of sleep points (e.g., 1,000 points) is given once a month, and an item (e.g., a camp ticket. When the user selects to consume the camp ticket, the game effect produced by the camp set 770 enhances for a predetermined period of time.) that enhances the game effect produced by the camp set 770 is given. Note that the game control unit 210 can also cause the display unit 300 to display a timing at which a predetermined benefit can be got (e.g., a timing at which a predetermined character newly appears in the field) using the camp ticket such that the user can perceive the timing.
Benefit g): Every time the premium pass is continuously used for a predetermined period (e.g., three months), a predetermined item is given.
Benefit h): Every time sleep measurement is executed once, use of a sleep memo that is a function that can record any memo is enabled. Note that information related to the sleep memo is stored in, for example, the information terminal 10 and is not stored in the server, and only when the user has the premium pass, output of the stored sleep memo to the output unit 100 is enabled.
Benefit i): A compensation bonus is given in a case where, for example, the user forgets sleep measurement. That is, when, for example, the user forgets sleep measurement, the sleep information acquisition unit 204 cannot acquire the sleep information, and therefore cannot generally execute sleep research, either. Hence, if correction by manual input in the description of above [(e-3) Change of sleep information by manual input] is not accepted, the Benefit i) may be given. That is, according to the Benefit i), while correction of the sleep information by manual input correction on a day on which, for example, the user has forgotten sleep measurement is not accepted for the user who has forgotten the sleep measurement, for example, and, when the user takes a sleep next, a predetermined compensation bonus associated with the day on which the user has forgotten the sleep measurement is given. In this regard, even when the correction by manual input in the description of above [(e-3) Change of sleep information by manual input] is accepted, the following Benefit i-1) and Benefit i-2) may be given to the user. That is, from the viewpoint of continuously recording the user's sleep information, it is preferable to accept correction by manual input. In this case, the game system 1 can give the Benefit i-1) and the Benefit i-2) to the user, or can execute event processing and processing of, for example, recovering a predetermined parameter of a character such as a help character possessed by the user using the changed sleep information in place of the sleep information, and give the Benefit i-1) and the Benefit i-2) to the user.

More specifically, this predetermined compensation bonus may be one of the followings.
Benefit i-1): When the user executes sleep measurement on a day next to the day on which, for example, the user has forgotten the sleep measurement, a predetermined item or the like associated with a predetermined sleep time is given.
Benefit i-2): When, for example, the user forgets sleep measurement, a ticket that makes it possible to acquire a predetermined item or the like associated with a predetermined sleep time at an arbitrary timing of the user is given. The user can acquire a predetermined item or the like by consuming the ticket at an arbitrary timing.
Benefit i-3): When, for example, the user forgets sleep measurement, execution of correction by manual input in the description of [(e-3) Change of sleep information by manual input] is enabled. That is, execution of [(e-3) Change of sleep information by manual input] is usually disabled (e.g., the user having the normal pass cannot perform the execution), and only a user having the premium pass can accept the sleep information by a predetermined number of times of manual input.

Note that the ticket of the Benefit i-2) may be collectively given to the user at, for example, a timing of updating an expiration date of the premium pass. Furthermore, the game control unit 210 may refer to a day of the week on the day on which, for example, the user has forgotten the sleep measurement, acquire the user's past sleep time on the day of the week from the user information storage unit 218, and calculate an average sleep time of the acquired past sleep time of the day on the week. Furthermore, the game control unit 210 may use a predetermined item or the like determined on the basis of the calculated average sleep time as a compensation bonus given to the user.

[(e-5) Field Bonus Processing]

The game control unit 210 can also give a predetermined bonus to the user for calculation of the first parameter in the field in which the user has executed the game so far (the field in which the user has executed the game in a previous unit game period) at a timing at which the user selects a new field.

As a precondition, in each field, an increase multiple may be set in advance to items or the like used to increase the first parameter, that is, a growth item, a dish, and/or a skill effect of a help character (e.g., addition of a predetermined value to the first parameter resulting from exhibition of the skill). The increase multiple may be different or the same per item type, dish, and/or skill. Hereinafter, an example will be described where the increase multiple is the same irrespectively of the item type, the dish, and the skill from a viewpoint of easiness of calculation. More specifically, at a time of start of the game, an increase multiple is set to one field in association with the one field. An initial value of the increase multiple may be “1.0”. Accordingly, when the user plays the game for the first time in the one field, since the increase multiple is “1.0”, all of a value associated with an item that a help character gives to a field character, a dish parameter of a dish, and a predetermined value of the skill effect are an initial value, an initial dish parameter, and an initial predetermined value.

Furthermore, the game control unit 210 increases the increase multiple of the field (old field) in which the user has executed the game so far at a timing at which one unit game period switches to the next unit game period, that is, a timing at which the user selects a new field. In this case, the game control unit 210 increases the increase multiple associated with the old field (as an example, at a timing at which a unit game period during which the user has selected the old field for the first time ends and then switches to the next unit game period, the increase multiple of the old field is increased by 15% and set to “1.15”. This increase amount may be set as appropriate.). Accordingly, while, in a case where, for example, the user selects one field for the first time in one unit game period and a predetermined value associated with one growth item is “100”, the amount of the first parameters increased by the growth item in the one unit game period is “100”, in a case where the user selects the one field again in another unit game period (second selection) again, the increase multiple has increased (e.g., +15%), a value associated with the one growth item in the another unit game period is “115”, and the amount of the first parameters increased by the growth item in the another unit game period is also “115”.

The game control unit 210 stores each increase multiple associated with each field, increases by a predetermined amount the increase multiple of the field selected by the user in the one unit game period at each timing at which the one unit game period switches to the next unit game period of the one unit game period, and updates the stored increase multiple. In this regard, an upper limit can be set to the increase multiple of the field (e.g., the upper limit of the increase multiple is set up to 200% increase). Note that, when the user satisfies a predetermined condition, for example, when the user achieves a predetermined mission a predetermined number of times in the game, an upper limit value of the increase multiple may be increased by the predetermined amount (e.g., the upper limit of the increase multiple is increased from 200% increase to 300% increase). Note that, when the game control unit 210 displays on the display unit 300 information related to a field that can be selected by the user at the timing at which the user selects the field, the increase multiple of each field may be displayed together with the field information 510 from a viewpoint of making the user refer to the increase multiple and the field information 510 for field selection.

Accordingly, the game system 1 increases the increase multiple of the field that the user has selected in one unit game period at a timing at which the one unit game period switches to a next unit game period (e.g., a timing at which a week switches), so that, only by repeatedly selecting the field and playing the game, the user can easily increase the first parameter (i.e., it is easy to improve an evaluation of the field character, and it is easy to encounter a character having a sleeping face of higher rarity.).

### [Game Program]

Each component included in the game system 1 according to the present embodiment illustrated in FIGS. 1 to 23 can be implemented by causing a calculation processing device such as a Central Processing Unit (CPU) to execute a program (i.e. game program), that is, by executing processing executed using software. Alternatively, each component can be implemented by writing in advance the program into hardware serving as an electronic component such as an integrated circuit (IC). Note that software and hardware can be also used in combination.

That is, the game program according to the present embodiment is a game program that a computer that includes a processor and a memory and manages execution of the game that uses the sleep information related to a user's sleep is caused to execute. Furthermore, the game program according to the present embodiment can be built into an IC, a ROM, or the like in advance, for example. Furthermore, the game program can be recorded as a file with an installable format or an executable format in a computer-readable recording medium such as a magnetic recording medium, an optical recording medium, or a semiconductor recording medium to be provided as a computer program. The recording medium having the program stored thereon may be a non-transitory recording medium such as a CD-ROM or a DVD. Furthermore, the game program can be stored in advance in a computer connected to a communication network such as the Internet, and can be provided by being downloaded through the communication network.

The game program according to the present embodiment operates the CPU or the like to cause the game program to function as the sleep measurement unit 11, the output unit 100, the input unit 102, the input screen 104, the input control unit 106, the input acquisition unit 200, the output control unit 202, the sleep information acquisition unit 204, the parameter control unit 206, the sleep parameter calculation unit 208, the game control unit 210, the event determination unit 212, the storing unit 216, the user information storage unit 218, the game information storage unit 220, the character information storage unit 222, the field character information storage unit 224, and the dish information storage unit 226 described with reference to FIGS. 1 to 23.

### Advantageous Effects of Embodiment

The game system 1 according to the present embodiment gives a predetermined item or the like to a field character during a user's activity period, increases the first parameter by adding a value associated with the predetermined item or the like to the first parameter of a field character, and grows the field character. Furthermore, the game system 1 stores the first parameter at a time at which the user sleeps as the sleep start time parameter, and calculates the second parameter by multiplying the sleep start time parameter with the sleep parameter calculated on the basis of user's sleep information after the sleeping user wakes up. Next, the game system 1 determines a game event to be caused in the game based on the calculated second parameter, and generates game event information related to the game event. As the second parameter becomes larger, the game event that is advantageous for the user (is preferable for the user) is more likely to occur. That is, the game system 1 adopts multiplication for calculation of the second parameter, so that, by taking an appropriate duration of a sleep time without immersing in a game operation during the activity period (typically, daytime), the user can increase the second parameter and cause a game event that is preferable for the user. Consequently, by making the user take the appropriate duration of the sleep time in the sleep game that uses the user's sleep information, the game system 1 can improve enjoyability of the game.

Furthermore, the game system 1 can increase the first parameter (prevent the first parameter from becoming “0”) in a mode that, even if the user does not execute the game operation during the user's activity period, a help character possessed by the user automatically collects a predetermined item. Consequently, the game system 1 can calculate the second parameter only if the user takes a sleep, so that it is possible to suppress the user from immersing in the game during the activity period. That is, since every user takes a sleep, the game system 1 can make it easy to accumulate the minimum first parameters even if a game play time and the number of times of the game play at a time of wake-up are short and small (or even if the game is not played) such that users are not left from the sleep game as many as possible, and cause a game event only if the user takes a sleep. Consequently, the game system 1 can maintain a motivation for the user to continue the sleep game and enable the user to take an appropriate sleep.

Describing this point from a different viewpoint, the first parameter is automatically accumulated even if the user does not execute a game operation. Conventional games do not give log-in bonuses to users even if, for example, there is a login bonus, and if the users do not log in the game. On the other hand, the game system 1 according to the present embodiment accumulates a minimum amount of the first parameters required to execute the game without depending on a user's operation as described above. Accordingly, even if the user does not play the game in the game system 1 for a while, the first parameters are automatically accumulated, so that, even if there is a user who has left the game once, it is possible to maintain and improve a user's motivation to resume the game.

Furthermore, the game system 1 takes over the first parameter to a next day in the unit game period, and easily increases the second parameter more in a more latter half of the unit game period. Consequently, the game system 1 can maintain and improve the motivation to continue the game for the user who has started the game in a certain unit game period.

Although the embodiment of the present disclosure has been described above, the embodiment described above is not intended to limit the disclosure as set forth in the scope of claims. Furthermore, it should be noted that not all combinations of features described in the embodiment are essential as solutions to the problem addressed by the disclosure. Furthermore, technical elements of the embodiment described above can be applied independently or applied by being divided into a plurality of units such as program components and hardware components.

### REFERENCE SIGNS LIST

1 Game system
10 Terminal device
11 Sleep measurement unit
20 Server
80 Communication network
100 Output unit
102 Input unit
104 Input screen
106 Input control unit
200 Input acquisition unit
202 Output control unit
204 Sleep information acquisition unit
206 Parameter control unit
208 Sleep parameter calculation unit
210 Game control unit
212 Event determination unit
216 Storing unit
218 User information storage unit
220 Game information storage unit
222 Character information storage unit
224 Field character information storage unit
226 Dish information storage unit
300 Display unit
400 Sleep button
402 Measurement end button
404 Time display
406 Date display
410 Alarm settings area
412 Sleep induction sound settings area
420 Button
500 Field
510 Field information
520 Selection button
600, 602 Field character
604 Favorite food information
606 Request information
630 First parameter display area
632 Got parameter
650 Growth item
660 Dish image
662 Dish
670, 672 Cooking execution button
700, 702, 704 Character
710 Pictorial book description
712 Image list display area
714 Stored image
720 Acquired image
722 Today's image
730 Friend point display
740, 742, 744 Discovered character
750 Recovery amount
752 Got experience value
760 Help character
764 Automatically got parameter display area
766 Automatically got parameter
770 Camp set
772, 780, 782 Item set button
774 Cooking start button
790 Goal setting button
800 Second parameter
802 Breakdown
900 Sleep report
902 Sleep parameter
904 Sleep time
906 Sleep graph
908 Recorded data
910 Sleep contents display area
912 Sleep type display area
920 User rank display area
922 Reward display area
930 Research reward display area
932, 934, 936 Reward display area
940 Character evaluation
942 Got parameter display area
950 Evaluation display
952 Summary data
954 Summary graph
956 Sleep time details
960 Sleep graph
962 Average sleep time
970 Various menus

1. A non-transitory computer-readable storage medium storing computer-readable instructions thereon which, when executed by a computer that includes a processor and a memory and manages execution of a game using sleep information relating to sleep of a user, causes the computer to perform a method, the method comprising:
setting at least one object as an organization object from a plurality of objects owned by the user, the plurality of objects being associated with values of sleep time;
acquiring the sleep information of the user;
in a case that the sleep information is acquired, cumulatively adding the sleep time of the user included in the sleep information to the value of the sleep time of the at least one object organized in the organization object; and
displaying the value of the cumulatively added sleep time of each of the plurality of objects owned by the user.

2. The non-transitory computer-readable storage medium according to claim 1, wherein a third parameter relating to an ability of the object is further associated with each of the plurality of objects.

3. A non-transitory computer-readable storage medium storing computer-readable instructions thereon which, when executed by a computer that includes a processor and a memory and manages execution of a game using sleep information relating to sleep of a user, causes the computer to perform a method, the method comprising:
setting at least one object as an organization object from a plurality of objects owned by the user, the plurality of objects being associated with values of sleep time and a third parameter relating to an ability of each of the plurality of objects;
acquiring the sleep information of the user;
in a case that the sleep information is acquired, cumulatively adding the sleep time of the user included in the sleep information to the value of the sleep time of the at least one object organized in the organization object;
changing the third parameter so that the ability of the at least one object organized in the organization object is improved in a case that a predetermined condition is satisfied by adding the sleep time of the user to the value of the sleep time; and
displaying the value of the cumulatively added sleep time of each of the plurality of objects owned by the user.

4. The non-transitory computer-readable storage medium according to claim 3, wherein the third parameter is a parameter relating to a level of each of the plurality of objects.

5. The non-transitory computer-readable storage medium according to claim 4, wherein the level is increased in case that the predetermined condition is satisfied by adding the sleep time of the user to the value of the sleep time.

6. The non-transitory computer-readable storage medium according to claim 4, wherein the level is increased in case that the predetermined condition is satisfied by using a predetermined item.

7. A game system, comprising:
circuitry configured to
set at least one object as an organization object from a plurality of objects owned by the user, the plurality of objects being associated with values of sleep time,
acquire the sleep information of the user,
in a case that the sleep information is acquired, cumulatively add the sleep time of the user included in the sleep information to the value of the sleep time of the at least one object organized in the organization object, and
display the value of the cumulatively added sleep time of each of the plurality of objects owned by the user.

8. An information processing apparatus comprising circuitry configured to execute the steps according to claim 1.

9. An information processing apparatus comprising circuitry configured to execute the steps according to claim 3.

10. A server comprising circuitry configured to execute the steps according to claim 1.

11. A server comprising circuitry configured to execute the steps according to claim 3.

12. A game method executed by a computer comprising circuitry, wherein the circuitry is configured to execute the steps according to claim 1.

13. A game method executed by a computer comprising circuitry, wherein the circuitry is configured to execute the steps according to claim 1.
